(19) United States
(12) Patent Application Publication
(10) Pub. No.: US 2023/0279201 A1
(43) Pub. Date: Sep. 7, 2023

(54) REINFORCED ELASTOMER COMPOSITION

(71) Applicant: OMYA INTERNATIONAL AG, Oftringen (CH)

(72) Inventors: Matthias WELKER, Hésingue (FR); Samuel RENTSCH, Spiegel bei Bern (CH)

(73) Assignee: OMYA INTERNATIONAL AG, Oftringen (CH)

(21) Appl. No.: 17/928,034

(22) PCT Filed: Jul. 15, 2021
(86) PCT No.: PCT/EP2021/069694

§ 371 Date: Nov. 28, 2022

(30) Foreign Application Priority Data
Jul. 16, 2020 (EP) 20186209.1

(51) Int. Cl. C08K 9/06; C08K 3/26

(52) U.S. Cl. CPC C08K 9/06; C08K 3/26; C08K 2003/265; C08K 2003/267

(57) ABSTRACT

A curable elastomer composition includes a crosslinkable polymer, and a filler selected from surface-reacted calcium carbonate, precipitated hydromagnesite, or a mixture thereof, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source. Furthermore, the disclosure relates to a cured elastomer product formed from said composition, an article including the cured elastomer product, a method of producing a cured elastomer product, and use of the filler for reinforcing a cured elastomer product.

The present invention relates to elastomers, and in particular to a curable elastomer composition, a cured elastomer product, a method for producing said product, and the use of a filler selected from surface-reacted calcium carbonate and/or precipitated hydromagnesite for reinforcing a cured elastomer product.

Elastomers, also commonly termed rubbers, are crosslinked polymeric materials having rubber-like elasticity, i.e., the ability of reversible deformation upon application of an external deforming force. Elastomers have found widespread application, for example in tires, tubeless tires, O-rings, disposable gloves, automotive transmission belts, hoses, gaskets, oil seals, V belts, synthetic leather, printers form rollers, cable jacketing, pigment binders, adhesives, sealants, dynamic and static seals, conveyor belts, or sanitary applications.

It is common in the art to add certain fillers to the elastomer compositions, for example, in order to improve the mechanical properties. Commonly employed reinforcing fillers include carbon black, (modified) silica particles, kaolin and other clays. However, these fillers have certain disadvantages. For example, carbon black cannot be used as filler for insulating cables because it is slightly conductive. The color of carbon black also imposes restrictions with respect to its application, and filler materials such as carbon black or modified silica are difficult to handle due to heath safety and environmental concerns. Furthermore, elastomers containing these filler material may be still deficient with respect to tear resistance. They may break easily during processing, for example, when there is a notch already existing. This may be particularly the case when the elastomer is still hot, for example, during unmolding.

The use of ground calcium carbonate and precipitated calcium carbonate in elastomer compositions has been reported. For example, U.S. Pat. No. 3,374,198 A discloses compositions comprising ethylene-propylene rubbers and calcium carbonate as a reinforcing filler. Sobhy et al. (Egyptian Journal of Solids 2003, 26, 241-257) report on the cure characteristics and mechanical properties of natural rubber and nitrile rubber filled with calcium carbonate.

EP 3 192 837 A1 refers to a surface-modified calcium carbonate, which is surface-treated with an anhydride or acid or salt thereof, and suggests its use inter alia in polymer compositions, papermaking, paints, adhesives, sealants, pharma applications, crosslinking of rubbers, polyolefins, polyvinyl chlorides, in unsaturated polyesters and in alkyd resins.

In view of the foregoing, there is an ongoing need for elastomers with excellent mechanical properties.

Accordingly, it is an object of the present invention to provide an elastomer with excellent mechanical properties, and in particular, with an improved tear resistance, improved tensile modulus, tensile strength and/or elongation at break. Furthermore, it is desirable to provide an elastomer with good processability.

It is also an object to provide a filler for elastomers, which not only improves the mechanical properties of elastomers, but is at least partially derivable from natural sources, is environmentally benign and inexpensive. It would be desirable to provide a filler that has a light colour. Furthermore, it would be desirable to provide a filler that has no adverse effect during the curing of the elastomer.

The foregoing and other objects are solved by the subject-matter as defined in the independent claims.

According to one aspect of the present invention, a curable elastomer composition is provided comprising

a crosslinkable polymer, and

a filler selected from surface-reacted calcium carbonate, precipitated hydromagnesite, or a mixture thereof,

wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

According to a further aspect of the present invention, a cured elastomer product formed from the curable elastomer composition according to the present invention is provided.

According to still a further aspect of the present invention, an article comprising the cured elastomer product according to the present invention is provided, wherein the article is preferably selected from the group comprising tubeless articles, membranes, sealings, gloves, pipes, cable, electrical connectors, oil hoses, shoe soles, o-ring seals, shaft seals, gaskets, tubing, valve stem seals, fuel hose, tank seals, diaphragms, flexi liners for pumps, mechanical seals, pipe coupling, valve lines, military flare blinders, electrical connectors, fuel joints, roll covers, firewall seals, clips for jet engines, conveyor belts, and tires.

According to still a further aspect of the present invention, a method of producing a cured elastomer product is provided, comprising the steps of

i) providing a crosslinkable polymer,

ii) providing a filler selected from surface-reacted calcium carbonate, precipitated hydromagnesite, or a mixture thereof,

wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source,

iii) combining the crosslinkable polymer of step i) and the filler of step ii) in one or more steps to form a curable elastomer composition, and

iv) curing the curable elastomer composition of step iii).

According to still a further aspect of the present invention, use of a filler for reinforcing a cured elastomer product is provided, wherein the filler is selected from surface-reacted calcium carbonate, precipitated hydromagnesite, or a mixture thereof, and wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

According to still a further aspect of the present invention, a process for the surface treatment of hydromagnesite is provided, the process comprising the steps of:
I) providing precipitated hydromagnesite,
II) providing at least one surface-treatment composition in an amount ranging from 0.07 to 9 mg/m² of the precipitated hydromagnesite surface as provided in step a), preferably 0.1 to 8 mg/m², more preferably from 0.11 to 3 mg/m²,
wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated or unsaturated fatty acids, salts of saturated or unsaturated fatty acids, saturated or unsaturated esters of phosphoric acid, salts of saturated or unsaturated phosphoric acid esters, abietic acid, salts of abietic acid, trialkoxysilanes, and mixtures thereof and reaction products thereof, and
III) contacting the precipitated hydromagnesite and the at least one surface-treatment composition in one or more steps at a temperature in the range from 20 to 180° C.,
preferably the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferably completely neutralized surface treatment agents; and/or
b) a maleic anhydride grafted polybutadiene homopolymer or a maleic anhydride grafted polybutadiene-styrene copolymer and/or an acid or salt thereof, preferably a maleic anhydride grafted polybutadiene homopolymer having
   i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
   ii) a number of anhydride groups per chain in the range from 2 to 12, preferably from 2 to 9, and more preferably from 2 to 6, and/or
   iii) an anhydride equivalent weight in the range from 400 to 2 200, preferably from 500 to 2 000, and more preferably from 550 to 1 800, and/or
   iv) an acid number in the range from 10 to 300 meq KOH/g of maleic anhydride grafted polybutadiene homopolymer, preferably 20 to 200 meq KOH/g, more preferably 30 to 150 meq KOH/g, measured according to ASTM D974-14, and/or
   v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer,
   and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof, preferably at least one aliphatic carboxylic acid having a total amount of carbon atoms from C₄ to C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cis and/or a salt thereof and/or
f) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or
g) at least one polydialkylsiloxane, preferably selected from the group consisting of polydimethylsiloxane, preferably dimethicone, polydiethylsiloxane, polymethylphenylsiloxane and mixtures thereof, and/or
h) mixtures of the materials according to a) to g).

According to still a further aspect of the present invention, a surface-treated precipitated hydromagnesite obtained by a process according to the present invention is provided.

Advantageous embodiments of the present invention are defined in the corresponding subclaims.

According to one embodiment the crosslinkable polymer is selected from natural or synthetic rubber, preferably the crosslinkable polymer is selected from the group consisting of acrylic rubber, butadiene rubber, acrylonitrile-butadiene rubber, epichlorhydrin rubber, isoprene rubber, ethylene-propylene rubber, ethylene-propylene-diene rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, and mixtures thereof, and more preferably nitrile-butadiene rubber and/or ethylene-propylene-diene rubber.

According to one embodiment the filler is present in an amount from 1 to 80 wt.-%, preferably from 2 to 70 wt.-%, more preferably from 5 to 60 wt.-%, and most preferably from 10 to 50 wt.-%, based on the total weight of the curable elastomer composition, or the filler is present in an amount from 5 to 175 parts per hundred (phr), preferably from 20 to 160 phr, and most preferably from 30 to 150 phr, based on the total weight of the crosslinkable polymer. According to a further embodiment, the filler has a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, and/or a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, and/or a specific surface area of from 15 m²/g to 200 m²/g, preferably from 20 m²/g to 180 m²/g, more preferably from 25 m²/g to 140 m²/g, even more preferably from 27 m²/g to 120 m²/g, and most preferably from 30 m²/g to 100 m²/g, measured using nitrogen and the BET method.

According to a further embodiment the natural ground calcium carbonate is selected from the group consisting of marble, chalk, limestone, and mixtures thereof, or the precipitated calcium carbonate is selected from the group consisting of precipitated calcium carbonates having an aragonitic, vateritic or calcitic crystal form, and mixtures thereof, and/or the at least one H₃O⁺ ion donor is selected from the group consisting of hydrochloric acid, sulphuric acid, sulphurous acid, phosphoric acid, citric acid, oxalic acid, an acidic salt, acetic acid, formic acid, and mixtures thereof, preferably the at least one H₃O⁺ ion donor is selected from the group consisting of hydrochloric acid, sulphuric acid, sulphurous acid, phosphoric acid, oxalic acid, H₂PO₄⁻, being at least partially neutralised by a cation selected from Li⁺, Na⁺ and/or K⁺, HPO₄²⁻, being at least partially neutralised by a cation selected from Li⁺, Na⁺, K⁺, Mg²⁺, and/or Ca²⁺, and mixtures thereof, more preferably the at least one H₃O⁺ ion donor is selected from the group consisting of hydrochloric acid, sulphuric acid, sulphurous acid, phosphoric acid, oxalic acid, or mixtures thereof, and most preferably, the at least one H₃O⁺ ion donor is phosphoric acid. According to a further embodiment the precipitated hydromagnesite is surface-treated precipitated hydromagnesite, or a mixture of precipitated hydromagnesite and surface-treated precipitated hydromagnesite.

According to one embodiment the filler comprises at least one surface-treatment layer on at least a part of the surface of the filler, wherein the at least one surface-treatment layer is formed by contacting the filler with at least one surface-treatment composition in an amount from 0.07 to 9 mg/m² of the filler surface, preferably 0.1 to 8 mg/m², more preferably from 0.11 to 3 mg/m², and wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated or unsaturated fatty acids, salts of saturated or unsaturated fatty acids, saturated or unsaturated esters of phosphoric acid, salts of saturated or unsaturated phosphoric acid esters, abietic acid, salts of abietic acid, polydialkylsiloxanes, trialkoxysilanes, and mixtures thereof and reaction products thereof, preferably the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferably completely neutralized surface treatment agents; and/or
b) a maleic anhydride grafted polybutadiene homopolymer or a maleic anhydride grafted polybutadiene-styrene copolymer and/or an acid and/or salt thereof, preferably a maleic anhydride grafted polybutadiene homopolymer having
i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of anhydride groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) an acid number in the range from 10 to 300 meq KOH/g of maleic anhydride grafted polybutadiene homopolymer, preferably 20 to 200 meq KOH/g, more preferably 30 to 150 meq KOH/g, measured according to ASTM D974-14, and/or
v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer,
and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof, preferably at least one aliphatic carboxylic acid having a total amount of carbon atoms from C₄ to C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cm and/or a salt thereof and/or
f) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or
g) at least one polydialkylsiloxane, preferably selected from the group consisting of polydimethylsiloxane, preferably dimethicone, polydiethylsiloxane, polymethylphenylsiloxane and mixtures thereof, and/or
h) mixtures of the materials according to a) to g).

According to one embodiment the curable elastomer composition comprises a crosslinking agent, preferably the crosslinking agent is selected from the group consisting of peroxide curing agents, sulphur-based curing agents, bisphenol-based crosslinking agents, amine or diamine-based crosslinking agents, and mixtures thereof. According to a further embodiment the curable elastomer composition further comprises colouring pigment, dyes, wax, lubricant, oxidative- and/or UV-stabilizer, antioxidant, additional filler, processing aid, plasticizer, additional polymer, and mixtures thereof, preferably the additional filler is selected from the group comprising carbon black, silica, ground natural calcium carbonate, precipitated calcium carbonate, nanofiller, graphite, clay, talc, kaolin clay, calcined kaolin, calcined clay, diatomaceous earth, barium sulfate, titanium dioxide, wollastonite, and mixtures thereof, more preferably ground natural calcium carbonate, precipitated calcium carbonate, barium sulfate, carbon black, silica, wollastonite, and mixtures thereof, and most preferably carbon black.

According to one embodiment of the inventive method, the curing step iv) is carried out by adding a crosslinking agent, heat treatment, ultraviolet light radiation, electron-beam radiation and/or nuclear radiation.

According to one embodiment of the inventive use, the tear resistance and/or the elongation at break and/or the tensile strength and/or the tensile modulus of the cured elastomer product is increased compared to a cured elastomer without filler by at least 5%, preferably by at least 10%, more preferably by at least 15%, and most preferably by at least 20%, and/or wherein the tear resistance and/or the elongation at break and/or the tensile strength and/or the tensile modulus of the cured elastomer product is increased compared to a cured elastomer product containing an isovolumic amount of carbon black N550 as filler by at least 5%, preferably by at least 10%, more preferably by at least 15%, and most preferably by at least 20%, wherein the carbon black has a statistical thickness surface area (STSA) of 39±5 m²/g, measured according to ASTM D 6556-19, the tear resistance is measured according to NF ISO 34-2, and the elongation at break, the tensile strength and the tensile modulus are measured according NF ISO 37.

According to one embodiment of the inventive process, in step I) the precipitated hydromagnesite is provided in form of an aqueous suspension having a solids content in the range from 5 to 80 wt.-%, based on the total weight of the aqueous suspension, step III) is carried out by adding the at least one surface-treatment composition to the aqueous suspension and mixing the aqueous suspension at a temperature in the range from 20 to 120° C., and the process further comprises the step of: IV) drying the aqueous suspension during or after step III) at a temperature in the range from 40 to 160° C. at ambient or reduced pressure until the moisture content of the obtained surface-treated precipitated hydromagnesite is in the range from 0.001 to 20 wt.-%, based on the total weight of the surface-treated precipitated hydromagnesite.

It should be understood that for the purpose of the present invention, the following terms have the following meaning:

The term “acid” as used herein refers to an acid in the meaning of the definition by Brønsted and Lowry (e.g., H₂SO₄, HSO₄⁻), wherein the term “free acid” refers only to those acids being in the fully protonated form (e.g., H₂SO₄).

As used herein the term “polymer” generally includes homopolymers and co-polymers such as, for example, block, graft, random and alternating copolymers, as well as blends and modifications thereof. The polymer can be an amorphous polymer, a crystalline polymer, or a semi-crystalline polymer, i.e. a polymer comprising crystalline and amorphous fractions. The degree of crystallinity is specified in percent and can be determined by differential scanning calorimetry (DSC). An amorphous polymer may be characterized by its glass transition temperature and a crystalline polymer may be characterized by its melting point. A semi-crystalline polymer may be characterized by its glass transition temperature and/or its melting point.

The term “copolymer” as used herein refers to a polymer derived from more than one species of monomer. Copolymers that are obtained by copolymerization of two monomer species may also be termed bipolymers, those obtained from three monomers terpolymers, those obtained from four monomers quaterpolymers, etc. (cf. IUPAC Compendium of Chemical Terminology 2014, “copolymer”). Accordingly, the term “homopolymer” refers to a polymer derived from one species of monomer.

An “elastomer” is a polymer that shows rubber-like elasticity, and comprises crosslinks, preferably permanent crosslinks.

For the purposes of the present invention, a “crosslinkable polymer” is a polymer, which comprises crosslinkable sites, e.g., carbon multiple bonds, halogen functional groups, or hydrocarbon moieties, and which upon crosslinking forms an elastomer. The term is used synonymously with the term “elastomer precursor”.

For the purpose of the present invention, the term “rubber” refers to a crosslinkable polymer or elastomer precursor, which can be converted into an elastomer by a curing reaction, e.g. by vulcanization.

The term “glass transition temperature” in the meaning of the present invention refers to the temperature at which the glass transition occurs, which is a reversible transition in amorphous materials (or in amorphous regions within semi-crystalline materials) from a hard and relatively brittle state into a molten or rubber-like state. The glass-transition temperature is always lower than the melting point of the crystalline state of the material, if one exists. The term “melting point” in the meaning of the present invention refers to the temperature at which a solid changes state from solid to liquid at atmospheric pressure. At the melting point the solid and liquid phase exist in equilibrium. Glass-transition temperature and melting point are determined by ISO 11357 with a heating rate of 10° C./min.

For the purpose of the present application, “water-insoluble” materials are defined as materials which, when 100 g of said material is mixed with 100 g deionised water and filtered on a filter having a 0.2 mm pore size at 20° C. to recover the liquid filtrate, provide less than or equal to 1 g of recovered solid material following evaporation at 95 to 100° C. of 100 g of said liquid filtrate at ambient pressure. “Water-soluble” materials are defined as materials which, when 100 g of said material is mixed with 100 g deionised water and filtered on a filter having a 0.2 mm pore size at 20° C. to recover the liquid filtrate, provide more than 1 g of recovered solid material following evaporation at 95 to 100° C. of 100 g of said liquid filtrate at ambient pressure.

The term “surface-reacted” in the meaning of the present application shall be used to indicate that a material has been subjected to a process comprising partial dissolution of said material in aqueous environment followed by a crystallization process on and around the surface of said material, which may occur in the absence or presence of further crystallization additives.

The term “surface-treated” in the meaning of the present invention refers to a material which has been contacted with at least one surface-treatment composition comprising at least one surface treatment agent such as to obtain at least one surface-treatment layer on at least a part of the surface of the material.

The “particle size” of particulate materials, other than surface-reacted calcium carbonate and precipitated hydromagnesite, herein is described by its weight-based distribution of particle sizes dₓ. Therein, the value dₓ represents the diameter relative to which x % by weight of the particles have diameters less than dₓ. This means that, for example, the d₂₀ value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀ (wt) unless indicated otherwise. Particle sizes were determined by using a Sedigraph™ 5100 instrument or Sedigraph™ 5120 instrument of Micromeritics Instrument Corporation. The method and the instrument are known to the skilled person and are commonly used to determine the particle size of fillers and pigments. The measurements were carried out in an aqueous solution of 0.1 wt.-% Na₄P₂O₇.

The “particle size” of surface-reacted calcium carbonate and precipitated hydromagnesite herein is described as volume-based particle size distribution. Volume-based median particle size d₅₀ was evaluated using a Malvern Mastersizer 2000 or 3000 Laser Diffraction System. The d₅₀ or d₉₈ value, measured using a Malvern Mastersizer 2000 or 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

A “salt” in the meaning of the present invention is a chemical compound consisting of an assembly of cations and anions (cf. IUPAC, Compendium of Chemical Terminology, 2nd Ed. (the “gold book”), 1997, “salt”).

The “specific surface area” (expressed in m²/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 30 min prior to measurement. The total surface area (in m²) of said material can be obtained by multiplication of the specific surface area (in m²/g) and the mass (in g) of the material.

For the purpose of the present invention, the “solids content” of a liquid composition is a measure of the amount of material remaining after all the solvent or water has been evaporated. If necessary, the “solids content” of a suspension given in wt. % in the meaning of the present invention can be determined using a Moisture Analyzer HR73 from Mettler-Toledo (T=120° C., automatic switch off 3, standard drying) with a sample size of 5 to 20 g.

Unless specified otherwise, the term “drying” refers to a process according to which at least a portion of water is removed from a material to be dried such that a constant weight of the obtained “dried” material at 200° C. is reached. Moreover, a “dried” or “dry” material may be defined by its total moisture content which, unless specified otherwise, is less than or equal to 1.0 wt. %, preferably less than or equal to 0.5 wt. %, more preferably less than or equal to 0.2 wt. %, and most preferably between 0.03 and 0.07 wt. %, based on the total weight of the dried material.

For the purpose of the present invention, the term “viscosity” or “Brookfield viscosity” refers to Brookfield viscosity. The Brookfield viscosity can for this purpose be measured by a Brookfield DV-II+ Pro viscometer at 25° C.±1° C. at 100 rpm using an appropriate spindle of the Brookfield RV-spindle set and is specified in mPa·s. Based on his technical knowledge, the skilled person will select a spindle from the Brookfield RV-spindle set which is suitable for the viscosity range to be measured. For example, for a viscosity range between 200 and 800 mPa·s the spindle number 3 may be used, for a viscosity range between 400 and 1 600 mPa·s the spindle number 4 may be used, for a viscosity range between 800 and 3 200 mPa·s the spindle number 5 may be used, for a viscosity range between 1 000 and 2 000 000 mPa·s the spindle number 6 may be used, and for a viscosity range between 4 000 and 8 000 000 mPa·s the spindle number 7 may be used.

A “suspension” or “slurry” in the meaning of the present invention comprises undissolved solids and water, and optionally further additives, and usually contains large amounts of solids and, thus, is more viscous and can be of higher density than the liquid from which it is formed.

The term “aqueous” suspension refers to a system, wherein the liquid phase comprises, preferably consists of, water. However, said term does not exclude that the liquid phase of the aqueous suspension comprises minor amounts of at least one water-miscible organic solvent selected from the group comprising methanol, ethanol, acetone, acetonitrile, tetrahydrofuran and mixtures thereof. If the aqueous suspension comprises at least one water-miscible organic solvent, the liquid phase of the aqueous suspension comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the aqueous suspension. For example, the liquid phase of the aqueous suspension consists of water.

The “moisture pick-up susceptibility” of a material refers to the amount of moisture absorbed on the surface of said material within a certain time upon exposure to a defined humid atmosphere and is expressed in mg/g. The “normalized moisture pick-up susceptibility” of a material refers to the amount of moisture absorbed on the surface of said material within a certain time upon exposure to a defined humid atmosphere and is expressed in mg/m².

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

The curable elastomer composition of the present invention comprises a crosslinkable polymer, and a filler selected from surface-reacted calcium carbonate, precipitated hydromagnesite, or a mixture thereof. The surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

In the following, preferred embodiments of the inventive products will be set out in more detail. It is to be understood that these embodiments and details also apply to the inventive method for their production and their uses.

### The Crosslinkable Polymer

The curable elastomer composition of the present invention comprises a crosslinkable polymer.

The term “crosslinkable” indicates that the polymer contains at least one site or group, which is capable of forming a crosslink between two polymer chains during curing of the polymer. A “crosslink” in the meaning of the present invention is a small region in a polymer from which at least four chains emanate, and is formed by reactions involving sites or groups on an existing polymer or by interactions between existing polymers, wherein the small region may be an atom, a group of atoms, or a number of branch points connected by bonds, groups of atoms, or oligomeric chains (cf. IUPAC, Compendium of Chemical Terminology, 2nd Ed. (the “gold book”), 1997, “crosslink”). Preferably, the crosslink may be a covalent structure e.g. a covalent bond or a short sequence of chemical bonds, which joins two polymer chains together. The formation of crosslinks within the crosslinkable polymer results in a polymer network, and thus, in a polymer of higher molecular weight. Thus, it is understood that the elastomer of the present invention is formed by crosslinking of a crosslinkable polymer, also denoted as the elastomer precursor. Any crosslinking method, such as chemical crosslinking by crosslinking agents, vulcanization, curing by ultraviolet light radiation, electron-beam radiation, nuclear radiation, gamma radiation, microwave radiation and/or ultrasonic radiation, is suitable for the purposes of the present invention.

The crosslinkable polymer of the present invention may be a natural rubber or a synthetic rubber. According to one embodiment the crosslinkable polymer is selected from natural or synthetic rubber, preferably the crosslinkable polymer is selected from the group consisting of acrylic rubber, butadiene rubber, acrylonitrile-butadiene rubber, epichlorhydrin rubber, isoprene rubber, ethylene-propylene rubber, ethylene-propylene-diene rubber, nitrile-butadiene rubber, butyl rubber, styrene-butadiene rubber, polyisoprene, hydrogenated nitrile-butadiene rubber, carboxylated nitrile-butadiene rubber, chloroprene rubber, isoprene isobutylene rubber, chloro-isobutene-isoprene rubber, brominated isobutene-isoprene rubber, silicone rubber, fluorocarbon rubber, polyurethane rubber, polysulfide rubber, thermoplastic rubber, and mixtures thereof. Especially preferred rubbers according to the present invention are nitrile-butadiene rubber and/or ethylene-propylene-diene rubber. These types of rubber are well-known to the skilled person (see Winnacker/Kuchler, “Chemische Technik. Prozesse and Produkte”, 5^{th} vol., 5^{th} Ed., Wiley-VCH 2005, Ch. 4, pp. 821 to 896). Commonly, the rubbers are denoted in abbreviated form according to DIN ISO-R 1629:2015-03 or ASTM D1418-17.

Natural rubber (NR) in the sense of the present invention is a polymeric material comprising crosslinked polyisoprene, wherein the polyisoprene may be obtained from natural sources, such as the rubber tree (Hevea Brasiliensis), spurges (Euphorbia spp.), dandelion (Taxacum officinale and Taxacum kok-saghyz), Palaquium gutta, rubber fig (Ficus elastica), bulletwood (Manilkara bidentata) or guayule (Parthenium argentatum). Depending on the source of natural rubber, the rubber may be present, e.g., as caoutchouc (cis-1,4-polyisoprene), gutta-percha (trans-1,4-polyisoprene), or chicle (commonly a mixture of cis-1,4-polyisoprene and trans-1,4-polyisoprene).

Synthetic rubbers are commonly produced from radical, anionic, cationic or coordination polymerization from synthetic monomers, and subsequent crosslinking. The polymerization reaction may be performed, e.g., as polymerization in emulsion, solution, or suspension.

For example, ethylene-propylene rubber (EPR) is typically formed by radical copolymerization of ethylene and propylene. Optionally, small amounts (e.g., less than 10 mol-%, based on the total amount of monomers, preferably less than 5 mol-%) of diene monomers, such as butadiene, dicyclopentadiene, ethylidene norbornene or norbornadiene may be present. If a diene monomer is present during the copolymerization, the formed ethylene-propylene rubber is denoted as ethylene-propylene-diene rubber (EPDM) and comprises unsaturated carbon moieties, which may facilitate crosslinking of the obtained rubber. Alternatively, EPDM may be synthesized by coordination polymerization using vanadium-based catalysts, such as VCl₄ or VOCl₃. According to a preferred embodiment of the present invention, the crosslinkable polymer is ethylene-propylene-diene rubber (EPDM).

Butadiene rubbers (BR) are commonly formed from coordination polymerization of butadiene in the presence of Ziegler-Natta catalysts, and also by anionic polymerization. The butadiene rubber thus obtained may have different structural units, such as cis-1,4-, trans-1,4- and 1,2-butadiene structural units, wherein the latter may be present in syndiotactic, isotactic and/or atactic form.

Styrene-butadiene rubbers (SBR) are copolymers of styrene and butadiene, which may be present as random copolymers or block-copolymers. Specific examples include E-SBR (i.e., SBR obtained by emulsion polymerization) and L-SBR (i.e., SBR obtained by anionic polymerization in solution).

Nitrile-butadiene rubbers (NBR) typically are statistical copolymers of acrylonitrile and butadiene, which may comprise cis-1,4-, trans-1,4- and 1,2-butadiene and acrylonitrile structural units in varying amounts. The skilled person knows how to adjust the polymerization conditions in emulsion copolymerization, e.g., the monomer ratio, reaction time, reaction temperature, use of emulsifiers, accelerators (e.g., thiurams, dithiocarbamates, sulfonamides, benzothiazole disulfide) and chain terminating agents (such as dimethyldithiocarbamate and diethyl hydroxylamine), in order to obtain a suitable distribution of these structural units. NBR may have a number average molecular weight Mₙ in a broad range from 1500 g/mol to 1500 kg/mol, for example from 3000 g/mol to 1000 kg/mol, or from 5000 g/mol to 500 kg/mol. The acrylonitrile content may range from 10 mol-% to 75 mol-%, preferably to 60 mol-%, based on the total amount of monomer units. NBR may be resistant to oil, fuel and other non-polar chemicals, and therefore, is commonly applied in fuel and oil handling hoses, seals, grommets, and self-sealing fuel tanks, protective gloves, footwear, sponges, expanded foams, mats and in aeronautical applications. Mixtures of NBR with other rubbers, such as EPDM, or thermoplastic polymers, such as PVC, may also be employed).

Hydrogenated nitrile-butadiene rubber (HNBR) may be obtained by hydrogenation of NBR in the presence of hydrogenation catalysts, such as cobalt-, rhodium-, ruthenium-, iridium-, or palladium-based systems.

In another embodiment of the present invention, carboxylated NBR (XNBR) may be used, which may be obtained by copolymerization of butadiene and acrylonitrile with small amounts (e.g., less than 10 mol-%, preferably less than 5 mol-%, based on the total amount of monomers) of acrylic or methacrylic acid. XNBR may be crosslinked by the addition of metal salts, preferably multivalent metal salts, such as calcium salts, zinc salts, magnesium salts, zirconium salts, or aluminum salts, in addition or alternatively to the crosslinking methods described hereinbelow.

Polyisoprene, also termed isoprene rubber (IR), may be synthesized by anionic or Ziegler-Natta polymerization of isoprene, and may comprise cis-1,4-, trans-1,4-, 1,2-, and 3,4-isoprene structural units. The skilled person knows how to adjust the reaction conditions in order to obtain a suitable molar distribution of said building units.

Isobutene-isoprene rubbers (IIR), also termed butyl rubber, are typically synthesized by cationic polymerization starting from isobutene and isoprene monomer units in the presence of a catalyst, such as aluminum trichloride or dialkylaluminum chlorides. Halogenated IIR, such as chlorinated IIR (CIIR) or brominated IIR (BIIR) may suitably be obtained by post polymerization modification of IIR, e.g., chlorination using chlorine or bromination using bromine, which is typically performed under exclusion of light and temperatures in the range from 40 to 60° C. The halogen content of the halogenated IIRs preferably is in the range from 0.5 to 5 wt.-%, more preferably 1.0 to 2.5 wt.-%, based on the total weight of the halogenated IIR.

Polychloroprene, also denoted as chloroprene rubber (CR), may be produced by radical emulsion polymerization of chloroprene (2-chlorobutadiene). The polymer may primarily comprise trans-1,4-chloroprene and 1,2-chloroprene units in varying amounts, depending on the polymerization conditions, which may be suitably adapted by the skilled person. In addition or alternatively to the crosslinking methods hereinbelow, CR may be crosslinked at higher temperatures due to the extrusion of hydrochloric acid, optionally in the presence of an acid acceptor, such as a metal oxide or hydroxide, preferably zinc oxide, magnesium oxide, or combinations thereof. Said acid acceptor may be introduced into the elastomer already during polymerization or during mixing of the elastomer precursor with the remaining compounds of the elastomer composition.

Acrylic rubbers (ACM) may be synthesized by emulsion or suspension radical polymerization. Typical monomers comprise acrylic acid ester monomers, preferably comprising a saturated or unsaturated, linear or branched group comprising from 1 to 20 carbon atoms, preferably 1 to 8 carbon atoms. Suitable ACM are commercially available, e.g., under the tradenames Noxtite® ACM or Nipol® AR.

Epichlorohydrin rubbers may be obtained by ring-opening polymerization of epichlorohydrin, optionally further comprising monomers selected from the group comprising ethylene oxide, propylene oxide, and allylglycidyl ether, typically in the presence of a catalyst, such as trialkyl aluminum.

Silicone rubbers typically are poly(diorganyl)siloxanes and may be formed by hydrolysis-condensation of, e.g., diorganyldihalogenidosiloxanes. The organyl groups may be selected from the group comprising alkyl, aryl, and alkenyl groups.

Polyurethane rubbers comprise urethane structural building units formed from the reaction of isocyanates (i.e., diisocyanates and polyisocyanates) and alcohols (i.e., diols, triols, polyols).

Polysulfide rubbers may be formed from the polycondensation reaction of dihalides (X—R—X) with sodium polysulfides (Na—Sₓ—Na, with x≥2). Typical examples include Thiokol A, Thiokol FA, and Thiokol ST.

Thermoplastic rubbers (TPR or TPE) in the meaning of the present invention are materials, which show elastic properties, and processing properties of thermoplastic materials. The TPR may be selected from the group comprising block copolymers, such as styrene-diene block copolymers, styrene-ethylene-butylene rubbers, polyester TPE, polyurethane TPE or polyamide TPE, mixtures of elastomers and non-elastomers, such as mixtures of EPDM with PP and/or PE, mixtures of NR with polyolefins, or mixtures of IIR and polyolefins, and ionomeric polymers, for example zincous salts of sulfonated and maleinized EPDM.

A “fluorocarbon rubber” in the meaning of the present invention is a fluorine-containing polymer which has a low Tg value, e.g. a Tg value of less than 0° C., preferably less than −5° C., more preferably less than −10° C., and most preferably less than −15° C., and displays rubber-like elasticity (cf. IUPAC, Compendium of Chemical Terminology, 2nd Ed. (the “gold book”), 1997, “elastomer”). Fluorocarbon rubbers may be categorized according to ASTM D1418—“Standard Practice for Rubber and Rubber Latices—Nomenclature”. ASTM D1418 specifies three classes of fluorocarbon rubbers:

FKM fluorocarbon rubbers: Fluororubber of the polymethylene type that utilizes vinylidene fluoride as a comonomer and have substituent fluoro, alkyl, perfluoroalkyl or perfluoroalkoxy groups in the polymer chain, with or without a curesite monomer. FFKM fluorocarbon rubbers: Perfluororubber of the polymethylene type having all substituent groups on the polymer chain either fluoro, perfluoroalkyl, or perfluoroalkoxy groups. FEPM fluorocarbon rubbers: Fluororubber of the polymethylene type containing one or more of the monomeric alkyl, perfluoroalkyl, and/or perfluoroalkoxy groups with or without a curesite monomer (having a reactive pendant group). Most preferably the fluorocarbon rubber is a copolymer of vinylidene fluoride, hexafluoropropylene, and tetrafluoroethylene.

Methods for producing fluorocarbon rubbers are known in the art. Alternatively, fluorocarbon rubbers are commercially available. Examples of commercially available fluorocarbon rubbers are Viton®, Viton® Extreme™, and Kalrez® fluorocarbon rubbers of DuPont Corporation, Dyneon™ fluorocarbon rubbers of 3M Corporation, DAI-EL™ fluorocarbon rubbers of Daikin Industries, Technoflon® of Solvay S.A., and Aflas® of Asahi Glass Co., Ltd. The skilled person will select the appropriate grade within these fluorocarbon rubber brands according to his needs.

According to one embodiment, the crosslinkable polymer has a specific gravity from 0.5 to 5, preferably from 0.7 to 4, and more preferably from 1 to 3, measured according to ASTM D297.

According to one embodiment the curable elastomer composition comprises the crosslinkable polymer in an amount from 20 to 99 wt.-%, preferably in an amount from 40 to 98 wt.-%, more preferably from 60 to 95 wt.-%, and most preferably from 70 to 90 wt.-%, based on the total weight of the curable fluoropolymer composition. According to another embodiment the curable elastomer composition comprises the crosslinkable polymer in an amount from 20 to 99 wt.-%, preferably in an amount from 40 to 98 wt.-%, more preferably from 60 to 95 wt.-%, and most preferably from 70 to 90 wt.-%, based on the total weight of the crosslinkable polymer and the filler.

The crosslinkable polymer may be provided in solid form or molten form. According to one embodiment, the crosslinkable polymer is a solid polymer, for example, in form of granules, sheets, or a powder. According to another embodiment, the crosslinkable polymer is a molten polymer. According to a preferred embodiment, the crosslinkable polymer is provided in solid form.

### Filler

In addition to the crosslinkable polymer, the curable elastomer composition of the present invention comprises a filler selected from surface-reacted calcium carbonate, precipitated hydromagnesite, or a mixture thereof, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donor treatment and/or is supplied from an external source.

According to one embodiment the filler is present in an amount from 1 to 80 wt.-%, preferably from 2 to 70 wt.-%, more preferably from 5 to 60 wt.-%, and most preferably from 10 to 50 wt.-%, based on the total weight of the curable elastomer composition. According to another embodiment the filler is present in an amount from 1 to 80 wt.-%, preferably from 2 to 70 wt.-%, more preferably from 5 to 60 wt.-%, and most preferably from 10 to 50 wt.-%, based on the total weight of the crosslinkable polymer and the filler. According to another embodiment, the filler is present in an amount from 5 to 175 parts per hundred (phr), preferably from 20 to 160 phr, and most preferably from 30 to 150 phr, based on the total weight of the crosslinkable polymer.

In a preferred embodiment, the filler has a specific surface area of from 15 m²/g to 200 m²/g, preferably from 20 m²/g to 180 m²/g, more preferably from 25 m²/g to 140 m²/g, even more preferably from 27 m²/g to 120 m²/g, most preferably from 30 m²/g to 100 m²/g, measured using nitrogen and the BET method. For example, the filler has a specific surface area of from 75 m²/g to 100 m²/g, measured using nitrogen and the BET method. The BET specific surface area in the meaning of the present invention is defined as the surface area of the particles divided by the mass of the particles. As used therein the specific surface area is measured by adsorption using the BET isotherm (ISO 9277:2010) and is specified in m²/g.

It is furthermore preferred that the filler particles have a volume median particle size d₅₀ of from 0.1 to 75 μm, preferably from 0.5 to 50 μm, more preferably 1 to 40 μm, even more preferably from 1.2 to 30 μm, and most preferably from 1.5 to 15 μm.

According to one embodiment the filler particles have a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm.

The value dₓ represents the diameter relative to which x % of the particles have diameters less than dₓ. This means that the d₉₈ value is the particle size at which 98% of all particles are smaller. The d₉₈ value is also designated as “top cut”. The dₓ values may be given in volume or weight percent. The d₅₀ (wt) value is thus the weight median particle size, i.e. 50 wt.-% of all grains are smaller than this particle size, and the d₅₀ (vol) value is the volume median particle size, i.e. 50 vol.-% of all grains are smaller than this particle size.

Volume median particle size d₅₀ was evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

The weight median particle size is determined by the sedimentation method, which is an analysis of sedimentation behaviour in a gravimetric field. The measurement is made with a Sedigraph™ 5100 or 5120, Micromeritics Instrument Corporation. The method and the instrument are known to the skilled person and are commonly used to determine grain size of fillers and pigments. The measurement is carried out in an aqueous solution of 0.1 wt.-% Na₄P₂O₇. The samples were dispersed using a high speed stirrer and sonicated.

The processes and instruments are known to the skilled person and are commonly used to determine particle size of fillers and pigments.

The specific pore volume is measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm (˜nm). The equilibration time used at each pressure step is 20 seconds. The sample material is sealed in a 5 cm³ chamber powder penetrometer for analysis. The data are corrected for mercury compression, penetrometer expansion and sample material compression using the software Pore-Comp (Gane, P. A. C., Kettle, J. P., Matthews, G. P. and Ridgway, C. J., “Void Space Structure of Compressible Polymer Spheres and Consolidated Calcium Carbonate Paper-Coating Formulations”, Industrial and Engineering Chemistry Research, 35(5), 1996, p₁₇₅₃-1764).

The total pore volume seen in the cumulative intrusion data can be separated into two regions with the intrusion data from 214 μm down to about 1-4 μm showing the coarse packing of the sample between any agglomerate structures contributing strongly. Below these diameters lies the fine interparticle packing of the particles themselves. If they also have intraparticle pores, then this region appears bi modal, and by taking the specific pore volume intruded by mercury into pores finer than the modal turning point, i.e. finer than the bi-modal point of inflection, the specific intraparticle pore volume is defined. The sum of these three regions gives the total overall pore volume of the powder, but depends strongly on the original sample compaction/settling of the powder at the coarse pore end of the distribution.

By taking the first derivative of the cumulative intrusion curve the pore size distributions based on equivalent Laplace diameter, inevitably including pore-shielding, are revealed. The differential curves clearly show the coarse agglomerate pore structure region, the interparticle pore region and the intraparticle pore region, if present. Knowing the intraparticle pore diameter range it is possible to subtract the remainder interparticle and interagglomerate pore volume from the total pore volume to deliver the desired pore volume of the internal pores alone in terms of the pore volume per unit mass (specific pore volume). The same principle of subtraction, of course, applies for isolating any of the other pore size regions of interest.

Preferably, the filler has an intra-particle intruded specific pore volume in the range from 0.1 to 2.3 cm³/g, more preferably from 0.2 to 2.0 cm³/g, especially preferably from 0.4 to 1.8 cm³/g and most preferably from 0.6 to 1.6 cm³/g, calculated from mercury porosimetry measurement.

The intra-particle pore size of the filler preferably is in a range of from 0.004 to 1.6 μm, more preferably in a range of from 0.005 to 1.3 μm, especially preferably from 0.006 to 1.15 μm and most preferably of 0.007 to 1.0 μm, e.g. 0.1 to 0.67 μm determined by mercury porosimetry measurement.

The filler may be provided in any suitable dry form. For example, the filler may be in form of a powder and/or in pressed or granulated form. The moisture content of the filler may be between 0.01 and 10 wt.-%, based on the total weight of the filler. According to one embodiment, the moisture content of the filler is less than or equal to 8 wt.-%, based on the total weight of the filler, preferably less than or equal to 6 wt.-%, and more preferably less than or equal to 4 wt.-%. According to another embodiment, the moisture content of the filler is between 0.01 and 8 wt.-%, preferably between 0.02 and 6 wt.-%, and more preferably between 0.03 and 4 wt.-%, based on the total weight of the filler.

According to one embodiment the moisture pick-up susceptibility of the filler is from 0.3 to 60 mg/g, preferably from 1 to 50 mg/g, more preferably from 2 to 40 mg/g, and most preferably from 4 to 35 mg/g.

### Surface-Reacted Calcium Carbonate

According to one embodiment, the filler is surface-reacted calcium carbonate and/or a mixture of surface-reacted calcium carbonate and precipitated hydromagnesite, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source. According to another embodiment, the filler is surface-reacted calcium carbonate as defined herein. According to still another embodiment, the filler is a mixture of surface-reacted calcium carbonate as defined herein and precipitated hydromagnesite.

An H₃O⁺ ion donor in the context of the present invention is a Brønsted acid and/or an acid salt.

In a preferred embodiment of the invention the surface-reacted calcium carbonate is obtained by a process comprising the steps of: (a) providing a suspension of natural or precipitated calcium carbonate, (b) adding at least one acid having a pKₐ value of 0 or less at 20° C. or having a pKₐ value from 0 to 2.5 at 20° C. to the suspension of step (a), and (c) treating the suspension of step (a) with carbon dioxide before, during or after step (b). According to another embodiment the surface-reacted calcium carbonate is obtained by a process comprising the steps of: (A) providing a natural or precipitated calcium carbonate, (B) providing at least one water-soluble acid, (C) providing gaseous CO₂, (D) contacting said natural or precipitated calcium carbonate of step (A) with the at least one acid of step (B) and with the CO₂ of step (C), characterised in that: (i) the at least one acid of step B) has a pKₐ of greater than 2.5 and less than or equal to 7 at 20° C., associated with the ionisation of its first available hydrogen, and a corresponding anion is formed on loss of this first available hydrogen capable of forming a water-soluble calcium salt, and (ii) following contacting the at least one acid with natural or precipitated calcium carbonate, at least one water-soluble salt, which in the case of a hydrogen-containing salt has a pKₐ of greater than 7 at 20° C., associated with the ionisation of the first available hydrogen, and the salt anion of which is capable of forming water-insoluble calcium salts, is additionally provided.

“Natural ground calcium carbonate” (GCC) in the meaning of the present invention is a calcium carbonate obtained from natural sources, such as limestone, marble, or chalk, and processed through a wet and/or dry treatment such as grinding, screening and/or fractionating, for example, by a cyclone or classifier. According to one embodiment natural ground calcium carbonate (GCC) is selected from calcium carbonate containing minerals selected from the group comprising marble, chalk, limestone and mixtures thereof. Natural calcium carbonate may comprise further naturally occurring components such as magnesium carbonate, alumino silicate etc.

In general, the grinding of natural ground calcium carbonate may be a dry or wet grinding step and may be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. In case the calcium carbonate containing mineral material comprises a wet ground calcium carbonate containing mineral material, the grinding step may be performed under conditions such that autogenous grinding takes place and/or by horizontal ball milling, and/or other such processes known to the skilled man. The wet processed ground calcium carbonate containing mineral material thus obtained may be washed and dewatered by well-known processes, e.g. by flocculation, filtration or forced evaporation prior to drying. The subsequent step of drying (if necessary) may be carried out in a single step such as spray drying, or in at least two steps. It is also common that such a mineral material undergoes a beneficiation step (such as a flotation, bleaching or magnetic separation step) to remove impurities.

“Precipitated calcium carbonate” (PCC) in the meaning of the present invention is a synthesized material, generally obtained by precipitation following reaction of carbon dioxide and calcium hydroxide in an aqueous, semi-dry or humid environment or by precipitation of calcium and carbonate ions, for example CaCl₂) and Na₂CO₃, out of solution. Further possible ways of producing PCC are the lime soda process, or the Solvay process in which PCC is a by-product of ammonia production. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained PCC slurry can be mechanically dewatered and dried. PCCs are described, for example, in EP 2 447 213 A1, EP 2 524 898 A1, EP 2 371 766 A1, EP 1 712 597 A1, EP 1 712 523 A1, or WO 2013/142473 A1.

According to one embodiment of the present invention, the precipitated calcium carbonate is precipitated calcium carbonate, preferably comprising aragonitic, vateritic or calcitic mineralogical crystal forms or mixtures thereof.

Precipitated calcium carbonate may be ground prior to the treatment with carbon dioxide and at least one H₃O⁺ ion donor by the same means as used for grinding natural calcium carbonate as described above.

According to one embodiment of the present invention, the natural or precipitated calcium carbonate is in form of particles having a weight median particle size d₅₀ of 0.05 to 10.0 μm, preferably 0.2 to 5.0 μm, more preferably 0.4 to 3.0 μm, most preferably 0.6 to 1.2 μm, especially 0.7 μm. According to a further embodiment of the present invention, the natural or precipitated calcium carbonate is in form of particles having a top cut particle size d₉₈ of 0.15 to 55 μm, preferably 1 to μm, more preferably 2 to 25 μm, most preferably 3 to 15 μm, especially 4 μm.

The natural and/or precipitated calcium carbonate may be used dry or suspended in water. Preferably, a corresponding slurry has a content of natural or precipitated calcium carbonate within the range of 1 wt.-% to 90 wt.-%, more preferably 3 wt.-% to 60 wt.-%, even more preferably 5 wt.-% to 40 wt.-%, and most preferably 10 wt.-% to 25 wt.-% based on the weight of the slurry.

The one or more H₃O⁺ ion donor used for the preparation of surface reacted calcium carbonate may be any strong acid, medium-strong acid, or weak acid, or mixtures thereof, generating H₃O⁺ ions under the preparation conditions. According to the present invention, the at least one H₃O⁺ ion donor can also be an acidic salt, generating H₃O⁺ ions under the preparation conditions.

According to one embodiment, the at least one H₃O⁺ ion donor is a strong acid having a pKₐ of 0 or less at 20° C.

According to another embodiment, the at least one H₃O⁺ ion donor is a medium-strong acid having a pKₐ value from 0 to 2.5 at 20° C. If the pKₐ at 20° C. is 0 or less, the acid is preferably selected from sulphuric acid, hydrochloric acid, or mixtures thereof. If the pKₐ at 20° C. is from 0 to 2.5, the H₃O⁺ ion donor is preferably selected from H₂SO₃, H₃PO₄, oxalic acid, or mixtures thereof. The at least one H₃O⁺ ion donor can also be an acidic salt, for example, HSO₄⁻ or H₂PO₄, being at least partially neutralized by a corresponding cation such as Li⁺, Na⁺ or K⁺, or HPO₄²⁻, being at least partially neutralised by a corresponding cation such as Li⁺, Na⁺, K⁺, Mg²⁺ or Ca²⁺. The at least one H₃O⁺ ion donor can also be a mixture of one or more acids and one or more acidic salts.

According to still another embodiment, the at least one H₃O⁺ ion donor is a weak acid having a pKₐ value of greater than 2.5 and less than or equal to 7, when measured at 20° C., associated with the ionisation of the first available hydrogen, and having a corresponding anion, which is capable of forming water-soluble calcium salts. Subsequently, at least one water-soluble salt, which in the case of a hydrogen-containing salt has a pKₐ of greater than 7, when measured at 20° C., associated with the ionisation of the first available hydrogen, and the salt anion of which is capable of forming water-insoluble calcium salts, is additionally provided. According to the preferred embodiment, the weak acid has a pKₐ value from greater than 2.5 to 5 at 20° C., and more preferably the weak acid is selected from the group consisting of acetic acid, formic acid, propanoic acid, and mixtures thereof. Exemplary cations of said water-soluble salt are selected from the group consisting of potassium, sodium, lithium and mixtures thereof. In a more preferred embodiment, said cation is sodium or potassium. Exemplary anions of said water-soluble salt are selected from the group consisting of phosphate, dihydrogen phosphate, monohydrogen phosphate, oxalate, silicate, mixtures thereof and hydrates thereof. In a more preferred embodiment, said anion is selected from the group consisting of phosphate, dihydrogen phosphate, monohydrogen phosphate, mixtures thereof and hydrates thereof. In a most preferred embodiment, said anion is selected from the group consisting of dihydrogen phosphate, monohydrogen phosphate, mixtures thereof and hydrates thereof. Water-soluble salt addition may be performed dropwise or in one step. In the case of drop wise addition, this addition preferably takes place within a time period of 10 minutes. It is more preferred to add said salt in one step.

According to one embodiment of the present invention, the at least one H₃O⁺ ion donor is selected from the group consisting of hydrochloric acid, sulphuric acid, sulphurous acid, phosphoric acid, citric acid, oxalic acid, an acidic salt, acetic acid, formic acid, and mixtures thereof. Preferably the at least one H₃O⁺ ion donor is selected from the group consisting of hydrochloric acid, sulphuric acid, sulphurous acid, phosphoric acid, oxalic acid, H₂PO₄⁻, being at least partially neutralised by a corresponding cation such as Li⁺, Na⁺ or K⁺, HPO₄²⁻, being at least partially neutralised by a corresponding cation such as Li⁺, Na⁺, K⁺, Mg²⁺, or Ca²⁺ and mixtures thereof, more preferably the at least one acid is selected from the group consisting of hydrochloric acid, sulphuric acid, sulphurous acid, phosphoric acid, oxalic acid, or mixtures thereof, and most preferably, the at least one H₃O⁺ ion donor is phosphoric acid.

The one or more H₃O⁺ ion donor can be added to the suspension as a concentrated solution or a more diluted solution. Preferably, the molar ratio of the H₃O⁺ ion donor to the natural or precipitated calcium carbonate is from 0.01 to 4, more preferably from 0.02 to 2, even more preferably 0.05 to 1 and most preferably 0.1 to 0.58.

As an alternative, it is also possible to add the H₃O⁺ ion donor to the water before the natural or precipitated calcium carbonate is suspended.

In a next step, the natural or precipitated calcium carbonate is treated with carbon dioxide. If a strong acid such as sulphuric acid or hydrochloric acid is used for the H₃O⁺ ion donor treatment of the natural or precipitated calcium carbonate, the carbon dioxide is automatically formed. Alternatively or additionally, the carbon dioxide can be supplied from an external source.

H₃O⁺ ion donor treatment and treatment with carbon dioxide can be carried out simultaneously which is the case when a strong or medium-strong acid is used. It is also possible to carry out H₃O⁺ ion donor treatment first, e.g. with a medium strong acid having a pKₐ in the range of 0 to 2.5 at 20° C., wherein carbon dioxide is formed in situ, and thus, the carbon dioxide treatment will automatically be carried out simultaneously with the H₃O⁺ ion donor treatment, followed by the additional treatment with carbon dioxide supplied from an external source.

In a preferred embodiment, the H₃O⁺ ion donor treatment step and/or the carbon dioxide treatment step are repeated at least once, more preferably several times. According to one embodiment, the at least one H₃O⁺ ion donor is added over a time period of at least about 5 min, preferably at least about 10 min, typically from about 10 to about 20 min, more preferably about 30 min, even more preferably about 45 min, and sometimes about 1 h or more.

Subsequent to the H₃O⁺ ion donor treatment and carbon dioxide treatment, the pH of the aqueous suspension, measured at 20° C., naturally reaches a value of greater than 6.0, preferably greater than 6.5, more preferably greater than 7.0, even more preferably greater than 7.5, thereby preparing the surface-reacted natural or precipitated calcium carbonate as an aqueous suspension having a pH of greater than 6.0, preferably greater than 6.5, more preferably greater than 7.0, even more preferably greater than 7.5.

Further details about the preparation of the surface-reacted natural calcium carbonate are disclosed in WO 00/39222 A1, WO 2004/083316 A1, WO 2005/121257 A2, WO 2009/074492 A1, EP 2 264 108 A1, EP 2 264 109 A1 and US 2004/0020410 A1, the content of these references herewith being included in the present application.

Similarly, surface-reacted precipitated calcium carbonate is obtained. As can be taken in detail from WO 2009/074492 A1, surface-reacted precipitated calcium carbonate is obtained by contacting precipitated calcium carbonate with H₃O⁺ ions and with anions being solubilized in an aqueous medium and being capable of forming water-insoluble calcium salts, in an aqueous medium to form a slurry of surface-reacted precipitated calcium carbonate, wherein said surface-reacted precipitated calcium carbonate comprises an insoluble, at least partially crystalline calcium salt of said anion formed on the surface of at least part of the precipitated calcium carbonate.

Said solubilized calcium ions correspond to an excess of solubilized calcium ions relative to the solubilized calcium ions naturally generated on dissolution of precipitated calcium carbonate by H₃O⁺ ions, where said H₃O⁺ ions are provided solely in the form of a counterion to the anion, i.e. via the addition of the anion in the form of an acid or non-calcium acid salt, and in absence of any further calcium ion or calcium ion generating source.

Said excess solubilized calcium ions are preferably provided by the addition of a soluble neutral or acid calcium salt, or by the addition of an acid or a neutral or acid non-calcium salt which generates a soluble neutral or acid calcium salt in situ.

Said H₃O⁺ ions may be provided by the addition of an acid or an acid salt of said anion, or the addition of an acid or an acid salt which simultaneously serves to provide all or part of said excess solubilized calcium ions.

In a further preferred embodiment of the preparation of the surface-reacted natural or precipitated calcium carbonate, the natural or precipitated calcium carbonate is reacted with the one or more H₃O⁺ ion donors and/or the carbon dioxide in the presence of at least one compound selected from the group consisting of silicate, silica, aluminium hydroxide, earth alkali aluminate such as sodium or potassium aluminate, magnesium oxide, or mixtures thereof. Preferably, the at least one silicate is selected from an aluminium silicate, a calcium silicate, or an earth alkali metal silicate. These components can be added to an aqueous suspension comprising the natural or precipitated calcium carbonate before adding the one or more H₃O⁺ ion donors and/or carbon dioxide.

Alternatively, the silicate and/or silica and/or aluminium hydroxide and/or earth alkali aluminate and/or magnesium oxide component(s) can be added to the aqueous suspension of natural or precipitated calcium carbonate while the reaction of natural or precipitated calcium carbonate with the one or more H₃O⁺ ion donors and carbon dioxide has already started. Further details about the preparation of the surface-reacted natural or precipitated calcium carbonate in the presence of at least one silicate and/or silica and/or aluminium hydroxide and/or earth alkali aluminate component(s) are disclosed in WO 2004/083316 A1, the content of this reference herewith being included in the present application.

In order to obtain a solid surface-reacted calcium carbonate in the form of granules or a powder, the aqueous suspension comprising the surface-reacted calcium carbonate is dried. Suitable drying methods are known to the skilled person.

In case the surface-reacted calcium carbonate has been dried, the moisture content of the dried surface-reacted calcium carbonate can be between 0.01 and 8 wt.-%, based on the total weight of the dried surface-reacted calcium carbonate. According to one embodiment, the moisture content of the dried surface-reacted calcium carbonate is less than or equal to 6 wt.-%, based on the total weight of the dried surface-reacted calcium carbonate, preferably less than or equal to 4 wt.-%, and more preferably less than or equal to 3 wt.-%. According to another embodiment, the moisture content of the dried surface-reacted calcium carbonate is between 0.01 and 6 wt.-%, preferably between 0.02 and 4 wt.-%, and more preferably between 0.03 and 3 wt.-%, based on the total weight of the dried surface-reacted calcium carbonate.

The surface-reacted calcium carbonate may have different particle shapes, such as e.g. the shape of roses, golf balls and/or brains.

According to one embodiment of the present invention the filler is surface-reacted calcium carbonate and/or a mixture of surface-reacted calcium carbonate and precipitated hydromagnesite, and the natural ground calcium carbonate is selected from the group consisting of marble, chalk, limestone, and mixtures thereof, or the precipitated calcium carbonate is selected from the group consisting of precipitated calcium carbonates having an aragonitic, vateritic or calcitic crystal form, and mixtures thereof.

According to a further embodiment the filler is surface-reacted calcium carbonate and/or a mixture of surface-reacted calcium carbonate and precipitated hydromagnesite, and the at least one H₃O⁺ ion donor is selected from the group consisting of hydrochloric acid, sulphuric acid, sulphurous acid, phosphoric acid, citric acid, oxalic acid, an acidic salt, acetic acid, formic acid, and mixtures thereof, preferably the at least one H₃O⁺ ion donor is selected from the group consisting of hydrochloric acid, sulphuric acid, sulphurous acid, phosphoric acid, oxalic acid, H₂PO₄, being at least partially neutralised by a cation selected from Li⁺, Na⁺ and/or K⁺, HPO₄²⁻, being at least partially neutralised by a cation selected from Li⁺, Na′+K⁺, Mg²⁺, and/or Ca²⁺, and mixtures thereof, more preferably the at least one H₃O⁺ ion donor is selected from the group consisting of hydrochloric acid, sulphuric acid, sulphurous acid, phosphoric acid, oxalic acid, or mixtures thereof, and most preferably, the at least one H₃O⁺ ion donor is phosphoric acid.

According to one embodiment of the present invention, the surface-reacted calcium carbonate comprises an water-insoluble, at least partially crystalline calcium salt of an anion of the at least one acid, which is formed on the surface of the natural ground calcium carbonate or precipitated calcium carbonate. According to one embodiment, the water-insoluble, at least partially crystalline salt of an anion of the at least one acid covers the surface of the natural ground calcium carbonate or precipitated calcium carbonate at least partially, preferably completely. Depending on the employed at least one acid, the anion may be sulphate, sulphite, phosphate, citrate, oxalate, acetate, formiate and/or chloride.

The surface-reacted calcium carbonate may be surface-treated with at least one surface-treatment composition comprising at least one surface-treatment agent or may be a blend of surface-treated surface-reacted calcium carbonate and untreated surface-reacted calcium carbonate. The surface treatment may further improve the surface characteristics and especially may increase the hydrophobicity of the surface-reacted calcium carbonate, which may further improve the compatibility of the surface-reacted calcium carbonate with the crosslinkable polymer. Suitable surface-treatment agents are described further below.

According to one embodiment of the present invention, the surface-reacted calcium carbonate does not comprise a surface-treatment layer, i.e. an untreated surface-reacted calcium carbonate is employed in the inventive curable elastomer composition, the inventive cured elastomer product, the inventive article, the inventive method, or the inventive use, respectively.

### Precipitated Hydromagnesite

According to one embodiment of the present invention, the filler is precipitated hydromagnesite and/or a mixture of surface-reacted calcium carbonate as defined herein and precipitated hydromagnesite. According to another embodiment of the present invention, the filler is precipitated hydromagnesite. According to still another embodiment of the present invention, the filler is a mixture of surface-reacted calcium carbonate as defined herein and precipitated hydromagnesite.

Hydromagnesite or basic magnesium carbonate, which is the standard industrial name for hydromagnesite, is a naturally occurring mineral which is found in magnesium rich minerals such as serpentine and altered magnesium rich igneous rocks, but also as an alteration product of brucite in periclase marbles. Hydromagnesite is described as having the following formula Mg₅(CO₃)₄(OH)₂·4 H₂O.

It should be appreciated that hydromagnesite is a very specific mineral form of magnesium carbonate and occurs naturally as small needle-like crystals or crusts of acicular or bladed crystals. In addition thereto, it should be noted that hydromagnesite is a distinct and unique form of magnesium carbonate and is chemically, physically and structurally different from other forms of magnesium carbonate. Hydromagnesite can readily be distinguished from other magnesium carbonates by x-ray diffraction analysis, thermogravimetric analysis or elemental analysis. Unless specifically described as hydromagnesite, all other forms of magnesium carbonates (e.g. artinite (Mg₂(CO₃)(OH)₂·3 H₂O), dypingite (Mg₅(CO₃)₄(OH)₂·5 H₂O), giorgiosite (Mg₅(CO₃)₄(OH)₂·5 H₂O), pokrovskite (Mg₂(CO₃)(OH)₂·0.5 H₂O), magnesite (MgCO₃), barringtonite (MgCO₃·2 H₂O), lansfordite (MgCO₃·5 H₂O) and nesquehonite (MgCO₃·3 H₂O)) are not hydromagnesite within the meaning of the present invention and do not correspond chemically to the formula described above.

Besides the natural hydromagnesite, precipitated hydromagnesite (or synthetic magnesium carbonate) can be prepared. For instance, U.S. Pat. Nos. 1,361,324, 935,418, GB548197 and GB544907 generally describe the formation of aqueous solutions of magnesium bicarbonate (typically described as “Mg(HCO₃)₂”), which is then transformed by the action of a base, e.g., magnesium hydroxide, to form hydromagnesite. Other processes described in the art suggest to prepare compositions containing both, hydromagnesite and magnesium hydroxide, wherein magnesium hydroxide is mixed with water to form a suspension which is further contacted with carbon dioxide and an aqueous basic solution to form the corresponding mixture; cf. for example U.S. Pat. No. 5,979,461. WO2001054831 A1 relates to a process for preparing precipitated hydromagnesite in an aqueous environment.

The instant embodiment of the present invention relates to precipitated hydromagnesite. It is appreciated that the precipitated hydromagnesite can be one or a mixture of different types of precipitated hydromagnesite. In one embodiment of the present invention, the precipitated hydromagnesite comprises, preferably consists of, one type of precipitated hydromagnesite. Alternatively, the hydromagnesite comprises, preferably consists of, two or more types of precipitated hydromagnesites. For example, the precipitated hydromagnesite comprises, preferably consists of, two or three kinds of hydromagnesites. Preferably, the precipitated hydromagnesite comprises, more preferably consists of, one kind of precipitated hydromagnesite.

The precipitated hydromagnesite may be surface-treated with at least one surface-treatment composition comprising at least one surface-treatment agent or may be a blend of surface-treated precipitated hydromagnesite and non-surface treated precipitated hydromagnesite. The surface treatment may further improve the surface characteristics and especially may increase the hydrophobicity of the hydromagnesite, which may further improve the compatibility of the precipitated hydromagnesite with the crosslinkable polymer. Suitable surface-treatment agents are described further below.

According to one embodiment, the precipitated hydromagnesite is a surface-treated hydromagnesite or a mixture of precipitated hydromagnesite and surface-treated precipitated hydromagnesite.

### Surface Treatment of Filler

According to one embodiment the filler comprises at least one surface-treatment layer on at least a part of the surface of the filler. The at least one surface-treatment layer may be formed by contacting the filler with at least one surface-treatment composition in an amount from 0.07 to 9 mg/m² of the filler surface, preferably 0.1 to 8 mg/m², more preferably from 0.11 to 3 mg/m², wherein the surface-treatment composition comprises at least one surface-treatment agent.

A “surface-treatment agent” in the meaning of the present invention is any material, which is capable of reacting and/or forming an adduct with the surface of the filler material, thereby forming a surface-treatment layer on at least a part of the surface of the filler material. It should be understood that the present invention is not limited to any particular surface-treatment agents. The skilled person knows how to select suitable materials for use as surface-treatment agents. However, it is preferred that the surface-treatment agents are selected from unsaturated and/or saturated surface-treatment agents.

The term “at least one” surface-treatment agent in the meaning of the present invention means that the surface-treatment composition comprises, preferably consists of, one or more surface treatment agent(s).

In one embodiment of the present invention, the at least one surface-treatment composition comprises, preferably consists of, one surface treatment agent. Alternatively, the at least one surface-treatment composition comprises, preferably consists of, two or more surface treatment agents. For example, the at least one surface-treatment composition comprises, preferably consists of, two or three surface treatment agents.

Preferably, the at least one surface-treatment composition comprises, more preferably consists of, one surface treatment agent.

The surface treatment agent may be selected from the group consisting of mono- or di-substituted succinic anhydride containing compounds, mono- or di-substituted succinic acid containing compounds, mono- or di-substituted succinic acid salts containing compounds, saturated or unsaturated fatty acids, salts of saturated or unsaturated fatty acids, saturated or unsaturated esters of phosphoric acid, salts of saturated or unsaturated phosphoric acid esters; abietic acid, salts of abietic acid, polydialkylsiloxanes, trialkoxysilanes, and mixtures thereof and reaction products thereof.

The at least one surface-treatment agent may be an unsaturated surface-treatment agent, a saturated surface-treatment agent, or a mixture thereof.

Unsaturated surface-treatment agents may be selected from the group consisting of sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferred are completely neutralized surface treatment agents; and/or

a maleic anhydride grafted polybutadiene homopolymer or a maleic anhydride grafted polybutadiene-styrene copolymer and/or an acid and/or salt thereof, preferably a maleic anhydride grafted polybutadiene homopolymer having
i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of anhydride groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer, and/or an acid and/or salt thereof.

Saturated surface-treatment agents may be selected from the group consisting of

a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof,

a phosphoric acid ester blend of one or more phosphoric acid mono-ester and/or salts thereof and/or one or more phosphoric acid di-ester and/or salts thereof, and/or

at least one saturated aliphatic linear or branched carboxylic acid and/or salts thereof, preferably at least one aliphatic carboxylic acid having a total amount of carbon atoms from Ca to C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cm and/or a salt thereof and/or

at least one mono-substituted succinic anhydride consisting of succinic anhydride mono-substituted with a group selected from a linear, branched, aliphatic and cyclic group having a total amount of carbon atoms from at least C₂ to Cao in the substituent and/or salts thereof, and/or

at least one polydialkylsiloxane, preferably selected from the group consisting of polydimethylsiloxane, preferably dimethicone, polydiethylsiloxane, polymethylphenylsiloxane and mixtures thereof.

According to one embodiment of the present invention, the filler comprises at least one surface-treatment layer on at least a part of the surface of the filler,

wherein the at least one surface-treatment layer is formed by contacting the filler with at least one surface-treatment composition in an amount from 0.07 to 9 mg/m² of the filler surface, preferably 0.1 to 8 mg/m², more preferably from 0.11 to 3 mg/m², and

wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated and unsaturated fatty acids, salts of saturated and unsaturated fatty acids, saturated and unsaturated esters of phosphoric acid, salts of saturated and unsaturated phosphoric acid esters, abietic acid, salts of abietic acid, polydialkylsiloxanes, trialkoxysilanes, and mixtures thereof and reaction products thereof.

According to one embodiment the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferred are completely neutralized surface treatment agents; and/or
b) a maleic anhydride grafted polybutadiene homopolymer or a maleic anhydride grafted polybutadiene-styrene copolymer and/or an acid and/or salt thereof, preferably a maleic anhydride grafted polybutadiene homopolymer having
   i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
   ii) a number of anhydride groups per chain in the range from 2 to 12, preferably from 2 to 9, and more preferably from 2 to 6, and/or
   iii) an anhydride equivalent weight in the range from 400 to 2 200, preferably from 500 to 2 000, and more preferably from 550 to 1 800, and/or
   iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
   v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer,
   and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof, preferably at least one aliphatic carboxylic acid having a total amount of carbon atoms from Cato C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cm and/or a salt thereof and/or f) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or g) at least one polydialkylsiloxane, preferably selected from the group consisting of polydimethylsiloxane, preferably dimethicone, polydiethylsiloxane, polymethylphenylsiloxane and mixtures thereof, and/or
h) mixtures of the materials according to a) to g).

According to one embodiment of the present invention, the filler, preferably precipitated hydromagnesite, comprises at least one surface-treatment layer on at least a part of the surface of the filler, wherein the surface-treatment layer is formed by contacting the filler with at least one surface-treatment composition in an amount from 0.07 to 9 mg/m² of the filler surface, preferably 0.1 to 8 mg/m², more preferably from 0.11 to 3 mg/m², and wherein the at least one surface-treatment composition comprises at least one surface-treatment agent selected from the group consisting of mono- or di-substituted succinic anhydride containing compounds comprising unsaturated carbon moieties, mono- or di-substituted succinic acid containing compounds comprising unsaturated carbon moieties, mono- or di-substituted succinic acid salts containing compounds comprising unsaturated carbon moieties, unsaturated fatty acids, salts of unsaturated fatty acids, unsaturated esters of phosphoric acid, salts of unsaturated phosphoric acid esters, abietic acid, salts of abietic acid, polydialkylsiloxanes, trialkoxysilanes comprising unsaturated carbon moieties, and mixtures thereof and reaction products thereof, preferably the at least one surface-treatment agent is selected from the group consisting of a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferred are completely neutralized surface treatment agents; and/or
b) a maleic anhydride grafted polybutadiene homopolymer or a maleic anhydride grafted polybutadiene-styrene copolymer and/or acid and/or salt thereof, preferably a maleic anhydride grafted polybutadiene homopolymer having
i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of anhydride groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer, and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof.

The wording “comprising unsaturated carbon moieties” should be understood in that the respective compound comprises at least one unsaturated carbon moiety, such as a carbon-carbon double bond. For example, the respective compound may comprise one unsaturated carbon moiety. However, the respective compound may also comprise more than one unsaturated carbon moiety.

For the purposes of the present invention, an “unsaturated carbon moiety” refers to a double or triple bond, for example a carbon-carbon double bond, a carbon-carbon triple bond or a carbon-heteroatom multiple bond. Preferably, the unsaturated carbon moiety is a carbon-carbon double bond. It is appreciated that the unsaturated carbon moiety should be chemically crosslinkable, i.e., does not form part of an aromatic system.

In the following, the unsaturated and unsaturated surface-treatment agents will be described more in detail.

According to one embodiment, the unsaturated surface-treatment agent can be a mono- or di-substituted succinic anhydride containing compound comprising unsaturated carbon moieties, a mono- or di-substituted succinic acid containing compound comprising unsaturated carbon moieties, or a mono- or di-substituted succinic acid salt containing compound comprising unsaturated carbon moieties. Preferred are mono-substituted succinic anhydride containing compounds comprising unsaturated carbon moieties, mono-substituted succinic acid containing compounds comprising unsaturated carbon moieties, or mono-substituted succinic acid salt containing compounds comprising unsaturated carbon moieties.

The term “succinic anhydride containing compound” refers to a compound containing succinic anhydride. The term “succinic anhydride”, also called dihydro-2,5-furandione, succinic acid anhydride or succinyl oxide, has the molecular formula C₄H₄O₃ and is the acid anhydride of succinic acid.

The term “mono-substituted” succinic anhydride containing compound in the meaning of the present invention refers to a succinic anhydride wherein a hydrogen atom is substituted by another substituent.

The term “di-substituted” succinic anhydride containing compound in the meaning of the present invention refers to a succinic anhydride wherein two hydrogen atoms are substituted by another substituent.

The term “succinic acid containing compound” refers to a compound containing succinic acid. The term “succinic acid” has the molecular formula C₄H₆O₄.

The term “mono-substituted” succinic acid in the meaning of the present invention refers to a succinic acid wherein a hydrogen atom is substituted by another substituent.

The term “di-substituted” succinic acid containing compound in the meaning of the present invention refers to a succinic acid wherein two hydrogen atoms are substituted by another substituent.

The term “succinic acid salt containing compound” refers to a compound containing succinic acid, wherein the active acid groups are partially or completely neutralized. The term “partially neutralized” succinic acid salt containing compound refers to a degree of neutralization of the active acid groups in the range from 40 and 95 mole-%, preferably from 50 to 95 mole-%, more preferably from 60 to 95% and most preferably from 70 to 95%. The term “completely neutralized” succinic acid salt containing compound refers to a degree of neutralization of the active acid groups of >95 mole-%, preferably of >99 mole-%, more preferably of >99.8 mole-% and most preferably of 100 mole-%.

Preferably, the active acid groups are partially or completely neutralized.

The succinic acid salt containing compound is preferably a compound selected from the group consisting of sodium, potassium, calcium, magnesium, lithium, strontium, primary amine, secondary amine, tertiary amine and/or ammonium salts thereof, whereby the amine salts are linear or cyclic. It is appreciated that one or both acid groups can be in the salt form, preferably both acid groups are in the salt form.

The term “mono-substituted” succinic acid salt in the meaning of the present invention refers to a succinic acid salt wherein a hydrogen atom is substituted by another substituent.

The term “di-substituted” succinic acid containing compound in the meaning of the present invention refers to a succinic acid salt wherein two hydrogen atoms are substituted by another substituent.

Accordingly, the mono- or di-substituted succinic anhydride containing compounds comprising unsaturated carbon moieties, mono- or di-substituted succinic acid containing compounds comprising unsaturated carbon moieties or mono- or di-substituted succinic acid salts containing compounds comprising unsaturated carbon moieties comprise substituent(s) R¹ and/or R² comprising unsaturated carbon moieties. The unsaturated carbon moieties are located terminally and/or in a side chain of substituent(s) R¹ and/or R².

The substituent(s) R¹ and/or R² comprising a carbon-carbon double bond is/are preferably selected from an isobutylene, a polyisobutylene, a polybutadiene, an acryloyl, a methacryloyl group or mixtures thereof. For example, the surface-treatment agent may be a maleic anhydride grafted polybutadiene homopolymer or a maleic anhydride grafted polybutadiene-styrene copolymer, preferably a maleic anhydride grafted polybutadiene homopolymer and/or an acid and/or salt thereof.

The maleic anhydride grafted polybutadiene homopolymer preferably has i) a number average molecular weight Mₙ measured by gel permeation chromatography from 1 000 to 20 000 g/mol, preferably from 1 400 to 15 000 g/mol, and more preferably from 2 000 to 10 000 g/mol, measured according to EN ISO 16014-1:2019, and/or
ii) a number of anhydride groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer.

The term “maleic anhydride grafted” means that a succinic anhydride is obtained after reaction of substituent(s) R¹ and/or R² comprising a carbon-carbon double bond with the double bond of maleic anhydride. Thus, the terms “maleic anhydride grafted polybutadiene homopolymer” and “maleic anhydride grafted polybutadiene-styrene copolymer” refer to a polybutadiene homopolymer and a polybutadiene-styrene copolymer each bearing succinic anhydride moieties formed from the reaction of a carbon-carbon double bond with the double bond of maleic anhydride, respectively.

The term “anhydride equivalent weight” refers to the number average molecular weight Mₙ measured by gel permeation chromatography divided by the number of anhydride groups per chain. For example, the maleic anhydride grafted polybutadiene homopolymer may have a number average molecular weight Mₙ measured by gel permeation chromatography from 1 000 to 20 000 g/mol, preferably from 1 400 to 15 000 g/mol, more preferably from 2 000 to 10 000 g/mol, an acid number in the range from 20 to 200 meq KOH per g of maleic anhydride grafted polybutadiene homopolymer, preferably 30 to 150 meq KOH/g, measured according to ASTM D974-14, and a molar amount of 1,2-vinyl groups in the range from 10 to 60 mol-%, preferably 15 to 40 mol-%. In another embodiment, the maleic anhydride grafted polybutadiene homopolymer may have a number average molecular weight Mₙ measured by gel permeation chromatography from 2000 to 5000 g/mol, an acid number in the range from 30 to 100 meq KOH/g, measured according to ASTM D974-14, and a molar amount of 1,2-vinyl groups in the range from 15 to 40 mol-%.

In one embodiment of the present invention, the salt of the maleic anhydride grafted polybutadiene homopolymer or the maleic anhydride grafted polybutadiene-styrene copolymer may be selected from the group comprising sodium, potassium, calcium, magnesium, lithium, strontium, primary amine, secondary amine, tertiary amine and/or ammonium salts thereof, and preferably is selected from the group consisting of sodium, potassium, calcium and/or magnesium salts thereof.

In a preferred embodiment of the present invention, the surface-treatment agent is a salt of a maleic anhydride grafted polybutadiene homopolymer selected from the group consisting of sodium, potassium, calcium, magnesium, lithium, strontium, primary amine, secondary amine, tertiary amine and/or ammonium salts thereof, preferably selected from the group consisting of sodium, potassium, calcium and/or magnesium salts thereof. More preferably, the salt of the maleic anhydride grafted polybutadiene homopolymer has a number average molecular weight Mₙ measured by gel permeation chromatography from 1 000 to 20 000 g/mol, preferably from 1 400 to 15 000 g/mol, more preferably from 2 000 to 10 000 g/mol, an acid number in the range from 20 to 200 meq KOH per g of maleic anhydride grafted polybutadiene homopolymer, preferably 30 to 150 meq KOH/g, measured according to ASTM D974-14, and a molar amount of 1,2-vinyl groups in the range from 10 to 60 mol-%, preferably 15 to 40 mol-%.

The salt of the maleic anhydride grafted polybutadiene homopolymer or the maleic anhydride grafted polybutadiene-styrene copolymer may be obtained by partial or full neutralization from the corresponding anhydride, e.g., by treatment of the maleic anhydride grafted polybutadiene homopolymer or a maleic anhydride grafted polybutadiene-styrene copolymer and/or acid thereof with a base, preferably sodium hydroxide or an aqueous solution of sodium hydroxide.

Thus, it is to be understood that the acid or salt of the maleic anhydride grafted polybutadiene homopolymer is preferably derivable by hydrolysis from a succinic anhydride grafted polybutadiene homopolymer having
i) a number average molecular weight Mₙ measured by gel permeation chromatography from 1 000 to 20 000 g/mol, preferably from 1 400 to 15 000 g/mol, and more preferably from 2 000 to 10 000 g/mol, measured according to EN ISO 16014-1:2019, and/or
ii) a number of anhydride groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer.

The surface-treatment composition may comprise, preferably consist of a maleic anhydride grafted polybutadiene homopolymer or a maleic anhydride grafted polybutadiene-styrene copolymer and/or an acid and/or salt thereof, preferably a maleic anhydride grafted polybutadiene homopolymer and/or an acid and/or salt thereof. Thus, the surface-treatment layer of the filler may be formed by contacting the filler material with said surface-treatment composition in an amount from 0.07 to 9 mg/m² of the filler material surface, preferably 0.1 to 8 mg/m², more preferably 0.11 to 3 mg/m².

For example, the surface-treatment layer on at least a part of the surface of the filler material may be formed by contacting the filler material with the maleic anhydride grafted polybutadiene homopolymer, or the maleic anhydride grafted polybutadiene homopolymer and/or an acid and/or salt thereof having a number average molecular weight Mₙ measured by gel permeation chromatography from 1 000 to 20 000 g/mol, preferably from 1 400 to 15 000 g/mol, more preferably from 2 000 to 10 000 g/mol, an acid number in the range from 20 to 200 meq KOH per g of succinic anhydride grafted polybutadiene homopolymer, preferably 30 to 150 meq KOH/g, measured according to ASTM D974-14, and/or a molar amount of 1,2-vinyl groups in the range from 10 to 60 mol-%, preferably 15 to mol-%, in an amount from 0.07 to 9 mg/m² of the filler material surface, preferably 0.1 to 8 mg/m², more preferably 0.11 to 3 mg/m².

In another embodiment of the present invention, the mono-substituted succinic anhydride compound comprising unsaturated carbon moieties is at least one linear or branched alkenyl mono-substituted succinic anhydride compound comprising unsaturated carbon moieties. For example, the at least one alkenyl mono-substituted succinic anhydride is selected from the group comprising ethenylsuccinic anhydride, propenylsuccinic anhydride, butenylsuccinic anhydride, triisobutenyl succinic anhydride, pentenylsuccinic anhydride, hexenylsuccinic anhydride, heptenylsuccinic anhydride, octenylsuccinic anhydride, nonenylsuccinic anhydride, decenyl succinic anhydride, dodecenyl succinic anhydride, hexadecenyl succinic anhydride, octadecenyl succinic anhydride, and mixtures thereof.

Accordingly, it is appreciated that e.g. the term “hexadecenyl succinic anhydride” comprises linear and branched hexadecenyl succinic anhydride(s). One specific example of linear hexadecenyl succinic anhydride(s) is n-hexadecenyl succinic anhydride such as 14-hexadecenyl succinic anhydride, 13-hexadecenyl succinic anhydride, 12-hexadecenyl succinic anhydride, 11-hexadecenyl succinic anhydride, 10-hexadecenyl succinic anhydride, 9-hexadecenyl succinic anhydride, 8-hexadecenyl succinic anhydride, 7-hexadecenyl succinic anhydride, 6-hexadecenyl succinic anhydride, 5-hexadecenyl succinic anhydride, 4-hexadecenyl succinic anhydride, 3-hexadecenyl succinic anhydride and/or 2-hexadecenyl succinic anhydride. Specific examples of branched hexadecenyl succinic anhydride(s) are 14-methyl-9-pentadecenyl succinic anhydride, 14-methyl-2-pentadecenyl succinic anhydride, 1-hexyl-2-decenyl succinic anhydride and/or iso-hexadecenyl succinic anhydride.

Furthermore, it is appreciated that e.g. the term “octadecenyl succinic anhydride” comprises linear and branched octadecenyl succinic anhydride(s). One specific example of linear octadecenyl succinic anhydride(s) is n-octadecenyl succinic anhydride such as 16-octadecenyl succinic anhydride, 15-octadecenyl succinic anhydride, 14-octadecenyl succinic anhydride, 13-octadecenyl succinic anhydride, 12-octadecenyl succinic anhydride, 11-octadecenyl succinic anhydride, 10-octadecenyl succinic anhydride, 9-octadecenyl succinic anhydride, 8-octadecenyl succinic anhydride, 7-octadecenyl succinic anhydride, 6-octadecenyl succinic anhydride, 5-octadecenyl succinic anhydride, 4-octadecenyl succinic anhydride, 3-octadecenyl succinic anhydride and/or 2-octadecenyl succinic anhydride. Specific examples of branched octadecenyl succinic anhydride(s) are 16-methyl-9-heptadecenyl succinic anhydride, 16-methyl-7-heptadecenyl succinic anhydride, 1-octyl-2-decenyl succinic anhydride and/or iso-octadecenyl succinic anhydride.

In one embodiment of the present invention, the at least one alkenyl mono-substituted succinic anhydride is selected from the group comprising hexenylsuccinic anhydride, octenylsuccinic anhydride, hexadecenyl succinic anhydride, octadecenyl succinic anhydride, and mixtures thereof.

In one embodiment of the present invention, the mono-substituted succinic anhydride compound comprising unsaturated carbon moieties is one alkenyl mono-substituted succinic anhydride. For example, the one alkenyl mono-substituted succinic anhydride is hexenylsuccinic anhydride. Alternatively, the one alkenyl mono-substituted succinic anhydride is octenylsuccinic anhydride. Alternatively, the one alkenyl mono-substituted succinic anhydride is hexadecenyl succinic anhydride. For example, the one alkenyl mono-substituted succinic anhydride is linear hexadecenyl succinic anhydride such as n-hexadecenyl succinic anhydride or branched hexadecenyl succinic anhydride such as 1-hexyl-2-decenyl succinic anhydride. Alternatively, the one alkenyl mono-substituted succinic anhydride is octadecenyl succinic anhydride. For example, the one alkyl mono-substituted succinic anhydride is linear octadecenyl succinic anhydride such as n-octadecenyl succinic anhydride or branched octadecenyl succinic anhydride such iso-octadecenyl succinic anhydride, or 1-octyl-2-decenyl succinic anhydride.

In one embodiment of the present invention, the one alkenyl mono-substituted succinic anhydride is linear octadecenyl succinic anhydride such as n-octadecenyl succinic anhydride. In another embodiment of the present invention, the one alkenyl mono-substituted succinic anhydride is linear octenylsuccinic anhydride such as n-octenylsuccinic anhydride.

In one embodiment of the present invention, the mono-substituted succinic anhydride compound comprising unsaturated carbon moieties is a mixture of two or more kinds of alkenyl mono-substituted succinic anhydrides. For example, the mono-substituted succinic anhydride compound comprising unsaturated carbon moieties is a mixture of two or three kinds of alkenyl mono-substituted succinic anhydrides.

If the mono-substituted succinic anhydride compound comprising unsaturated carbon moieties is a mixture of two or more kinds of alkenyl mono-substituted succinic anhydrides, one alkenyl mono-substituted succinic anhydride is linear or branched octadecenyl succinic anhydride, while each further alkenyl mono-substituted succinic anhydride is selected from ethenylsuccinic anhydride, propenylsuccinic anhydride, butenylsuccinic anhydride, pentenylsuccinic anhydride, hexenylsuccinic anhydride, heptenylsuccinic anhydride, nonenylsuccinic anhydride, hexadecenyl succinic anhydride and mixtures thereof. For example, the mono-substituted succinic anhydride compound comprising unsaturated carbon moieties is a mixture of two or more kinds of alkenyl mono-substituted succinic anhydrides, wherein one alkenyl mono-substituted succinic anhydride is linear octadecenyl succinic anhydride and each further alkenyl mono-substituted succinic anhydride is selected from ethenylsuccinic anhydride, propenylsuccinic anhydride, butenylsuccinic anhydride, pentenylsuccinic anhydride, hexenylsuccinic anhydride, heptenylsuccinic anhydride, nonenylsuccinic anhydride, hexadecenyl succinic anhydride and mixtures thereof. Alternatively, the mono-substituted succinic anhydride compound comprising unsaturated carbon moieties is a mixture of two or more kinds of alkenyl mono-substituted succinic anhydrides, wherein one alkenyl mono-substituted succinic anhydride is branched octadecenyl succinic anhydride and each further alkenyl mono-substituted succinic anhydride is selected from ethenylsuccinic anhydride, propenylsuccinic anhydride, butenylsuccinic anhydride, pentenylsuccinic anhydride, hexenylsuccinic anhydride, heptenylsuccinic anhydride, nonenylsuccinic anhydride, hexadecenyl succinic anhydride and mixtures thereof.

For example, the mono-substituted succinic anhydride compound comprising unsaturated carbon moieties is a mixture of two or more kinds of alkenyl mono-substituted succinic anhydrides comprising one or more hexadecenyl succinic anhydride, like linear or branched hexadecenyl succinic anhydride(s), and one or more octadecenyl succinic anhydride, like linear or branched octadecenyl succinic anhydride(s).

In one embodiment of the present invention, the mono-substituted succinic anhydride compound comprising unsaturated carbon moieties is a mixture of two or more kinds of alkenyl mono-substituted succinic anhydrides comprising linear hexadecenyl succinic anhydride(s) and linear octadecenyl succinic anhydride(s). Alternatively, the mono-substituted succinic anhydride compound comprising unsaturated carbon moieties is a mixture of two or more kinds of alkenyl mono-substituted succinic anhydrides comprising branched hexadecenyl succinic anhydride(s) and branched octadecenyl succinic anhydride(s). For example, the one or more hexadecenyl succinic anhydride is linear hexadecenyl succinic anhydride like n-hexadecenyl succinic anhydride and/or branched hexadecenyl succinic anhydride like 1-hexyl-2-decenyl succinic anhydride. Additionally or alternatively, the one or more octadecenyl succinic anhydride is linear octadecenyl succinic anhydride like n-octadecenyl succinic anhydride and/or branched octadecenyl succinic anhydride like iso-octadecenyl succinic anhydride and/or 1-octyl-2-decenyl succinic anhydride.

If the mono-substituted succinic anhydride compound comprising unsaturated carbon moieties is a mixture of two or more kinds of alkenyl mono-substituted succinic anhydrides, it is appreciated that one alkenyl mono-substituted succinic anhydride is present in an amount of from 20 to 60 wt.-% and preferably of from 30 to 50 wt.-%, based on the total weight of the mono-substituted succinic anhydride provided.

For example, if the mono-substituted succinic anhydride compound comprising unsaturated carbon moieties is a mixture of two or more kinds of alkenyl mono-substituted succinic anhydrides comprising one or more hexadecenyl succinic anhydride(s), like linear or branched hexadecenyl succinic anhydride(s), and one or more octadecenyl succinic anhydride(s), like linear or branched hexadecenyl succinic anhydride(s), it is preferred that the one or more octadecenyl succinic anhydride(s) is present in an amount of from 20 to 60 wt.-% and preferably of from 30 to 50 wt.-%, based on the total weight of the mono-substituted succinic anhydride.

It is also appreciated that the mono-substituted succinic anhydride compound comprising unsaturated carbon moieties may be a mixture of alkyl mono-substituted succinic anhydrides and alkenyl mono-substituted succinic anhydrides.

In another embodiment, the surface-treatment agent may be a mono-substituted succinic acid compound comprising unsaturated carbon moieties or a mono-substituted succinic acid salt compound comprising unsaturated carbon moieties, wherein the mono-substituted succinic acid compound comprising unsaturated carbon moieties or the mono-substituted succinic acid salt compound comprising unsaturated carbon moieties is derived from the mono-substituted succinic anhydride compounds compound comprising unsaturated carbon moieties as described hereinabove.

In one embodiment, the surface-treatment agent is a maleinized polybutadiene having a Brookfield viscosity at 25° C. in the range from 1 000 to 300 000 mPa s, and/or an acid number in the range from 10 to 300 mg potassium hydroxide per g maleinized polybutadiene and/or an iodine number in the range from 100 to 1 000 g iodine per 100 g maleinized polybutadiene. For example, the surface treatment agent is a maleinized polybutadiene having a Brookfield viscosity at 25° C. in the range from 1 000 to 300 000 mPa s, or an acid number in the range from 10 to 300 mg potassium hydroxide per g maleinized polybutadiene or an iodine number in the range from 100 to 1 000 g iodine per 100 g maleinized polybutadiene. Alternatively, the surface treatment agent is a maleinized polybutadiene having a Brookfield viscosity at 25° C. in the range from 1 000 to 300 000 mPa s, and an acid number in the range from 10 to 300 mg potassium hydroxide per g maleinized polybutadiene and an iodine number in the range from 100 to 1 000 g iodine per 100 g maleinized polybutadiene.

The term “maleinized” means that the succinic anhydride is obtained after reaction of substituent(s) R¹ and/or R² comprising a crosslinkable double bond with the double bond of maleic anhydride.

Additionally or alternatively, the at least one surface treatment agent is selected from unsaturated fatty acids and/or salts of unsaturated fatty acids.

The term “unsaturated fatty acid” in the meaning of the present invention refers to straight chain or branched chain, unsaturated organic compounds composed of carbon and hydrogen. Said organic compound further contains a carboxyl group placed at the end of the carbon skeleton.

The unsaturated fatty acid is preferably selected from the group consisting of myristoleic acid, palmitoleic acid, sapienic acid, oleic acid, elaidic acid, vaccenic acid, linoleic acid, α-linolenic acid, eicosapentaenoic acid, docosahexaenoic acid and mixtures thereof. More preferably, the surface treatment agent being an unsaturated fatty acid is selected from the group consisting of myristoleic acid, palmitoleic acid, sapienic acid, oleic acid, elaidic acid, vaccenic acid, linoleic acid, α-linolenic acid and mixtures thereof. Most preferably, the surface treatment agent being an unsaturated fatty acid is oleic acid and/or linoleic acid, preferably oleic acid or linoleic acid, most preferably linoleic acid.

Additionally or alternatively, the surface treatment agent is a salt of an unsaturated fatty acid.

The term “salt of unsaturated fatty acid” refers to an unsaturated fatty acid, wherein the active acid group is partially or completely neutralized. The term “partially neutralized” unsaturated fatty acid refers to a degree of neutralization of the active acid groups in the range from 40 and 95 mole-% preferably from 50 to 95 mole-%, more preferably from 60 to 95 mole-% and most preferably from 70 to 95 mole-%. The term “completely neutralized” unsaturated fatty acid refers to a degree of neutralization of the active acid groups of >95 mole-%, preferably of >99 mole-%, more preferably of >99.8 mole-% and most preferably of 100 mole-%. Preferably, the active acid groups are partially or completely neutralized.

The salt of unsaturated fatty acid is preferably a compound selected from the group consisting of sodium, potassium, calcium, magnesium, lithium, strontium, primary amine, secondary amine, tertiary amine and/or ammonium salts thereof, whereby the amine salts are linear or cyclic. For example, the surface treatment agent is a salt of oleic acid and/or linoleic acid, preferably oleic acid or linoleic acid, most preferably linoleic acid.

Additionally or alternatively, the at least one surface treatment agent is an unsaturated ester of phosphoric acid and/or a salt of an unsaturated phosphoric acid ester.

Thus, the unsaturated ester of phosphoric acid may be a blend of one or more phosphoric acid mono-ester and one or more phosphoric acid di-ester and optionally one or more phosphoric acid tri-ester. In one embodiment, said blend further comprises phosphoric acid.

For example, the unsaturated ester of phosphoric acid is a blend of one or more phosphoric acid mono-ester and one or more phosphoric acid di-ester. Alternatively, the unsaturated ester of phosphoric acid is a blend of one or more phosphoric acid mono-ester and one or more phosphoric acid di-ester and phosphoric acid. Alternatively, the unsaturated ester of phosphoric acid is a blend of one or more phosphoric acid mono-ester and one or more phosphoric acid di-ester and one or more phosphoric acid tri-ester. Alternatively, the unsaturated ester of phosphoric acid is a blend of one or more phosphoric acid mono-ester and one or more phosphoric acid di-ester and one or more phosphoric acid tri-ester and phosphoric acid.

For example, said blend comprises phosphoric acid in an amount of ≤8 mol.-%, preferably of ≤6 mol.-%, and more preferably of ≤4 mol.-%, like from 0.1 to 4 mol.-%, based on the molar sum of the compounds in the blend.

The term “phosphoric acid mono-ester” in the meaning of the present invention refers to an o-phosphoric acid molecule mono-esterified with one alcohol molecule selected from unsaturated, branched or linear, aliphatic or aromatic alcohols having a total amount of carbon atoms from C₆ to C₃₀, preferably from C₈ to C22, more preferably from C8 to C20 and most preferably from C8 to C18 in the alcohol substituent.

The term “phosphoric acid di-ester” in the meaning of the present invention refers to an o-phosphoric acid molecule di-esterified with two alcohol molecules selected from the same or different, unsaturated, branched or linear, aliphatic or aromatic alcohols having a total amount of carbon atoms from C6 to C30, preferably from C8 to C22, more preferably from C8 to C20 and most preferably from C8 to C18 in the alcohol substituent.

The term “phosphoric acid tri-ester” in the meaning of the present invention refers to an o-phosphoric acid molecule tri-esterified with three alcohol molecules selected from the same or different, unsaturated, branched or linear, aliphatic or aromatic alcohols having a total amount of carbon atoms from C6 to C30, preferably from C8 to C22, more preferably from C8 to C20 and most preferably from C8 to C18 in the alcohol substituent.

Additionally or alternatively, the surface-treatment agent is a salt of an unsaturated phosphoric acid ester. In one embodiment, the salt of an unsaturated phosphoric acid ester may further comprise minor amounts of a salt of phosphoric acid.

The term “salt of unsaturated phosphoric acid ester” refers to an unsaturated phosphoric acid ester, wherein the active acid group(s) is/are partially or completely neutralized. The term “partially neutralized” unsaturated phosphoric acid esters refers to a degree of neutralization of the active acid group(s) in the range from 40 and 95 mole-%, preferably from 50 to 95 mole-%, more preferably from 60 to 95 mole-% and most preferably from 70 to 95 mole-%. The term “completely neutralized” unsaturated phosphoric acid esters refers to a degree of neutralization of the active acid group(s) of >95 mole-%, preferably of >99 mole-%, more preferably of >99.8 mole-% and most preferably of 100 mole-%. Preferably, the active acid group(s) is/are partially or completely neutralized.

The salt of unsaturated phosphoric acid ester is preferably a compound selected from the group consisting of sodium, potassium, calcium, magnesium, lithium, strontium, primary amine, secondary amine, tertiary amine and/or ammonium salts thereof, whereby the amine salts are linear or cyclic.

Additionally or alternatively, the at least one surface treatment agent is abietic acid (also named: abieta-7,13-dien-18-oic acid).

Additionally or alternatively, the surface treatment agent is a salt of abietic acid.

The term “salt of abietic acid” refers to abietic acid, wherein the active acid groups are partially or completely neutralized. The term “partially neutralized” abietic acid refers to a degree of neutralization of the active acid groups in the range from 40 and 95 mole-%, mol %, preferably from 50 to 95 mole-%, more preferably from 60 to 95 mole-% and most preferably from 70 to 95 mole-%. The term “completely neutralized” abietic acid refers to a degree of neutralization of the active acid groups of >95 mole-%, preferably of >99 mole-%, more preferably of >99.8 mole-% and most preferably of 100 mole-%. Preferably, the active acid groups are partially or completely neutralized, more preferably completely neutralized.

The salt of abietic acid is preferably a compound selected from the group consisting of sodium, potassium, calcium, magnesium, lithium, strontium, primary amine, secondary amine, tertiary amine and/or ammonium salts thereof, whereby the amine salts are linear or cyclic.

According to another embodiment of the present invention, the at least one surface-treatment agent is an unsaturated trialkoxysilane, which is represented by the formula R³—Si(OR⁴)₃. Therein, the substituent R³ represents any kind of unsaturated substituent, i.e., any branched, linear or cyclic alkene moiety having a total amount of carbon atoms from C2 to C30, such as a vinyl, allyl, propargyl, butenyl, crotyl, prenyl, pentenyl, hexenyl, cyclohexenyl or vinylphenyl moiety. OR⁴ is a hydrolyzable group, wherein substituent R⁴ represents any saturated or unsaturated, branched, linear, cyclic or aromatic moiety from having a total amount of carbon atoms from C1 to C30, such as a methyl, ethyl, propyl, allyl, butyl, butenyl, phenyl or benzyl group. According to a preferred embodiment, R⁴ is a linear alkyl group having a total amount of carbon atoms from C1 to C15, preferably from C1 to C8 and most preferably from C1 to C2. According to an exemplified embodiment of the present invention the hydrolysable alkoxy group is a methoxy or an ethoxy group. Thus, specific or preferred examples of trialkoxysilanes comprising unsaturated carbon moieties suitable for use in the present invention include vinyltrimethoxysilane, vinyltriethoxysilane, allyltrimethoxysilane or allyltriethoxysilane.

According to one embodiment of the present invention, the surface-treatment agent comprises a saturated surface-treatment agent, which is a phosphoric acid ester blend of one or more phosphoric acid mono-ester and/or salts thereof and/or one or more phosphoric acid di-ester and/or salts thereof.

In one embodiment of the present invention, the one or more phosphoric acid mono-ester consists of an o-phosphoric acid molecule esterified with one alcohol selected from saturated, branched or linear, aliphatic or aromatic alcohols having a total amount of carbon atoms from C6 to C30 in the alcohol substituent. For example, the one or more phosphoric acid mono-ester consists of an o-phosphoric acid molecule esterified with one alcohol selected from saturated, branched or linear, aliphatic or aromatic alcohols having a total amount of carbon atoms from C8 to C22, more preferably from C8 to C20 and most preferably from C8 to C18 in the alcohol substituent.

Alkyl esters of phosphoric acid are well known in the industry especially as surfactants, lubricants and antistatic agents (Die Tenside; Kosswig and Stache, Carl Hanser Verlag Munchen, 1993).

The synthesis of alkyl esters of phosphoric acid by different methods and the surface treatment of minerals with alkyl esters of phosphoric acid are well known by the skilled man, e.g. from Pesticide Formulations and Application Systems: 17th Volume; Collins H M, Hall F R, Hopkinson M, STP1268; Published: 1996, U.S. Pat. Nos. 3,897,519 A, 4,921,990 A, 4,350,645 A, 6,710,199 B2, 4,126,650 A, 5,554,781 A, EP 1092000 B1 and WO 2008/023076 A1.

In one embodiment of the present invention, the one or more phosphoric acid mono-ester consists of an o-phosphoric acid molecule esterified with one alcohol selected from saturated and linear or branched and aliphatic alcohols having a total amount of carbon atoms from C6 to C30 in the alcohol substituent. For example, the one or more phosphoric acid mono-ester consists of an o-phosphoric acid molecule esterified with one alcohol selected from saturated and linear or branched and aliphatic alcohols having a total amount of carbon atoms from C8 to C22, more preferably from C8 to C20 and most preferably from C8 to C18 in the alcohol substituent.

In one embodiment of the present invention, the one or more phosphoric acid mono-ester consists of an o-phosphoric acid molecule esterified with one alcohol selected from saturated and linear and aliphatic alcohols having a total amount of carbon atoms from C6 to C30, preferably from C8 to C22, more preferably from C8 to C20 and most preferably from C8 to C18 in the alcohol substituent. Alternatively, the one or more phosphoric acid mono-ester consists of an o-phosphoric acid molecule esterified with one alcohol selected from saturated and branched and aliphatic alcohols having a total amount of carbon atoms from C6 to C30, preferably from C8 to C22, more preferably from C8 to C20 and most preferably from C8 to C18 in the alcohol substituent.

In one embodiment of the present invention, the one or more phosphoric acid mono-ester is selected from the group comprising hexyl phosphoric acid mono-ester, heptyl phosphoric acid mono-ester, octyl phosphoric acid mono-ester, 2-ethylhexyl phosphoric acid mono-ester, nonyl phosphoric acid mono-ester, decyl phosphoric acid mono-ester, undecyl phosphoric acid mono-ester, dodecyl phosphoric acid mono-ester, tetradecyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof.

For example, the one or more phosphoric acid mono-ester is selected from the group comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof. In one embodiment of the present invention, the one or more phosphoric acid mono-ester is 2-octyl-1-dodecylphosphoric acid mono-ester.

It is appreciated that the expression “one or more” phosphoric acid di-ester means that one or more kinds of phosphoric acid di-ester may be present in the treatment layer of the surface-treated material product and/or the phosphoric acid ester blend.

Accordingly, it should be noted that the one or more phosphoric acid di-ester may be one kind of phosphoric acid di-ester. Alternatively, the one or more phosphoric acid di-ester may be a mixture of two or more kinds of phosphoric acid di-ester. For example, the one or more phosphoric acid di-ester may be a mixture of two or three kinds of phosphoric acid di-ester, like two kinds of phosphoric acid di-ester.

In one embodiment of the present invention, the one or more phosphoric acid di-ester consists of an o-phosphoric acid molecule esterified with two alcohols selected from saturated, branched or linear, aliphatic or aromatic alcohols having a total amount of carbon atoms from C6 to C30 in the alcohol substituent. For example, the one or more phosphoric acid di-ester consists of an o-phosphoric acid molecule esterified with two fatty alcohols selected from saturated, branched or linear, aliphatic or aromatic alcohols having a total amount of carbon atoms from C8 to C22, more preferably from C8 to C20 and most preferably from C8 to C18 in the alcohol substituent.

It is appreciated that the two alcohols used for esterifying the phosphoric acid may be independently selected from the same or different saturated, branched or linear, aliphatic or aromatic alcohols having a total amount of carbon atoms from C6 to C30 in the alcohol substituent. In other words, the one or more phosphoric acid di-ester may comprise two substituents being derived from the same alcohols or the phosphoric acid di-ester molecule may comprise two substituents being derived from different alcohols.

In one embodiment of the present invention, the one or more phosphoric acid di-ester consists of an o-phosphoric acid molecule esterified with two alcohols selected from the same or different, saturated and linear or branched and aliphatic alcohols having a total amount of carbon atoms from C6 to C30 in the alcohol substituent. For example, the one or more phosphoric acid di-ester consists of an o-phosphoric acid molecule esterified with two alcohols selected from the same or different, saturated and linear or branched and aliphatic alcohols having a total amount of carbon atoms from C8 to C22, more preferably from C8 to C20 and most preferably from C8 to C18 in the alcohol substituent.

In one embodiment of the present invention, the one or more phosphoric acid di-ester consists of an o-phosphoric acid molecule esterified with two alcohols selected from the same or different, saturated and linear and aliphatic alcohols having a total amount of carbon atoms from C6 to C30, preferably from C8 to C22, more preferably from C8 to C20 and most preferably from C8 to C18 in the alcohol substituent. Alternatively, the one or more phosphoric acid di-ester consists of an o-phosphoric acid molecule esterified with two alcohols selected from the same or different, saturated and branched and aliphatic alcohols having a total amount of carbon atoms from C6 to C30, preferably from C8 to C22, more preferably from C8 to C20 and most preferably from C8 to C18 in the alcohol substituent. In one embodiment of the present invention, the one or more phosphoric acid di-ester is selected from the group comprising hexyl phosphoric acid di-ester, heptyl phosphoric acid di-ester, octyl phosphoric acid di-ester, 2-ethylhexyl phosphoric acid di-ester, nonyl phosphoric acid di-ester, decyl phosphoric acid di-ester, undecyl phosphoric acid di-ester, dodecyl phosphoric acid di-ester, tetradecyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof.

For example, the one or more phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof. In one embodiment of the present invention, the one or more phosphoric acid di-ester is 2-octyl-1-dodecylphosphoric acid di-ester.

In one embodiment of the present invention, the one or more phosphoric acid mono-ester is selected from the group comprising 2-ethylhexyl phosphoric acid mono-ester, hexadecyl phosphoric acid mono-ester, heptylnonyl phosphoric acid mono-ester, octadecyl phosphoric acid mono-ester, 2-octyl-1-decylphosphoric acid mono-ester, 2-octyl-1-dodecylphosphoric acid mono-ester and mixtures thereof and the one or more phosphoric acid di-ester is selected from the group comprising 2-ethylhexyl phosphoric acid di-ester, hexadecyl phosphoric acid di-ester, heptylnonyl phosphoric acid di-ester, octadecyl phosphoric acid di-ester, 2-octyl-1-decylphosphoric acid di-ester, 2-octyl-1-dodecylphosphoric acid di-ester and mixtures thereof.

According to another embodiment of the present invention, the surface-treatment composition comprises a saturated surface-treatment agent, which is at least one saturated aliphatic linear or branched carboxylic acid and/or salts thereof preferably at least one aliphatic carboxylic acid having a total amount of carbon atoms from C4 to C24 and/or a salt thereof, more preferably at least one aliphatic carboxylic acid having a total amount of carbon atoms from C12 to C20 and/or a salt thereof, most preferably at least one aliphatic carboxylic acid having a total amount of carbon atoms from C16 to C18 and/or a salt thereof.

The aliphatic carboxylic acid in the meaning of the present invention may be selected from one or more linear chain, branched chain, saturated, and/or alicyclic carboxylic acids. Preferably, the aliphatic carboxylic acid is a monocarboxylic acid, i.e. the aliphatic carboxylic acid is characterized in that a single carboxyl group is present. Said carboxyl group is placed at the end of the carbon skeleton.

In one embodiment of the present invention, the aliphatic linear or branched carboxylic acid and/or salt thereof is selected from saturated unbranched carboxylic acids, preferably selected from the group of carboxylic acids consisting of pentanoic acid, hexanoic acid, heptanoic acid, octanoic acid, nonanoic acid, decanoic acid, undecanoic acid, lauric acid, tridecanoic acid, myristic acid, pentadecanoic acid, palmitic acid, heptadecanoic acid, stearic acid, nonadecanoic acid, arachidic acid, heneicosylic acid, behenic acid, tricosylic acid, lignoceric acid, their salts, their anhydrides and mixtures thereof.

In another embodiment of the present invention, the aliphatic linear or branched carboxylic acid and/or salt thereof is selected from the group consisting of octanoic acid, decanoic acid, lauric acid, myristic acid, palmitic acid, stearic acid, arachidic acid and mixtures thereof. Preferably, the aliphatic carboxylic acid is selected from the group consisting of myristic acid, palmitic acid, stearic acid, their salts, their anhydrides and mixtures thereof.

Preferably, the aliphatic carboxylic acid and/or a salt or anhydride thereof is stearic acid and/or a stearic acid salt or stearic anhydride.

According to another embodiment of the present invention, the surface-treatment composition comprises a saturated surface-treatment agent, which is at least one aliphatic aldehyde.

In this regard, the at least one aliphatic aldehyde represents a saturated surface treatment agent and may be selected from any linear, branched or alicyclic, substituted or non-substituted, saturated or aliphatic aldehyde. Said aldehyde is preferably chosen such that the number of carbon atoms is greater than or equal to 6 and more preferably greater than or equal to 8. Furthermore, said aldehyde has generally a number of carbon atoms that is lower or equal to 14, preferably lower or equal to 12 and more preferably lower or equal to 10. In one preferred embodiment, the number of carbon atoms of the aliphatic aldehyde is between 6 and 14, preferably between 6 and 12 and more preferably between 6 and 10. Suitable aldehydes suitable for use in the present invention are known to the skilled person, e.g., from WO 2011/147802 A1.

According to another embodiment of the present invention, the surface-treatment composition comprises a saturated surface-treatment agent, which is at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof.

Accordingly, it should be noted that the at least one mono-substituted succinic anhydride may be one kind of mono-substituted succinic anhydride. Alternatively, the at least one mono-substituted succinic anhydride may be a mixture of two or more kinds of mono-substituted succinic anhydride. For example, the at least one mono-substituted succinic anhydride may be a mixture of two or three kinds of mono-substituted succinic anhydride, like two kinds of mono-substituted succinic anhydride.

In one embodiment of the present invention, the at least one mono-substituted succinic anhydride is one kind of mono-substituted succinic anhydride.

It is appreciated that the at least one mono-substituted succinic anhydride represents a surface treatment agent and consists of succinic anhydride mono-substituted with a group selected from any linear, branched, aliphatic, and cyclic group having a total amount of carbon atoms from C2 to C30 in the substituent.

In one embodiment of the present invention, the at least one mono-substituted succinic anhydride consists of succinic anhydride mono-substituted with a group selected from a linear, branched, aliphatic, and cyclic group having a total amount of carbon atoms from C3 to C20 in the substituent. For example, the at least one mono-substituted succinic anhydride consists of succinic anhydride mono-substituted with a group selected from a linear, branched, aliphatic, and cyclic group having a total amount of carbon atoms from C4 to C18 in the substituent.

In one embodiment of the present invention, the at least one mono-substituted succinic anhydride consists of succinic anhydride mono-substituted with one group being a linear and aliphatic group having a total amount of carbon atoms from C2 to C30, preferably from C3 to C20 and most preferably from C4 to C18 in the substituent. Additionally or alternatively, the at least one mono-substituted succinic anhydride consists of succinic anhydride mono-substituted with one group being a branched and aliphatic group having a total amount of carbon atoms from C2 to C30, preferably from C3 to C20 and most preferably from C4 to C18 in the substituent.

Thus, it is preferred that the at least one mono-substituted succinic anhydride consists of succinic anhydride mono-substituted with one group being a linear or branched, alkyl group having a total amount of carbon atoms from C2 to C30, preferably from C3 to C20 and most preferably from C4 to C18 in the substituent.

For example, the at least one mono-substituted succinic anhydride consists of succinic anhydride mono-substituted with one group being a linear alkyl group having a total amount of carbon atoms from C2 to C30, preferably from C3 to C20 and most preferably from C4 to C18 in the substituent. Additionally or alternatively, the at least one mono-substituted succinic anhydride consists of succinic anhydride mono-substituted with one group being a branched alkyl group having a total amount of carbon atoms from C2 to C30, preferably from C3 to C20 and most preferably from C4 to C18 in the substituent.

In one embodiment of the present invention, the at least one mono-substituted succinic anhydride is at least one linear or branched alkyl mono-substituted succinic anhydride. For example, the at least one alkyl mono-substituted succinic anhydride is selected from the group comprising ethylsuccinic anhydride, propylsuccinic anhydride, butylsuccinic anhydride, triisobutyl succinic anhydride, pentylsuccinic anhydride, hexylsuccinic anhydride, heptylsuccinic anhydride, octylsuccinic anhydride, nonylsuccinic anhydride, decyl succinic anhydride, dodecyl succinic anhydride, hexadecanyl succinic anhydride, octadecanyl succinic anhydride, and mixtures thereof.

Accordingly, it is appreciated that, e.g., the term “butylsuccinic anhydride” comprises linear and branched butylsuccinic anhydride(s). One specific example of linear butylsuccinic anhydride(s) is n-butylsuccinic anhydride. Specific examples of branched butylsuccinic anhydride(s) are iso-butylsuccinic anhydride, sec-butylsuccinic anhydride and/or tert-butylsuccinic anhydride.

Furthermore, it is appreciated that, e.g., the term “hexadecanyl succinic anhydride” comprises linear and branched hexadecanyl succinic anhydride(s). One specific example of linear hexadecanyl succinic anhydride(s) is n-hexadecanyl succinic anhydride. Specific examples of branched hexadecanyl succinic anhydride(s) are 14-methylpentadecanyl succinic anhydride, 13-methylpentadecanyl succinic anhydride, 12-methylpentadecanyl succinic anhydride, 11-methylpentadecanyl succinic anhydride, 10-methylpentadecanyl succinic anhydride, 9-methylpentadecanyl succinic anhydride, 8-methylpentadecanyl succinic anhydride, 7-methylpentadecanyl succinic anhydride, 6-methylpentadecanyl succinic anhydride, 5-methylpentadecanyl succinic anhydride, 4-methylpentadecanyl succinic anhydride, 3-methylpentadecanyl succinic anhydride, 2-methylpentadecanyl succinic anhydride, 1-methylpentadecanyl succinic anhydride, 13-ethylbutadecanyl succinic anhydride, 12-ethylbutadecanyl succinic anhydride, 11-ethylbutadecanyl succinic anhydride, 10-ethylbutadecanyl succinic anhydride, 9-ethylbutadecanyl succinic anhydride, 8-ethylbutadecanyl succinic anhydride, 7-ethylbutadecanyl succinic anhydride, 6-ethylbutadecanyl succinic anhydride, 5-ethylbutadecanyl succinic anhydride, 4-ethylbutadecanyl succinic anhydride, 3-ethylbutadecanyl succinic anhydride, 2-ethylbutadecanyl succinic anhydride, 1-ethylbutadecanyl succinic anhydride, 2-butyldodecanyl succinic anhydride, 1-hexyldecanyl succinic anhydride, 1-hexyl-2-decanyl succinic anhydride, 2-hexyldecanyl succinic anhydride, 6,12-dimethylbutadecanyl succinic anhydride, 2,2-diethyldodecanyl succinic anhydride, 4,8,12-trimethyltridecanyl succinic anhydride, 2,2,4,6,8-pentamethylundecanyl succinic anhydride, 2-ethyl-4-methyl-2-(2-methylpentyl)-heptyl succinic anhydride and/or 2-ethyl-4,6-dimethyl-2-propylnonyl succinic anhydride.

Furthermore, it is appreciated that e.g. the term “octadecanyl succinic anhydride” comprises linear and branched octadecanyl succinic anhydride(s). One specific example of linear octadecanyl succinic anhydride(s) is n-octadecanyl succinic anhydride. Specific examples of branched hexadecanyl succinic anhydride(s) are 16-methylheptadecanyl succinic anhydride, 15-methylheptadecanyl succinic anhydride, 14-methylheptadecanyl succinic anhydride, 13-methylheptadecanyl succinic anhydride, 12-methylheptadecanyl succinic anhydride, 11-methylheptadecanyl succinic anhydride, 10-methylheptadecanyl succinic anhydride, 9-methylheptadecanyl succinic anhydride, 8-methylheptadecanyl succinic anhydride, 7-methylheptadecanyl succinic anhydride, 6-methylheptadecanyl succinic anhydride, 5-methylheptadecanyl succinic anhydride, 4-methylheptadecanyl succinic anhydride, 3-methylheptadecanyl succinic anhydride, 2-methylheptadecanyl succinic anhydride, 1-methylheptadecanyl succinic anhydride, 14-ethylhexadecanyl succinic anhydride, 13-ethylhexadecanyl succinic anhydride, 12-ethylhexadecanyl succinic anhydride, 11-ethylhexadecanyl succinic anhydride, 10-ethylhexadecanyl succinic anhydride, 9-ethylhexadecanyl succinic anhydride, 8-ethylhexadecanyl succinic anhydride, 7-ethylhexadecanyl succinic anhydride, 6-ethylhexadecanyl succinic anhydride, 5-ethylhexadecanyl succinic anhydride, 4-ethylhexadecanyl succinic anhydride, 3-ethylhexadecanyl succinic anhydride, 2-ethylhexadecanyl succinic anhydride, 1-ethylhexadecanyl succinic anhydride, 2-hexyldodecanyl succinic anhydride, 2-heptylundecanyl succinic anhydride, iso-octadecanyl succinic anhydride and/or 1-octyl-2-decanyl succinic anhydride.

In one embodiment of the present invention, the at least one alkyl mono-substituted succinic anhydride is selected from the group comprising butylsuccinic anhydride, hexylsuccinic anhydride, heptylsuccinic anhydride, octylsuccinic anhydride, hexadecanyl succinic anhydride, octadecanyl succinic anhydride, and mixtures thereof.

In one embodiment of the present invention, the at least one mono-substituted succinic anhydride is one kind of alkyl mono-substituted succinic anhydride. For example, the one alkyl mono-substituted succinic anhydride is butylsuccinic anhydride. Alternatively, the one alkyl mono-substituted succinic anhydride is hexylsuccinic anhydride. Alternatively, the one alkyl mono-substituted succinic anhydride is heptylsuccinic anhydride or octylsuccinic anhydride. Alternatively, the one alkyl mono-substituted succinic anhydride is hexadecanyl succinic anhydride. For example, the one alkyl mono-substituted succinic anhydride is linear hexadecanyl succinic anhydride such as n-hexadecanyl succinic anhydride or branched hexadecanyl succinic anhydride such as 1-hexyl-2-decanyl succinic anhydride. Alternatively, the one alkyl mono-substituted succinic anhydride is octadecanyl succinic anhydride. For example, the one alkyl mono-substituted succinic anhydride is linear octadecanyl succinic anhydride such as n-octadecanyl succinic anhydride or branched octadecanyl succinic anhydride such as iso-octadecanyl succinic anhydride or 1-octyl-2-decanyl succinic anhydride.

In one embodiment of the present invention, the one alkyl mono-substituted succinic anhydride is butylsuccinic anhydride such as n-butylsuccinic anhydride.

In one embodiment of the present invention, the at least one mono-substituted succinic anhydride is a mixture of two or more kinds of alkyl mono-substituted succinic anhydrides. For example, the at least one mono-substituted succinic anhydride is a mixture of two or three kinds of alkyl mono-substituted succinic anhydrides.

According to another embodiment of the present invention, the surface-treatment composition comprises a saturated surface-treatment agent, which is at least one polydialkylsiloxane.

Preferred polydialkylsiloxanes are described e.g. in US 2004/0097616 A1. Most preferred are polydialkylsiloxanes selected from the group consisting of polydimethylsiloxane, preferably dimethicone, polydiethylsiloxane and polymethylphenylsiloxane and/or mixtures thereof.

For example, the at least one polydialkylsiloxane is preferably a polydimethylsiloxane (PDMS).

According to yet another embodiment of the present invention, the surface-treatment composition comprises a saturated surface-treatment agent, which is at least one trialkoxysilane. A trialkyoxysilane is represented by the formula R⁵—Si(OR⁴)₃. Therein, the substituent R⁵ represents any kind of saturated substituent, i.e., any branched, linear or cyclic alkane moiety having a total amount of carbon atoms from C1 to C30, such as a methyl, ethyl, propyl, allyl, butyl, butenyl, phenyl or benzyl group moiety, which optionally comprises a further substituent. The further substituent may be selected from the group consisting of a hydroxyl group, an alkoxy group, an acyloxy group, an acryloxy group, a methacryloxy group, an ethacryloxy group, a carboxyl group, an epoxy group, an anhydride group, an ester group, an aldehyde group, an amino group, an ureido group, an azide group, a halogen group, a phosphonate group, a phosphine group, a sulfur-containing group, an isocyanate group or masked isocyanate group, a phenyl group, a benzyl group, and a benzoyl group, and preferably is selected from the group consisting of an amino group and a sulfur-containing group.

OR⁴ is a hydrolyzable group, wherein substituent R⁴ represents any saturated or unsaturated, branched, linear, cyclic or aromatic moiety from having a total amount of carbon atoms from C1 to C30, such as a methyl, ethyl, propyl, allyl, butyl, butenyl, phenyl or benzyl group. According to a preferred embodiment, R⁴ is a linear alkyl group having a total amount of carbon atoms from C1 to C15, preferably from C1 to C8 and most preferably from C1 to C2. According to an exemplified embodiment of the present invention the hydrolysable alkoxy group is a methoxy or an ethoxy group. Thus, specific or preferred examples of the trialkoxysilane include methyltriethoxysilane, methyltrimethoxysilane, octyltrimethoxysilane, octyltriethoxysilane, dodecyltriethoxysilane, dodecyltrimethoxysilane, n-octadecyltriethoxysilane, n-octadecyltrimethoxysilane, phenyltriethoxysilane, phenyltrimethoxysilane, benzyltriethoxysilane, benzyltrimethoxysilane, aminoethyltriethoxysilane, aminomethyltriethoxysilane, aminopropyltriethoxysilane, aminopropyltrimethoxysilane, N-(aminoethyl)aminopropyltriethoxysilane, N-(aminoethyl)aminopropyltrimethoxysilane.

Preferably, the trialkoxysilane is a sulfur-containing trialkoxysilane, i.e., the substituent R⁵ comprises at least one sulfur-containing functional group, such as a sulphonate group, a sulphide group, disulphide group, tetrasulphide group or a thiol group. Thus, specific and preferred examples include vinyltrimethoxysilane, vinyltriethoxysilane, mercaptopropyltrimethoxysilane (MPTS), mercaptopropyltriethoxysilane, bis(triethoxysilylpropyl) disulfide (TESPD), bis(triethoxysilylpropyl) tetrasulfide (TESPT), bis(trithoxysilylpropyl) disulfide, bis(trithoxysilylpropyl) tetrasulfide and mixtures thereof. It is to be understood that a sulfur-containing trialkoxysilane can participate in a crosslinking reaction, i.e., can be crosslinked with the elastomer of the elastomer composition.

In another preferred embodiment, the trialkoxysilane is an amino-containing trialkoxysilane, i.e., the substituent R⁵ comprises at least one primary, secondary or tertiary amino group, preferably at least one primary amino group —NH₂. More preferably, the trialkoxysilane is selected from the group consisting of 3-aminopropyltrimethoxysilane (APTMS), 3-aminopropyltriethoxysilane, N-(aminoethyl)aminopropyltriethoxysilane, N-(aminoethyl)aminopropyltrimethoxysilane, and mixtures thereof, and most preferably is is selected from the group consisting of 3-aminopropyltrimethoxysilane, 3-aminopropyltriethoxysilane, and mixtures thereof.

According to one embodiment the filler is surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source, and the surface-reacted calcium carbonate comprises at least one surface-treatment layer on at least a part of the surface of the surface-reacted calcium carbonate,

wherein the surface-treatment layer is formed by contacting the surface-reacted calcium carbonate with at least one surface-treatment composition in an amount from 0.07 to 9 mg/m² of the filler surface, preferably 0.1 to 8 mg/m², more preferably from 0.11 to 3 mg/m², and

wherein the at least one surface-treatment composition comprises at least one surface-treatment agent selected from any one of the afore-mentioned surface-treatment agents, preferably the surface-treatment agent is selected from the group consisting of a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof.

According to another embodiment the filler is precipitated hydromagnesite and the precipitated hydromagnesite comprises at least one surface-treatment layer on at least a part of the surface of the precipitated hydromagnesite,

wherein the surface-treatment layer is formed by contacting the precipitated hydromagnesite with at least one surface-treatment composition in an amount from 0.07 to 9 mg/m² of the filler surface, preferably 0.1 to 8 mg/m², more preferably from 0.11 to 3 mg/m², and

wherein the at least one surface-treatment composition comprises at least one surface-treatment agent selected from any one of the afore-mentioned surface-treatment agents.

### Formation of the Treatment Layer

It is appreciated that the surface-treatment layer on at least a part of the filler is formed by contacting the filler material with the surface-treatment agent as described hereinabove. The filler is contacted with the surface-treatment composition in an amount from 0.07 to 9 mg/m² of the filler material surface, preferably 0.1 to 8 mg/m², more preferably 0.11 to 3 mg/m². That is, a chemical reaction may take place between the filler and the surface treatment agent. In other words, the surface-treatment layer may comprise the surface treatment agent and/or salty reaction products thereof.

The term “salty reaction products” of the surface-treatment agent refers to products obtained by contacting the filler with the surface-treatment composition comprising the surface-treatment agent. Said reaction products are formed between at least a part of the applied surface-treatment agent and reactive molecules located at the surface of the filler.

For example, if the surface-treatment layer is formed by contacting the filler with the mono- or di-substituted succinic anhydride containing compounds comprising unsaturated carbon moieties, the surface-treatment layer may further comprise a salt formed from the reaction of the mono- or di-substituted succinic anhydride containing compounds comprising unsaturated carbon moieties with the filler material. Likewise, if the surface-treatment layer is formed by contacting the filler with stearic acid, the surface-treatment layer may further comprise a salt formed from the reaction of stearic acid with the filler. Analogous reactions may take place when using alternative surface treatment agents according to the present invention.

According to one embodiment the salty reaction product(s) of the mono- or di-substituted succinic anhydride containing compounds comprising unsaturated carbon moieties are one or more calcium and/or magnesium salts thereof.

According to one embodiment the salty reaction product(s) of the mono- or di-substituted succinic anhydride containing compounds comprising unsaturated carbon moieties formed on at least a part of the surface of the filler material are one or more calcium salts and/or one or more magnesium salts thereof.

According to one embodiment the molar ratio of the mono- or di-substituted succinic anhydride containing compounds comprising unsaturated carbon moieties to the salty reaction product(s) thereof is from 99.9:0.1 to 0.1:99.9, preferably from 70:30 to 90:10.

According to one embodiment of the present invention, the filler comprises, and preferably consists of, a filler and a treatment layer comprising at least one surface-treatment agent as described hereinabove. The treatment layer is formed on at least a part of the surface, preferably on the whole surface, of said filler material.

Methods for preparing the surface-treated surface-reacted calcium carbonate are known in the art. For example, surface-treated surface-reacted calcium carbonate treated with at least one phosphoric acid ester blend and suitable compounds for coating are described in EP 2 770 017 A1. Methods for preparing the surface-treated surface-reacted calcium carbonate treated with at least one mono-substituted succinic anhydride consisting of succinic anhydride mono-substituted with a group selected from a linear, branched, aliphatic and cyclic group having a total amount of carbon atoms from at least C2 to C30 in the substituent and suitable compounds for coating are described e.g. in WO 2016/023937 A1.

According to a further aspect of the present invention, a process for the surface treatment of precipitated hydromagnesite is provided, the process comprising the steps of:
I) providing precipitated hydromagnesite;
II) providing at least one surface-treatment composition in an amount ranging from 0.07 to 9 mg/m² of the precipitated hydromagnesite surface, preferably 0.1 to 8 mg/m², more preferably from 0.11 to 3 mg/m²,
   wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated and unsaturated fatty acids, salts of saturated and unsaturated fatty acids, saturated and unsaturated esters of phosphoric acid, salts of saturated and unsaturated phosphoric acid esters, abietic acid, salts of abietic acid, trialkoxysilanes, and mixtures thereof and reaction products thereof, and
III) contacting the precipitated hydromagnesite and the at least one surface-treatment composition in one or more steps at a temperature in the range from 20 to 180° C.

According to a preferred embodiment, step c) is carried out at a temperature from 60 to 150° C. or at a temperature from 20 to 120° C.

The precipitated hydromagnesite may be provided in dry form or in form of an aqueous suspension.

According to one embodiment in step I) the precipitated hydromagnesite is provided in dry form, and step III) is carried out at a temperature of at least 10° C. above the melting point of the at least one surface-treatment composition, preferably at a temperature from 60 to 150° C.

According to another embodiment in step I) the precipitated hydromagnesite is provided in form of an aqueous suspension having a solids content in the range from 5 to 80 wt.-%, based on the total weight of the aqueous suspension, step III) is carried out by adding the at least one surface-treatment composition to the aqueous suspension and mixing the aqueous suspension at a temperature in the range from 20 to 120° C., and IV) drying the aqueous suspension during or after step III) at a temperature in the range from 40 to 160° C. at ambient or reduced pressure until the moisture content of the obtained surface-treated precipitate hydromagnesite is in the range from 0.001 to 20 wt.-%, based on the total weight of the surface-treated precipitated hydromagnesite.

The skilled person will appreciate that the process of the present invention may comprise additional steps. For example, the process may comprises the step of filtering the obtained aqueous suspension before step IV), or adding a pH-control additive before, during or after step III).

According to one embodiment, a process for the surface treatment of precipitated hydromagnesite comprises the following steps:
A) providing an aqueous suspension of precipitated hydromagnesite having solids content in the range from 5 to 80 wt.-%, based on the total weight of the aqueous suspension;
B) adding at least one surface-treatment composition to the aqueous suspension obtained in step A) in an amount ranging from 0.07 to 9 mg/m² of the precipitated hydromagnesite surface, preferably 0.1 to 8 mg/m², more preferably from 0.11 to 3 mg/m²,
wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated and unsaturated fatty acids, salts of saturated and unsaturated fatty acids, saturated and unsaturated esters of phosphoric acid, salts of saturated and unsaturated phosphoric acid esters, abietic acid, salts of abietic acid, trialkoxysilanes, and mixtures thereof and reaction products thereof,
C) mixing the aqueous suspension obtained in step B) at a temperature in the range from to 120° C., and
D) drying the aqueous suspension during or after step C) at a temperature in the range from 20 to 120° C. at ambient or reduced pressure until the moisture content of the obtained surface-treated precipitate hydromagnesite is in the range from 0.001 to 20 wt.-%, based on the total weight of the surface-treated precipitated hydromagnesite.

In case the precipitated hydromagnesite is provided in form of an aqueous suspension, the pH-value of the aqueous suspension of step I) or A) may be adjusted to a range from 7.5 to 12. Additionally or alternatively, at least one base may be added to the aqueous suspension to readjust the pH-value to the range from 7.5 to 12 during or after step III) or C). Additionally or alternatively, the surface-treated precipitated hydromagnesite of step III) or C) or IV) or D) is deagglomerated after or during step IV) or D).

If the at least one surface-treatment layer is formed by contacting the precipitated hydromagnesite with at least one surface-treatment composition comprising two or more surface-treatment agents, it is to be understood that the two or more surface-treatment agents may be provided as a mixture prior to contacting the precipitated hydromagnesite with the surface-treatment composition. Alternatively, the precipitated hydromagnesite may be contacted with a first surface-treatment composition comprising the first surface-treatment agent, and a second surface-treatment composition comprising the second surface-treatment agent is added subsequently, that is, the surface-treatment is formed upon contacting the mixture of the precipitated hydromagnesite and the first surface-treatment composition with the second surface-treatment composition. In case the precipitated hydromagnesite is provided in dry form, it is to be understood that step III) is carried out at a temperature of at least 10° C. above the highest melting point of the two or more surface treatment agents.

According to one embodiment, the surface-treated precipitated hydromagnesite comprises two or more surface-treatment layers on at least a part of the surface of the precipitated hydromagnesite. The two or more surface-treatment layers may be formed by contacting in process step III) or C) the precipitated hydromagnesite and two or more surface-treatment compositions in two or more steps, optionally with drying steps in between. According to one embodiment of the present invention a first surface-treatment composition and a second surface-treatment composition are provided in step II), and in step III) the precipitated hydromagnesite is first contacted with the first surface-treatment composition, and subsequently with the second surface-treatment composition, wherein the preferably the first surface-treatment composition and the second surface-treatment composition comprises at least one surface-treatment agent independently from each other selected from the group consisting of mono- or di-substituted succinic anhydride containing compounds, mono- or di-substituted succinic acid containing compounds, mono- or di-substituted succinic acid salts containing compounds, saturated and unsaturated fatty acids, salts of saturated and unsaturated fatty acids, saturated and unsaturated esters of phosphoric acid, salts of saturated and unsaturated phosphoric acid esters, abietic acid, salts of abietic acid, trialkoxysilanes, and mixtures thereof and reaction products thereof.

According to a preferred embodiment, one of the first or second surface-treatment composition comprises at least one unsaturated surface-treatment agent and the other one comprises at least one saturated surface-treatment agent, wherein the at least one unsaturated surface-treatment agent is selected from the group consisting of sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferred are completely neutralized surface treatment agents; and/or

a maleic anhydride grafted polybutadiene homopolymer or a maleic anhydride grafted polybutadiene-styrene copolymer and/or acid and/or salt thereof, preferably a maleic anhydride grafted polybutadiene homopolymer having
i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
ii) a number of anhydride groups per chain in the range from 2 to 12, preferably from 2 to 9, and more preferably from 2 to 6, and/or
iii) an anhydride equivalent weight in the range from 400 to 2 200, preferably from 500 to 2 000, and more preferably from 550 to 1 800, and/or
iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer, and/or an acid and/or salt thereof, and/or

a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof, and

the at least one saturated surface-treatment agent is selected from the group consisting of

a phosphoric acid ester blend of one or more phosphoric acid mono-ester and/or salts thereof and/or one or more phosphoric acid di-ester and/or salts thereof, and/or

at least one saturated aliphatic linear or branched carboxylic acid and/or salts thereof, preferably at least one aliphatic carboxylic acid having a total amount of carbon atoms from Ca to C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cm and/or a salt thereof and/or

at least one mono-substituted succinic anhydride consisting of succinic anhydride mono-substituted with a group selected from a linear, branched, aliphatic and cyclic group having a total amount of carbon atoms from at least C₂ to Cao in the substituent and/or salts thereof, and/or

at least one polydialkylsiloxane, preferably selected from the group consisting of polydimethylsiloxane, preferably dimethicone, polydiethylsiloxane, polymethylphenylsiloxane and mixtures thereof.

According to one preferred embodiment, the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferably completely neutralized surface treatment agents; and/or
b) a maleic anhydride grafted polybutadiene homopolymer or a maleic anhydride grafted polybutadiene-styrene copolymer and/or an acid and/or salt thereof, preferably a maleic anhydride grafted polybutadiene homopolymer having
   i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
   ii) a number of anhydride groups per chain in the range from 2 to 12, preferably from 2 to 9, and more preferably from 2 to 6, and/or
   iii) an anhydride equivalent weight in the range from 400 to 2 200, preferably from 500 to 2 000, and more preferably from 550 to 1 800, and/or
   iv) an acid number in the range from 10 to 300 meq KOH/g of maleic anhydride grafted polybutadiene homopolymer, preferably 20 to 200 meq KOH/g, more preferably 30 to 150 meq KOH/g, measured according to ASTM D974-14, and/or
   v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer,
   and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, triethoxysilane, and mixtures thereof, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof, preferably at least one aliphatic carboxylic acid having a total amount of carbon atoms from C₄ to C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cis and/or a salt thereof and/or
f) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or
g) at least one polydialkylsiloxane, preferably selected from the group consisting of polydimethylsiloxane, preferably dimethicone, polydiethylsiloxane, polymethylphenylsiloxane and mixtures thereof, and/or
h) mixtures of the materials according to a) to g).

According to a preferred embodiment of the present invention, a process for the surface treatment of precipitated hydromagnesite comprises the steps of:
I) providing precipitated hydromagnesite;
II) providing at least one surface-treatment composition in an amount ranging from 0.07 to 9 mg/m² of the precipitated hydromagnesite surface, preferably 0.1 to 8 mg/m², more preferably from 0.11 to 3 mg/m²,
wherein the at least one surface-treatment composition comprises at least one surface-treatment agent selected from the group consisting of mono- or di-substituted succinic anhydride containing compounds comprising unsaturated carbon moieties, mono- or di-substituted succinic acid containing compounds comprising unsaturated carbon moieties, mono- or di-substituted succinic acid salts containing compounds comprising unsaturated carbon moieties, unsaturated fatty acids, salts of unsaturated fatty acids, unsaturated esters of phosphoric acid, salts of unsaturated phosphoric acid esters, abietic acid, salts of abietic acid, polydialkylsiloxanes, trialkoxysilanes comprising unsaturated carbon moieties, and mixtures thereof and reaction products thereof, and
III) contacting the precipitated hydromagnesite and the at least one surface-treatment composition in one or more steps at a temperature in the range from 20 to 180° C.,
preferably the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferred are completely neutralized surface treatment agents; and/or
b) a maleic anhydride grafted polybutadiene homopolymer or a maleic anhydride grafted polybutadiene-styrene copolymer and/or an acid and/or salt thereof, preferably a maleic anhydride grafted polybutadiene homopolymer having
   i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
   ii) a number of anhydride groups per chain in the range from 2 to 12, preferably from 2 to 9, and more preferably from 2 to 6, and/or
   iii) an anhydride equivalent weight in the range from 400 to 2 200, preferably from 500 to 2 000, and more preferably from 550 to 1 800, and/or
   iv) an acid number in the range from 10 to 300 meq KOH per g of maleic anhydride grafted polybutadiene homopolymer, preferably 20 to 200 meq KOH/g, more preferably 30 to 150 meq KOH/g, measured according to ASTM D974-14, and/or
   v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer,
   and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, triethoxysilane, and mixtures thereof.

According to a further aspect of the present invention, a surface-treated precipitated hydromagnesite obtained by a process according to the present invention is provided.

According to one embodiment, a surface-treated precipitated hydromagnesite is provided, wherein the precipitated hydromagnesite comprises at least one surface-treatment layer on at least a part of the surface of the precipitated hydromagnesite,

wherein the at least one surface-treatment layer is formed by contacting the precipitated hydromagnesite with at least one surface-treatment composition in an amount from 0.07 to 9 mg/m² of the precipitated hydromagnesite surface, preferably 0.1 to 8 mg/m², more preferably from 0.11 to 3 mg/m², and

wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated or unsaturated fatty acids, salts of saturated or unsaturated fatty acids, saturated or unsaturated esters of phosphoric acid, salts of saturated or unsaturated phosphoric acid esters, abietic acid, salts of abietic acid, polydialkylsiloxanes, trialkoxysilanes, and mixtures thereof and reaction products thereof, preferably the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, preferably both acid groups are in the salt form; unsaturated fatty acids, preferably oleic acid and/or linoleic acid; unsaturated esters of phosphoric acid; abietic acid and/or mixtures thereof, preferably completely neutralized surface treatment agents; and/or
b) a maleic anhydride grafted polybutadiene homopolymer or a maleic anhydride grafted polybutadiene-styrene copolymer and/or an acid and/or salt thereof, preferably a maleic anhydride grafted polybutadiene homopolymer having
   i) a number average molecular weight Mₙ measured by gel permeation chromatography from 1 000 to 20 000 g/mol, preferably from 1 400 to 15 000 g/mol, and more preferably from 2 000 to 10 000 g/mol measured according to EN ISO 16014-1:2019, and/or
   ii) a number of anhydride groups per chain in the range from 2 to 12, preferably from 2 to 9, and more preferably from 2 to 6, and/or
   iii) an anhydride equivalent weight in the range from 400 to 2 200, preferably from 500 to 2 000, and more preferably from 550 to 1 800, and/or
   iv) an acid number in the range from 10 to 300 meq KOH/g of maleic anhydride grafted polybutadiene homopolymer, preferably 20 to 200 meq KOH/g, more preferably 30 to 150 meq KOH/g, measured according to ASTM D974-14, and/or
   v) a molar amount of 1,2-vinyl groups in the range from 5 to 80 mol-%, preferably 10 to 60 mol-%, more preferably 15 to 40 mol-%, based on the total amount of unsaturated carbon moieties in the maleic anhydride grafted polybutadiene homopolymer,
and/or an acid and/or salt thereof, and/or
c) a trialkoxysilane, preferably a sulfur-containing trialkoxysilane or an amino-containing trialkoxysilane, more preferably selected from the group consisting of mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), vinyltrimethoxysilane, vinyltriethoxysilane, and mixtures thereof, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof, preferably at least one aliphatic carboxylic acid having a total amount of carbon atoms from Ca to C₂₄ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from Cm to Cis and/or a salt thereof and/or
f) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or
g) at least one polydialkylsiloxane, preferably selected from the group consisting of polydimethylsiloxane, preferably dimethicone, polydiethylsiloxane, polymethylphenylsiloxane and mixtures thereof, and/or
h) mixtures of the materials according to a) to g).

In a preferred embodiment, the filler is surface-treated precipitated hydromagnesite having a volume median particle size d₅₀ (vol) of from 0.1 to 75 μm, preferably from 0.5 to 50 μm, more preferably 1 to 40 mm, even more preferably from 1.2 to 30 μm, and most preferably from 1.5 to 15 μm, a volume top cut particle size d₉₈ (vol) from 0.2 to 150 μm, preferably from 1 to 100 μm, more preferably from 2 to 80 μm, even more preferably from 2.4 to 60 μm, and most preferably from 3 to 30 μm, and a BET specific surface area of from 15 to 200 g/m², preferably from 20 to 180 g/m², more preferably from 25 to 140 g/m², even more preferably from 27 to 120 g/m², and most preferably from to 100 g/m², measured using nitrogen and the BET method,

wherein the precipitated hydromagnesite comprises at least one surface-treatment layer on at least a part of the hydromagnesite surface, wherein the at least one surface-treatment layer is formed by contacting the precipitated hydromagnesite with at least one surface-treatment composition comprising at least one surface-treatment agent in an amount from 0.07 to 9 mg/m² of the filler surface, preferably 0.1 to 8 mg/m², more preferably 0.11 to 3 mg/m², wherein the at least one surface-treatment agent is selected from the group consisting of mono- or di-substituted succinic anhydride containing compounds comprising unsaturated carbon moieties, mono- or di-substituted succinic acid containing compounds comprising unsaturated carbon moieties, mono- or di-substituted succinic acid salts containing compounds comprising unsaturated carbon moieties, trialkoxysilanes, and mixtures thereof, preferably selected from the group consisting of a succinic anhydride grafted polybutadiene homopolymer, a succinic anhydride grafted polybutadiene-styrene copolymer, vinyltriethoxysilane, mercaptopropyltrimethoxysilane (MPTS), bis(triethoxysilylpropyl) disulfide (TESPD), bis(triethoxysilylpropyl) tetrasulfide (TESPT), 3-aminopropyltrimethoxysilane (APTMS), and mixtures thereof, and most preferably selected from the group consisting of a succinic anhydride grafted polybutadiene homopolymer, vinyltriethoxysilane, bis(triethoxysilylpropyl) tetrasulfide (TESPT), and mixtures thereof.

According to another embodiment, the precipitated hydromagnesite does not comprise a surface-treatment layer, i.e. an untreated precipitated hydromagnesite is employed in the inventive curable elastomer composition, the inventive cured elastomer product, the inventive article, the inventive method, or the inventive use, respectively.

According to another embodiment, the precipitated hydromagnesite comprises a surface-treatment layer, i.e. a surface-treated precipitated hydromagnesite is employed in the inventive curable elastomer composition, the inventive cured elastomer product, the inventive article, the inventive method, or the inventive use, respectively.

According to another embodiment, the precipitated hydromagnesite is surface-treated precipitated hydromagnesite, or a mixture of untreated precipitated hydromagnesite and surface-treated precipitated hydromagnesite.

According to one embodiment of the present invention, the filler is selected from the group consisting of untreated surface-reacted calcium carbonate, untreated precipitated hydromagnesite, surface-treated precipitated hydromagnesite, and mixtures thereof.

### Further Components

In each of the aspects of the present invention, i.e., the inventive use, the inventive process, the inventive product, and the inventive article, the elastomer composition may comprise further components.

According to one embodiment, the curable elastomer composition further comprises colouring pigment, dyes, wax, lubricant, oxidative- and/or UV-stabilizer, antioxidant, additional filler, processing aid, plasticizer, additional polymer, and mixtures thereof.

According to one embodiment, the curable elastomer composition comprises at least one additional filler, preferably the at least one additional filler is selected from the group comprising carbon black, silica, ground natural calcium carbonate, precipitated calcium carbonate, nanofiller, graphite, clay, talc, kaolin clay, calcined kaolin, calcined clay, diatomaceous earth, barium sulfate, titanium dioxide, wollastonite, and mixtures thereof, preferably selected from the group comprising, preferably consisting of, ground natural calcium carbonate, precipitated calcium carbonate, barium sulfate, carbon black, silica, wollastonite, and mixtures thereof, and most preferably carbon black. The additional filler may be present in an amount from 0.1 to 50 wt.-%, preferably from 1 to 30 wt.-%, and most preferably in an amount of 2 to 20 wt.-%, based on the total weight of the crosslinkable polymer. Preferably, the at least one additional filler is present in the curable elastomer composition in a volume ratio with the filler selected from surface-reacted calcium carbonate and/or precipitated hydromagnesite in the range from 10:90 to 90:10, preferably from 25:75 to 75:25, and more preferably from 40:60 to 60:40, for example 50:50. According to a preferred embodiment, the curable elastomer composition comprises a crosslinkable polymer, and a filler selected from surface-reacted calcium carbonate, precipitated hydromagnesite, or a mixture thereof, and at least one additional filler selected from the group consisting of ground natural calcium carbonate, precipitated calcium carbonate, barium sulfate, carbon black, silica, wollastonite, and mixtures thereof, preferably carbon black, wherein the additional filler is present in a volume ratio with the filler selected from surface-reacted calcium carbonate and/or precipitated hydromagnesite in the range from 10:90 to 90:10, preferably from 25:75 to 75:25, more preferably from 40:60 to 60:40, and most preferably 50:50.

In the meaning of the present invention, the term “nanofiller” relates to a material essentially insoluble in the elastomeric resin, and wherein the material has a volume median particle size d₅₀ below 1 μm.

In a preferred embodiment, the curable elastomer composition further comprises a crosslinking agent, wherein the crosslinking agent preferably is selected from the group consisting of peroxide curing agents, sulphur-based curing agents, bisphenol-based crosslinking agents, amine or diamine-based crosslinking agents, and mixtures thereof. In addition, a crosslinking coagent may be present.

If the curing agent is a peroxide, the curing agent can be selected from a very wide range of materials, including peresters, perketals, hydroperoxides, peroxydicarbonates, diacyl peroxides and ketone peroxides. Examples of such peroxides include t-butyl peroctanoate, perbenzoate, methyl ethyl ketone peroxide, cyclohexanone peroxide, acetyl acetone peroxide, dibenzoyl peroxide, bis(4-t-butyl-cyclohexyl) peroxydicarbonate, dicumyl peroxide, 1,1-bis(tert-butylperoxy)-3,3,5-trimethylcyclohexane, 2,5-bis-(t-butylperoxy)-2,5-dimethylhexane, 2,5-bis-(t-butylperoxy)-2,5-dimethylhexyne, or α,α′-bis(t-butylperoxy)diisopropylbenzene, diisopropyl peroxydicarbonate, 1,1-bis(tert-hexylperoxy)-3,5,5-trimethylcyclohexane, 2,5-dimethylhexane-2,5-dihydroperoxide, di-tert-butyl peroxide, tert-butylcumyl peroxide, 2,5-dimethyl-2,5-bis(tert-butylperoxy)hexane, 2,5-dimethyl-2,5-bis(tert-butylperoxy)-3-hexine, tert-butyl peroxybenzoate, 2,5-dimethyl-2,5-bis(benzoylperoxy)hexane, tert-butyl peroxymaleate or tert-hexylperoxyisopropyl monocarbonate and the like. If desired, a mixture of two or more peroxides can be used.

Preferably the peroxide crosslinking-agents may be used in combination with a coagent. Examples of suitable coagents are 1,2,-polybutadiene, ethylene glycol dimethacrylate, triallyl phosphate, triallylisocyanurate, m-phenylenediamine-bis-maleimide or triallylcyanurate.

The sulphur based curing agent can be elemental sulphur or a sulphur-containing system such as thioureas such as ethylene thiourea, N,N-dibutylthiourea, N,N-diethylthiourea and the like; thiuram monosulfides and disulfides such as tetramethylthiuram monosulfide (TMTMS), tetrabutylthiuram disulfide (TBTDS), tetramethylthiuram disulfide (TMTDS), tetraethylthiuram monosulfide (TETMS), dipentamethylenethiuram hexasulfide (DPTH) and the like; benzothiazole sulfenamides such as N-oxydiethylene-2-benzothiazole sulfenamide, N-cyclohexyl-2-benzothiazole sulfenamide, N,N-diisopropyl-2-benzothiazole sulfenamide, N-tert-butyl-2-benzothiazole sulfenamide (TBBS) and the like; 2-mercaptoimidazoline, N,N-diphenylguanadine, N,N-di-(2-methylphenyl)-guanadine, thiazole accelerators such as 2-mercaptobenzothiazole, 2-(morpholinodithio)benzothiazole disulfide, zinc 2-mercaptobenzothiazole and the like; dithiocarbamates accelerators such as tellurium diethyldithiocarbamate, copper dimethyldithiocarbamate, bismuth dimethyldithiocarbamate, cadmium diethyldithiocarbamate, lead dimethyldithiocarbamate, zinc diethyldithiocarbamate and zinc dimethyldithiocarbamate. If desired, a mixture of two or more sulphur based curing agents can be used.

Examples of suitable amine crosslinking-agents are butylamine, dibutylamine, piperidine, trimethylamine, or diethylcyclohexylamine. Examples of suitable diamine crosslinking-agents are bis-cinnamylidene hexamethylene diamine, hexamethylene diamine carbamate, bis-peroxycarbamate such as hexamethylene-N,N′bis(tert-butyl peroxycarbamate or methylene bis-4-cyclohexyl-N,N′(tert-butylperoxycarbamate), piperazine, triethylene diamine, tetramethylethyldiamine, or diethylene triamine.

Examples of suitable bisphenol crosslinking-agents are 2,2-bis(4-hydroxyphenyl)hexafluoropropane, substituted hydroquinone, 4,4′-disubstituted bisphenol, or hexafluoro-bisphenol A.

It should be understood that the crosslinking agent and crosslinking coagent, if present, react with the crosslinkable polymer during the curing step, and thus, may form a part of the cured elastomer product. Furthermore, the cured elastomer product thus may comprise reaction products of the crosslinking agent and the crosslinking coagent, if present.

According to one embodiment, the curable elastomer composition comprises the crosslinking agent in an amount from 0.1 to 20 wt.-%, based on the total weight of the crosslinkable polymer, preferably in an amount from 0.2 to 15 wt. %, more preferably from 0.5 to 10 wt.-%, and most preferably in an amount from 1 to 5 wt.-%.

### Preparation of Curable Elastomer Composition

According to one embodiment, a method of producing the curable elastomer composition of the present invention comprises the steps of:
i) providing a crosslinkable polymer,
ii) providing a filler selected from surface-reacted calcium carbonate, precipitated hydromagnesite, or a mixture thereof, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source, and
iii) combining the crosslinkable polymer of step i) and the filler of step ii) in one or more steps, preferably in one step.

Optionally, any of the further components mentioned above may be added before, during and/or after step iii). For example, a crosslinking agent and/or an additional filler may be added before, during and/or after step iii). According to one embodiment, at least one crosslinking agent is added before, during and/or after step iii) in an amount from 0.1 to 20 wt.-%, based on the total weight of the crosslinkable polymer, preferably in an amount from 0.2 to 15 wt. %, more preferably from 0.5 to 10 wt.-%, and most preferably in an amount from 1 to 5 wt.-%, and/or at least one additional filler is added before, during and/or after step iii) in an amount from 0.1 to 30 wt.-%, preferably from 1 to 20 wt.-%, and most preferably in an amount of 2 to 15 wt.-%, based on the total weight of the crosslinkable polymer.

The components of the composition may be combined by any method known in the art. According to one embodiment, the components are mixed in a mixer, preferably an open mill cylinder mixer. According to another embodiment, the components are kneaded by a kneading machine such as an open roll, a Banbury mixer or a kneader.

The components may be combined in a state dissolved or dispersed in a solvent. Further, in a case where the crosslinkable polymer is two or more types of polymers, individually produced polymers may be blended first to produce a polymer mixture, before the filler is added, or two or more types of polymers may be blended simultaneously with the filler.

The skilled person will adapt the blending temperature such that a reaction between the components of the curable elastomer composition is avoided. For example, in case a crosslinking agent is present, cooling during blending may be required in order to avoid a crosslinking reaction. According to one embodiment, the blending temperature is from 20 to 120° C., preferably from 40 to 60° C. The blending time is preferably from 5 to 60 minutes, more preferably from 10 to 30 minutes.

According to one embodiment the filler is provided in an amount from 1 to 80 wt.-%, preferably from 2 to 60 wt.-%, more preferably from 5 to 40 wt.-%, and most preferably from 10 to 30 wt.-%, based on the total weight of the curable elastomer composition, and the crosslinkable polymer is provided in an amount from 20 to 99 wt.-%, preferably in an amount from 40 to 98 wt.-%, more preferably from 60 to 95 wt.-%, and most preferably from 70 to 90 wt.-%, based on the total weight of the curable elastomer composition.

According to another embodiment the filler is provided in an amount from 1 to 80 wt.-%, preferably from 2 to 60 wt.-%, more preferably from 5 to 40 wt.-%, and most preferably from 10 to 30 wt.-%, based on the total weight of the crosslinkable polymer and the filler, and the crosslinkable polymer is provided in an amount from 20 to 99 wt.-%, preferably in an amount from 40 to 98 wt.-%, more preferably from 60 to 95 wt.-%, and most preferably from 70 to 90 wt.-%, based on the total weight of the crosslinkable polymer and the filler.

### Cured Elastomer Product

According to a further aspect of the present invention, a cured elastomer product formed from the curable elastomer composition according to the present invention is provided.

The cured elastomer product of the present invention may be formed from the curable elastomer composition by any suitable method known in the art. A method of producing a cured elastomer product may comprise the steps of
I) providing a curable elastomer composition, and
II) curing the curable elastomer composition.

According to one embodiment, a method of producing a cured elastomer product is provided, comprising the steps of
i) providing a crosslinkable polymer,
ii) providing a filler selected from surface-reacted calcium carbonate, precipitated hydromagnesite, or a mixture thereof,
   wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source,
iii) combining the crosslinkable polymer of step i) and the filler of step ii) in one or more steps to form a curable elastomer composition, and
iv) curing the curable elastomer composition of step iii).

According to one embodiment, step iii) is carried out in one step.

The curing of the curable elastomer composition may be carried out by any method known in the art. According to one embodiment the curing step II) or iv) is carried out by adding a crosslinking agent, heat treatment, ultraviolet light radiation, electron-beam radiation and/or nuclear radiation.

The heat treatment may be carried out at temperatures from 95 to 230° C., preferably from 125 to 180° C., and most preferably from 150 to 170° C. The heating time may be from 1 minute to 15 hours, preferably from 5 minutes to 2 hours, and most preferably from 10 to 30 minutes.

According to a preferred embodiment, the curing step II) or iv) is carried out by adding a crosslinking agent and applying a heat treatment. The crosslinking agent may be selected from the crosslinking agents disclosed above. According to one embodiment, the crosslinking agent is added before, during and/or after step iii) in an amount from 0.1 to 20 wt.-%, based on the total weight of the crosslinkable polymer, preferably in an amount from 0.2 to 15 wt. %, more preferably from 0.5 to 10 wt.-%, and most preferably in an amount from 1 to 5 wt.-%. The addition of the crosslinking agent and the heat treatment may be carried out at the same time or the heat treatment may be applied after the addition of the crosslinking agent.

The curable elastomer composition may be shaped and cured at the same time, or may be shaped first, and cured subsequently. According to a further embodiment of the present invention, the method of producing a cured elastomer product comprises a further step III) or v) of shaping the curable elastomer composition during steps II) or iv).

Methods of shaping a curable elastomer composition are known to the skilled person. For example, the shaping may be carried out by extrusion or molding such as injection molding, transfer molding or compression molding, preferably compression molding. During compression molding, pressure is applied to force the mixture into the defined shape of the mold, such that the mixture is in contact with all areas of the mold, and the mixture is crosslinked in the mold, such that the cured elastomer product retains the desired shape. Preferably, compression molding is performed at a pressure of at least 100 bar, preferably of at least 150 bar, and more preferably of at least 200 bar.

According to a further aspect of the present invention, an article comprising the cured elastomer product according to the present invention is provided. According to a preferred embodiment, the article is selected from the group comprising tubeless articles, membranes, sealings, gloves, pipes, cable, electrical connectors, oil hoses, shoe soles, o-ring seals, shaft seals, gaskets, tubing, valve stem seals, fuel hose, tank seals, diaphragms, flexi liners for pumps, mechanical seals, pipe coupling, valve lines, military flare blinders, electrical connectors, fuel joints, roll covers, firewall seals, clips for jet engines, tires, and conveyor belts.

The inventors of the present application surprisingly found that a filler selected from surface-reacted calcium carbonate, precipitated hydromagnesite, or a mixture thereof, can be used for reinforcing a cured elastomer product. In other words, it was found the mechanical properties of cured elastomer product comprising the afore-mentioned fillers are improved compared to a cured elastomer product comprising no fillers or fillers conventionally used in the art such as carbon black. In particular, it was found that the tear resistance and the elongation of break of a cured elastomer product can be improved by the presence of the inventive filler.

According to a further aspect, use of a filler for reinforcing a cured elastomer product is provided, wherein the filler is selected from surface-reacted calcium carbonate, precipitated hydromagnesite, or a mixture thereof, and wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

According to one embodiment the tear resistance and/or the elongation at break and/or tensile strength and/or tensile modulus of the cured elastomer product is increased compared to a cured elastomer without filler by at least 5%, preferably by at least 10%, more preferably by at least 15%, and most preferably by at least 20%, wherein the tear resistance is measured according to NF ISO 34-2, and the elongation at break, tensile strength, tensile modulus are measured according NF ISO 37.

According to a further embodiment the tear resistance and/or the elongation at break and/or tensile strength and/or tensile modulus M100 of the cured elastomer product is increased compared to a cured elastomer product containing an isovolumic amount of carbon black N550 as filler, wherein the carbon black has a statistical thickness surface area (STSA) of 39±5 m²/g, measured according to ASTM D 6556-19, the tear resistance is measured according to NF ISO 34-2, and the elongation at break, tensile strength, tensile modulus are measured according NF ISO 37. Preferably the tear resistance and/or the elongation at break of the elastomer product may be increased by at least 5%, preferably by at least 10%, more preferably by at least 15%, and most preferably by at least 20%.

The scope and interest of the invention will be better understood based on the following examples which are intended to illustrate certain embodiments of the present invention and are non-limitative.

### EXAMPLES

### 1. Methods

Molecular Weight

The number-average molecular weight Mₙ is measured by gel permeation chromatography, according to ISO 16014-1:2019 and ISO 16014-2/2019.

Acid Number

The acid number is measured according to ASTM D974-14.

Specific Surface Area (BET)

The specific surface area (in m²/g) is determined using the BET method (using nitrogen as adsorbing gas), which is well known to the skilled man (ISO 9277:2010). The total surface area (in m²) of the filler material is then obtained by multiplication of the specific surface area and the mass (in g) of the corresponding sample.

Iodine Number

The iodine number is measured according to DIN 53241/1.

Particle Size

Volume median particle size d₅₀ (vol) and volume top cut particle size d₉₈ (vol) are evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

The weight median particle size d₅₀ (wt) and weight top cut particle size d₉₈ (wt) is determined by the sedimentation method, which is an analysis of sedimentation behaviour in a gravimetric field. The measurement is made with a Sedigraph™ 5100 or 5120, Micromeritics Instrument Corporation. The method and the instrument are known to the skilled person and are commonly used to determine grain size of fillers and pigments. The measurement is carried out in an aqueous solution of 0.1 wt.-% Na₄P₂O₇. The samples were dispersed using a high speed stirrer and sonicated.

The processes and instruments are known to the skilled person and are commonly used to determine the particle size of fillers and pigments.

Moisture Pick Up Susceptibility

The moisture pick up susceptibility of a material as referred to herein is determined in mg moisture/g after exposure to an atmosphere of 10% and 85% relative humidity, respectively, for 2.5 hours at a temperature of +23° C. (±2° C.). The measurement was done in a GraviTest 6300 device from Gintronic. For this purpose, the sample is first kept at an atmosphere of 10% relative humidity for 2.5 hours, then the atmosphere is changed to 85% relative humidity at which the sample is kept for another 2.5 hours. The weight increase between 10% and 85% relative humidity is then used to calculate the moisture pick-up in mg moisture/g of sample.

Analysis on Cured Polymer Product Samples

For all tests on the cured elastomer product samples, a minimum period of 16 h was kept between molding and testing of the product samples. The samples were kept in a controlled environment (temperature: 23±2° C., relative humidity: 50±5%).

Tensile Strength, Elongation at Break, Tensile Modulus M300 and M100:

Tensile strength, elongation at break, tensile modulus M300 and M100 were measured according to NF ISO 37 on a Zwick T2000, Zwick Z005, or Zwick Z100 device using the parameters outlined in Table 1 below.

TABLE 1
Tensile strength, elongation at break, modulus
M300, and Modulus M100 measurement parameters.

| | |
|---|---|
| Standard | NF ISO 37 |
| Type of test piece | Type H2 |
| Preparation of test piece | Samples were cut from sheets |
| | of 2 ± 0.2 mm thickness |
| Cutting direction | Parallel of calendering direction |
| State | Initial |
| Temperature | 23 ± 2° C. |
| Relative humidity | 50 ± 5% |
| Number of test pieces used | 3 |
| Units | MPa for strength |
| Test specimen conditioning before test | Minimum 16 h at 23° C. and |
| | 50% relative humidity |
| Conditioning after ageing in air | None |
| Conditioning after immersion | None |
| Rate of grip separation | 500 mm/min |

Tear Resistance

Tear resistance (DELFT) was measured according to NF ISO 34-2 on a Zwick T2000, Zwick Z005, Zwick Z100 device using the parameters outlined in Table 2.

TABLE 2
Tear resistance (DELFT) measurement parameters.

| | |
|---|---|
| Standard | NF ISO 34-2 |
| Type of test piece | Delft |
| Preparation of test piece | Samples were cut from sheets of |
| | 2 ± 0.2 mm thickness |
| Cutting direction | perpendicular to calendering direction |
| State | Initial |
| Temperature | 23 ± 2° C. |
| Relative humidity | 50 ± 5% |
| Number of test pieces used | 3 |
| Test specimen conditioning | Minimum 16 h at 23° C. and |
| before test | 50% relative humidity |
| Rate of grip separation | 500 mm/min |

Hardness Shore A

Hardness (Shore A) was measured according to NF ISO 7619-1 on a Bareiss Digitest II apparatus using the parameters outlined in Table 3.

TABLE 3
Hardness (Shore A) measurement parameters.

| | |
|---|---|
| Standard | NF ISO 7619-1 |
| Type of device | A |
| Type of test piece | 50 × 25 × (2.0 ± 0.2) mm |
| Number of test pieces used | 3 |
| Test carry out | 3 s |
| Preparation of test piece | Samples were cut from sheets |
| | of 2 ± 0.2 mm thickness |
| State | Initial |
| Temperature | 23 ± 2° C. |
| Relative humidity | 50 ± 5% |
| Number of measurements | 5 |
| Unit | points |
| Test specimen conditioning before test | Minimum 16 h at 23° C. and |
| | 50% relative humidity |

Hardness IRHD

Hardness (IRHD) was measured according to NF ISO 48-1 on a Wallace IRHD H14/1+ Gibitre-PC type N automatic apparatus using the parameters outlined in Table 4.

TABLE 4
Hardness (IRHD) measurement parameters.

| | |
|---|---|
| Standard | NF ISO 48-1 |
| Method | N |
| Type of test piece | 50 × 20 × (2.0 ± 0.2) mm |
| Number of test pieces used | 4 |
| Preparation of test piece | Samples were cut from sheets |
| | of 2 ± 0.2 mm thickness |
| State | Initial |
| Temperature | 23 ± 2° C. |
| Relative humidity | 50 ± 5% |
| Number of measurements | 5 |
| Unit | ° |
| Test specimen conditioning | Minimum 16 h to 6 days at 23° C. |
| before test | and 50% relative humidity |
| Conditioning after immersion | none |

Compression Set

These tests were provided on compression set plots type B, which are cylindrical molded rubber samples. The diameter of the sample was 13.0±0.5 mm and the thickness was 6.3±0.3 mm. Tests were carried out for 72 h at 100° C. using the parameters outlined in Table 5.

TABLE 5
Compression set.

| Standard | NF ISO 815-1 |
|---|---|
| Method | After 30 ± 3 min |
| Type of test piece | B |
| Number of test pieces used | 3 or 4 |
| Unit | % |
| Compression | 25% |
| Conditioning after immersion | none |
| Lubricant | Silicone |
| Preparation of test piece | molded |
| Temperature | 23 ± 2° C. |
| Relative humidity | 50 ± 5% |

### 2. Materials

Treatment A

Treatment A is a low molecular weight polybutadiene functionalized with maleic anhydride (Mₙ=3100 Da, Brookfield viscosity: 6500 cps+/−3500 at 25° C., acid number: 40.1-51.5 meq KOH/g, total acid: 7-9 wt.-%, microstructure (molar % of butadiene): 20-35% 1-2 vinyl functional groups), commercially available under the trade name RICON®130MA8 (Cray Valley).

Treatment B

Treatment B is (bis[3-(triethoxysilyl)propyl]tetrasulfide) (TESPT) (CAS: 40372-72-3), commercially available from Sigma-Aldrich.

Treatment C

Treatment C is a fatty acid mixture consisting of about 40% stearic acid and about 60% palmitic acid.

Treatment D

Treatment D is a mono-substituted alkenyl succinic anhydride (2,5-furandione, dihydro-, mono-C₁₅₋₂₀-alkenyl derivates, CAS: 68784-12-3). It is a blend of mainly branched octadecenyl succinic anhydrides (CAS: 28777-98-2) and mainly branched hexadecenyl succinic anhydrides (CAS: 32072-96-1), wherein the blend contains more than 80 wt.-% branched octadecenyl succinic anhydrides, based on the total weight of the blend. The purity of the blend was >95 wt.-%, and the residual olefin content was below 3 wt.-%, based on the total weight of the blend.

Treatment E

Treatment E is octadecyltriethoxyilane (CAS: 7399-00-0, commercially available from Gelest Inc.)

Treatment F

Treatment F is a low molecular weight, low vinyl butadiene functionalized with maleic anhydride (Mₙ=5000 g/mol, Brookfield viscosity: 48000 cps at 25° C., 1,2 vinyl content=28 wt.-%; MA groups/chain=5), commercially available under the trade name RICOBOND® 1031 (Cray Valley).

Powder 1

Powder 1 is a surface-reacted calcium carbonate with a d₅₀ (vol) of 4.8 μm, a d₉₈ (vol) of 13.3 μm, and specific surface area SSA of 33 m²/g.

Powder 2

Powder 2 is a surface-reacted calcium carbonate composed of 80% hydroxyapatite and 20% calcite (BET=85 m²/g, d₅₀ (vol)=6.1 μm, d₉₈ (vol)=13.8 μm), prepared with the following method:

In a mixing vessel, 350 liters of an aqueous suspension of natural ground calcium carbonate was prepared by adjusting the solids content of a ground marble calcium carbonate from Hustadmarmor, Norway, with a particle size distribution of 90 wt.-% less than 2 μm as determined by sedimentation, such that a solids content of 10 wt.-%, based on the total weight of the aqueous suspension, is obtained.

Whilst mixing the suspension, 62 kg of a 30% concentrated phosphoric acid was added to said suspension over a period of 10 minutes at a temperature of 70° C. Finally, after the addition of the phosphoric acid, the slurry was stirred for additional 5 minutes, before removing it from the vessel and drying.

Powder 3

Powder 3 is a surface-reacted calcium carbonate composed of 83% hydroxyapatite and 17% calcite (BET=67 m²/g, d₅₀ (vol)=1.2 μm, d₉₈ (vol)=9.7 μm).

Powder 4

Powder 4 is a precipitated hydromagnesite (BET specific surface area: 84.2 m²/g, d₅₀ (vol)=7.6 μm; d₉₅ (vol)=20.6 μm).

Powder 5

Powder 5 has been prepared by surface-treating powder 4 with 2.5 wt.-% of treatment A. To carry the treatment, the treatment agent (25 g) was first dispersed in 100 mL of deionized water, heated to 60° C. and neutralized to pH 9-10 with NaOH solution.

A suspension of powder 4 (1 kg in 7.5 L deionized water) was prepared in a 10 L ESCO batch reactor (ESCO-Labor AG, Switzerland) and heated to 85° C. The pH was adjusted to 10-11 with Ca(OH)₂ and the neutralized treatment agent was then added under vigorous stirring. Mixing was continued at 85° C. for 45 minutes, and the suspension was then transferred to metallic tray and dried in an oven (110° C.). The dried cake was then deagglomerated using a SR300 rotor beater mill (Retsch GmbH, Germany).

Powder 6

Powder 6 was prepared by surface treatment of powder 2 with 7.5 wt.-% of treatment B. Surface treatment was carried out in a high speed mixer (Somakon MP-LB Mixer, Somakon Verfahrenstechnik, Germany). Powder 2 (300 g) was put in the mixer and stirred at 500 rpm and room temperature. Treatment B (7.5 wt.-%, 24 g) was then added dropwise to the mixture and stirring was continued for another 10 minutes. After that time, the mixture was allowed to cool and the powder was collected.

Powder 7

Powder 7 is a precipitated hydromagnesite (d₅₀ (vol)=8.8 μm; d₉₈ (vol)=29 μm).

Powder 8

Powder 8 is a precipitated hydromagnesite (d₅₀ (vol)=11.6 μm; d₉₈ (vol)=47 μm).

Powder 9

Powder 9 was prepared by surface treatment of powder 7 with 4 wt.-% of treatment C. Surface treatment was carried out in a high speed mixer (Somakon MP-LB Mixer, Somakon Verfahrenstechnik, Germany equipped with a 2.5 L vessel). Powder 7 (150 g) was put in the mixer and stirred at 500 rpm and 120° C. Treatment C (4 wt.-%, 6 g) was then added to the mixture and stirring was continued for another 15 minutes. After that time, the mixture was allowed to cool and the powder was collected.

Powder 10

Powder 10 was prepared by surface treatment of powder 7 with 10 wt.-% of treatment C. Surface treatment was carried out in a high speed mixer (Somakon MP-LB Mixer, Somakon Verfahrenstechnik, Germany equipped with a 2.5 L vessel). Powder 7 (150 g) was put in the mixer and stirred at 500 rpm and 120° C. Treatment C (10 wt.-%, 15 g) was then added to the mixture and stirring was continued for another 15 minutes. After that time, the mixture was allowed to cool and the powder was collected.

Powder 11

Powder 11 was prepared by surface treatment of powder 7 with 4 wt.-% of treatment D. Surface treatment was carried out in a high speed mixer (Somakon MP-LB Mixer, Somakon Verfahrenstechnik, Germany equipped with a 2.5 L vessel). Powder 7 (150 g) was put in the mixer and stirred at 500 rpm and 120° C. Treatment D (4 wt.-%, 6 g) was then added to the mixture and stirring was continued for another 15 minutes. After that time, the mixture was allowed to cool and the powder was collected.

Powder 12

Powder 12 was prepared by surface treatment of powder 7 with 10 wt.-% of treatment D. Surface treatment was carried out in a high speed mixer (Somakon MP-LB Mixer, Somakon Verfahrenstechnik, Germany equipped with a 2.5 L vessel). Powder 7 (150 g) was put in the mixer and stirred at 500 rpm and 120° C. Treatment D (10 wt.-%, 15 g) was then added to the mixture and stirring was continued for another 15 minutes. After that time, the mixture was allowed to cool and the powder was collected.

Powder 13

Powder 13 was prepared by surface treatment of powder 7 with 5 wt.-% of treatment C and 5 wt.-% of treatment A. Surface treatment was carried out in a high speed mixer (Somakon MP-LB Mixer, Somakon Verfahrenstechnik, Germany equipped with a 2.5 L vessel). Powder 7 (150 g) was put in the mixer and stirred at 500 rpm and 120° C. Treatment C (5 wt.-%, 7.5 g) was first added slowly and treatment A (5 wt.-%, 7.5 g) was added subsequently to the mixture. Stirring was then continued for another 15 minutes. After that time, the mixture was allowed to cool and the powder was collected.

Powder 14

Powder 14 was prepared by surface treatment of powder 8 with 4 wt.-% of treatment D. Surface treatment was carried out in a high speed mixer (Somakon MP-LB Mixer, Somakon Verfahrenstechnik, Germany equipped with a 2.5 L vessel). Powder 8 (150 g) was put in the mixer and stirred at 500 rpm and 120° C. Treatment D (4 wt.-%, 6 g) was then added to the mixture and stirring was continued for another 15 minutes. After that time, the mixture was allowed to cool and the powder was collected.

Powder 15

Powder 15 was prepared by surface treatment of powder 8 with 4 wt.-% of treatment B. Surface treatment was carried out in a high speed mixer (Somakon MP-LB Mixer, Somakon Verfahrenstechnik, Germany equipped with a 2.5 L vessel). Powder 8 (150 g) was put in the mixer and stirred at 500 rpm and 120° C. Treatment B (4 wt.-%, 6 g) was then added to the mixture and stirring was continued for another 15 minutes. After that time, the mixture was allowed to cool and the powder was collected.

Powder 16

Powder 16 was prepared by surface treatment of powder 8 with 4 wt.-% of treatment E. Surface treatment was carried out in a high speed mixer (Somakon MP-LB Mixer, Somakon Verfahrenstechnik, Germany equipped with a 2.5 L vessel). Powder 8 (150 g) was put in the mixer and stirred at 500 rpm and 120° C. Treatment E (4 wt.-%, 6 g) was then added to the mixture and stirring was continued for another 15 minutes. After that time, the mixture was allowed to cool and the powder was collected.

Powder 17

Powder 17 has been prepared by surface-treating powder 7 with 4 wt.-% of treatment C. To carry the treatment, the treatment agent (8 g) was first dispersed in 300 mL of deionized water, heated to 80° C. and neutralized with NaOH solution (1.5 g).

A suspension of powder 7 (0.2 kg in 5 L deionized water) was prepared in a 10 L ESCO batch reactor (ESCO-Labor AG, Switzerland) and heated to 85° C. The neutralized treatment agent was then added under vigorous stirring. Mixing was continued at 85° C. for 45 minutes, and the suspension was then filtered in filter press, transferred to metallic tray and dried in an oven (110° C.). The dried cake was then deagglomerated using a SR300 rotor beater mill equipped with a 200 micrometers sieve (Retsch GmbH, Germany).

TABLE 6
Physical characteristics of powders 7 to 17 (n.d.: not determined).

| | | Density | TGA Mass | Moisture |
|---|---|---|---|---|
| | | (He-pycno- | loss | pick-up |
| | BET | metry) | 25-105° C. | susceptibility |
| Powder | (m²/g) | (g/cm³) | (wt .- %) | (mg/g) |
| Powder 7 | 46.7 | 2.03 | 3.03 | 27.2 |
| Powder 8 | 42.7 | 2.16 | 2.89 | 18.1 |
| Powder 9 | 39.4 | 2.01 | 2.07 | 23.3 |
| Powder 10 | 36.5 | 2.00 | 2.08 | 22.4 |
| Powder 11 | 31.7 | 2.00 | 1.79 | 16.6 |
| Powder 12 | 32.2 | 1.92 | 1.74 | 12.5 |
| Powder 13 | 33.4 | 1.86 | 2.37 | 21.8 |
| Powder 14 | 22.3 | 2.11 | 1.81 | 5.5 |
| Powder 15 | 26.5 | 2.17 | 1.84 | 7.6 |
| Powder 16 | 22.4 | n.d. | 1.82 | 7.7 |
| Powder 17 | 42.8 | 2.06 | 1.08 | 30.3 |

Powder 18

Powder 18 is a surface-reacted calcium carbonate (BET=139 m²/g, d₅₀ (vol)=6.1 μm, d₉₈ (vol)=14.2 μm) prepared with the following method:

In a mixing vessel, 350 liters of an aqueous suspension of natural ground calcium carbonate was prepared by adjusting the solids content of a ground marble calcium carbonate from Hustadmarmor, Norway with a particle size distribution of 90 wt.-% less than 2 μm as determined by sedimentation, such that a solids content of 10 wt.-%, based on the total weight of the aqueous suspension, is obtained.

Whilst mixing the suspension, 62 kg of a 30% concentrated phosphoric acid was added to said suspension over a period of 10 minutes at a temperature of 70° C. Additionally, during the phosphoric acid addition, 1.9 kg of citric acid was added rapidly (about 30 s) to the slurry. Finally, after the addition of the phosphoric acid, the slurry was stirred for additional 5 minutes, before removing it from the vessel and drying.

Powder 19

Powder 19 has been prepared by surface-treating powder 7 with 5 wt.-% of treatment A. To carry out the treatment, the treatment agent (35 g) was first dispersed in 400 mL of deionized water, heated to 60° C. and neutralized to pH 10 with NaOH solution.

A suspension of powder 7 (700 g in 6 L deionized water) was prepared in a 10 L ESCO batch reactor and heated to 85° C. The pH was adjusted to 10 with Ca(OH)₂ and the neutralized treatment agent was then added under vigorous stirring. Mixing was continued at 85° C. for 45 minutes, and the suspension was then filtered on a filter press and dried overnight in an oven (110° C.). The dried filter cake was then deagglomerated using a Retsch SR300 rotor beater mill.

Powder 20

Powder 20 is a precipitated hydromagnesite (BET=70.1 m²/g, d₅₀ (vol)=6.3 μm; d₉₈ (vol)=70 μm).

Powder 21

Powder 21 was prepared by surface treatment of powder 2 with 8 wt.-% of treatment B. Surface treatment was carried out in a high speed mixer (Somakon MP-LB Mixer, Somakon Verfahrenstechnik, Germany). Powder 2 (500 g) was put in the mixer and stirred at 500 rpm and 70° C. Treatment B (8 wt.-%, 40 g) was then added dropwise to the mixture and stirring was continued for another 15 minutes. After that time, the mixture was allowed to cool and the powder was collected.

Powder 22

Powder 22 has been prepared by surface-treating powder 7 with 7.5 wt.-% of treatment A. To carry out the treatment, the treatment agent (64 g) was first dispersed in 400 mL of deionized water, heated to 60° C. and neutralized to pH 10 with NaOH solution.

A suspension of powder 7 (850 g in 6 L deionized water) was prepared in a 10 L ESCO batch reactor and heated to 85° C. The pH was adjusted to 10 with Ca(OH)₂ and the neutralized treatment agent was then added under vigorous stirring. Mixing was continued at 85° C. for 45 minutes, and the suspension was then filtered on a filter press and dried overnight in an oven (110° C.). The dried filter cake was then deagglomerated using a Retsch SR300 rotor beater mill.

Powder 23

Powder 23 has been prepared by treating a precipitated hydromagnesite powder with treatment agent B. Surface treatment was carried out in a high speed mixer (Somakon MP-LB Mixer, Somakon Verfahrenstechnik, Germany). The untreated precipitated hydromagnesite powder (400 g) was put in the mixer and stirred at 500 rpm and 70° C. Treatment B (7.5 wt.-%, 30 g) was then added dropwise to the mixture and stirring was continued for another 15 minutes. After that time, the mixture was allowed to cool and the powder was collected (BET=32.8 m²/g, d₅₀ (vol)=8.6 μm; d₉₈ (vol)=μm).

Powder CE1 (Comparative)

Powder CE1 is a N550 carbon black filler, commercially available from Orion engineered Carbons GmbH (Purex® HS 45, iodine number: 43±5 mg/g, STSA surface area (according to ASTM D 6556): 39±5 m²/g).

Powder CE2 (Comparative)

Powder CE2 is high purity fully calcined kaolin, commercially available from Imerys (Polestar 200R, d₅₀ (wt)=2 μm).

Powder CE3 (Comparative)

Powder CE3 is a calcium carbonate having a d₅₀ (wt) of 2.4 μm, a d₉₈ of 9 μm and a BET specific surface area of about 2 m²/g.

Powder CE4 (Comparative)

Powder CE4 is high purity fully calcined kaolin, commercially available from Imerys (Polestar 200P, d₅₀ (wt)=2 μm).

Powder CE5 (Comparative)

Powder CE5 is a precipitated silica, commercially available from Evonik (Ultrasil VN3, BET specific surface area=180 m²/g).

Powder CE6 (Comparative)

Powder CE6 is a N220 carbon black filler, commercially available from Cabot under the Vulcan® 6, iodine number: 121 mg/kg, STSA surface area (according to ASTM D 6556): 104 m²/g).

Powder CE7 (Comparative)

Powder CE7 is ground calcium carbonate powder from France (Micromya-OM), d₅₀ (wt)=2.4 μm, d₉₈ (wt)=20 μm.

### 3. Examples

### 3.1. Examples Series A: Simple EPDM Formulations

Cured elastomer products were prepared as described in the following, wherein the compositions of the prepared cured elastomer products are compiled in Table 8 below.

Step 1: Internal Mixing

As a first step, each batch were mixed in a HAAKE internal mixer with 300 cm³ capacity equipped with Banbury rotors. The temperature was set at 40° C. at the beginning of each mixing, during the process the temperature raised up to 90° C. depending on the filler being incorporated. The following process had been used for each batch (Table 7):

TABLE 7
Internal mixing procedure.

| Time (min) | Operation | Speed (rpm) |
|---|---|---|
| t = 0 | Introduction of elastomer precursor | 40 |
| | and mineral filler (40° C.) | |
| t = 1 | Insertion of carbon black and oil | 40 |
| t = 5 | Dumping of the mixture | 40 |

Step 2: External Mixing

For the second step, mixing with the peroxide curing agent was performed on an instrumented cylinder mixer (300×700 or 150×350). All the rubbers were mixed with the same times, cylinder speeds, and cylinder spacing as to not influence in their rheological properties comparison. The cooling system was set to 25° C. and the metal guides were set as to allow the rubber to occupy 70% of the cylinder surface. In between two accelerations the cylinders are cleaned and are let cool. The detail proceedings for this process are described in Table 8 below.

TABLE 8
External mixing procedure.

| | | Cylinder |
|---|---|---|
| Time (min) | Operation | Spacing (mm) |
| t = 0 | Introduction of the mix from Step 1 | 1 |
| t = 2 | Insertion of the curing system | 1 |
| | (peroxide and coagent) | |
| t = 6 | 5 thin passings | 0.6 |

| | |
|---|---|
| Calendering sheet, thickness 2 mm | 2 |

Step 3: Molding

The pieces were then molded at 160° C. and 200 bar pressure by compression molding. This way, small 150×150×2 mm sheets were prepared. The curing time, which determines the molding time, was determined through a rheological MDR (Moving Die Rheometer) test.

The following elastomer compositions of Table 9 were obtained following the method described above. All elastomer compositions had an isovolumic amount of fillers. All fillers were coupled 50/50% with carbon black in volume. Therefore the carbon black reference batch contains 100 phr of N550. The other batches contain 50 phr of N550 and a slightly variable amount of mineral filler in function of their density, in order to have an amount of mineral filler equivalent to the volume of 50 phr of carbon black (indicated in Table 9 with an asterisk).

TABLE 9
EPDM elastomer compositions (phr: parts per hundred).

| Example | A-E1 | A-E2 | A-E3 | A-E4 | A-E5 | A-CE1 | A-CE2 | A-CE3 |
|---|---|---|---|---|---|---|---|---|
| EPDM Vistalon 2504 (phr) | 100 | 100 | 100 | 100 | 100 | 100 | 100 | 100 |
| Powder 1 (phr) | 76* | | | | | | | |
| Powder 2 (phr) | | 77* | | | | | | |
| Powder 3 (phr) | | | 78* | | | | | |
| Powder 4(phr) | | | | 60* | | | | |
| Powder 5 (phr) | | | | | 60* | | | |
| Powder CE1(phr) | 50 | 50 | 50 | 50 | 50 | 100 | 50 | 50 |
| Powder CE2 (phr) | | | | | | | 73* | |
| Powder CE3 (phr) | | | | | | | | 75* |
| Torilis 6200 plasticizer (phr) | 10 | 10 | 10 | 10 | 10 | 10 | 10 | 10 |
| Peroxide DC40 crosslinking | 7 | 7 | 7 | 7 | 7 | 7 | 7 | 7 |
| agent (phr) | | | | | | | | |
| Rhenogran TAC 50% | 2 | 2 | 2 | 2 | 2 | 2 | 2 | 2 |
| crosslinking coagent (phr) | | | | | | | | |

The obtained cured elastomer compositions had the properties compiled in Table 10 below.

TABLE 10
Effect on mechanical properties (series A).

| | Hardness | M100 | Strength at | Elongation | Tear resistance/ |
|---|---|---|---|---|---|
| Sample | IRDH (°) | (MPa) | break (MPa) | (%) | DELFT (MPa) |
| A-E1 | 73.5 | 5.09 | 10.94 | 225.9 | 26.73 |
| A-E2 | 85.2 | 5.75 | 10.85 | 215 | 32.33 |
| A-E3 | 77.6 | 5.137 | 11.59 | 225.9 | 20.22 |
| A-E4 | 82.3 | 6.36 | 13.19 | 200 | 32.13 |
| A-E5 | 82.8 | 6.09 | 11.63 | 200 | 31.6 |
| A-CE1 | 80.2 | 10.66 | — | 144.75 | 20 |
| A-CE2 | 75.7 | 5.69 | — | — | — |
| A-CE3 | 79 | 3.78 | 7.34 | — | — |

The effect on elongation at break and on tear resistance (DELFT) is shown in Table 10.

### 3.2. Examples Series B: EPDM Sulfur-Cured Formulations

Cured elastomer products were prepared as described in the following, wherein the compositions of the prepared cured elastomer products are compiled in Table 11 below.

### Step 1: Internal Mixing

Internal Mixing was carried out as described in Example 3.1.

Step 2: External Mixing External Mixing was carried out as described in Example 3.1., wherein mixing with the peroxide curing agent was performed on an instrumented cylinder mixer (150×350).

### Step 3: Molding

The pieces were then molded at 160° C. or 180° C. and 100 kgf/cm pressure by compression molding. This way, small 150×150×2 mm sheets were prepared. The curing time, which determines the molding time, was determined through a rheological MDR test.

The composition of the curable elastomer compositions are shown in Table 11 below and the properties of the cured elastomer compositions are combined in Table 12 below. Amounts of experimental fillers have been adjusted according to the measured density of each filler to correspond to the same volume as 40 phr of Powder CE1 (carbon black).

TABLE 11
EPDM elastomer compositions (phr: parts per hundred).

| Example | B-E2 | B-E4 | B-E6 | B-CE1 | B-CE5 |
|---|---|---|---|---|---|
| EPDM KELTAN 6950C (phr) | 100 | 100 | 100 | 100 | 100 |
| Powder 2 (phr) | 61.5 | | | | |
| Powder 4 (phr) | | 47 | | | |
| Powder 6 (phr) | | | 58 | | |
| Powder CE1 (phr) | 40 | 40 | 40 | 80 | 40 |
| Powder CE5 (phr) | | | | | 43 |
| Torilis 6200 plasticizer (phr) | 20 | 20 | 20 | 20 | 20 |
| ZnO vulcanization accelerator | 5 | 5 | 5 | 5 | 5 |
| (phr) | | | | | |
| Stearic acid (phr) | 1 | 1 | 1 | 1 | 1 |
| Protector octamine (phr) | 1 | 1 | 1 | 1 | 1 |
| CBS 80 vulcanization | 2.5 | 2.5 | 2.5 | 2.5 | 2.5 |
| accellerator (phr) | | | | | |
| TBzTD 70 vulcanization | 1 | 1 | 1 | 1 | 1 |
| accellerator (phr) | | | | | |
| Sulfur (phr) | 1.5 | 1.5 | 1.5 | 1.5 | 1.5 |

TABLE 12
Effect on mechanical properties (series B).

| | M100 | Strength at | Elongation | Tear resistance/ |
|---|---|---|---|---|
| Sample | (MPa) | break (MPa) | at break (%) | DELFT (MPa) |
| B-E2 | 3.9 | 12.6 | 345 | — |
| B-E4 | 3.6 | 14.6 | 347 | — |
| B-E6 | 4.8 | 15 | 388 | 37 |
| B-CE1 | 7.7 | 17.5 | 211 | 38.6 |
| B-CE5 | 4.6 | 16.3 | 324 | — |

The effect on elongation at break and the tear resistance (DELFT) is shown in Table 12.

### 3.3. Examples Series C: EPDM Peroxide-Cured Formulations

Step 1: Internal Mixing

As a first step, batches of EPDM and filler were mixed in a 2 L Banbury internal mixer according to the mixing procedure shown in Table 13 below. The temperature was set at 40° C. at the beginning of each mixing, and the temperature raised up to 150° C. during the process, depending on the filler being incorporated.

TABLE 13
Internal mixing procedure.

| Time (min:s) | Operation | Speed (rpm) |
|---|---|---|
| t = 00:00 | Introduction of EPDM | 50 |
| t = 00:50 | Addition of the filler | 50 |
| t = 02:30 | Addition of ⅔ of Powder CE1 | 50 |
| t = 05:30 | Addition of ⅓ of Powder CE1 + | 50 |
| | paraffinic oil | |
| t = 06:30 | Ramp cleaning | 50 |
| t = 08:30 | Dropping | 50 |

Step 2: External Mixing

For the second step, mixing with the peroxide crosslinking agent was performed on a cylinder mixer (300×700). All the elastomer precursors were mixed with the same times, cylinder speeds, and cylinder spacing. The cooling system was set to 40° C. and the metal guides were set as to allow the elastomer precursor to occupy 70% of the cylinder surface. The detail proceedings for this process are described in Table 14 below.

TABLE 14
External mixing procedure.

| | | Cylinder |
|---|---|---|
| Time (min:s) | Operation | Spacing (mm) |
| t = 00:00 | Introduction of the mix from Step 1 | 2.5 |
| t = 01:30 | Insertion of the curing system | 2.5 |
| | (peroxide and coagent) | |
| t = 06:00 | 3 thin passes | 0.5 |

| | |
|---|---|
| Calendering sheet, thickness 2 mm | 2 |

Step 3: Molding

Sheets of the elastomer composition were produced by compression molding at 180° C. and 200 bar pressure. This way, small 300×300×2 mm plates were made. The curing time, which determines the molding time, was determined through a rheological MDR (Moving Die Rheometer) test. The t98 value (time needed to reach 98% of the crosslinking, determined by MDR analysis) was taken as time of curing for the press plates. The fabrication of the compression set test specimens was done with the same procedure, meaning by compression molding. The curing time used was the addition of 10 min to the t98 value as the thickness of these test specimens is higher than the press plates.

The following elastomer compositions of Table 15 were obtained following the method described above. All elastomer compositions had an isovolumic amount of fillers. All fillers were coupled 50/50% with carbon black in volume. Therefore, the carbon black reference sample C-CE1 contains 100 phr of N550 (powder CE1). The other samples contain 50 phr of N550 and a slightly variable amount of mineral filler in function of their density, in order to have an amount of mineral filler equivalent to the volume of 50 phr of carbon black (indicated in Table 15 with an asterisk).

TABLE 15
EPDM elastomer compositions (phr: parts per hundred).

| Example | C-CE1 | C-E18 | C-E19 | C-E20 |
|---|---|---|---|---|
| EPDM Vistalon 2504N (phr) | 100 | 100 | 100 | 100 |
| Powder CE1 (phr) | 100 | 50 | 50 | 50 |
| Powder 18 (phr) | | 76.4* | | |
| Powder 19 (phr) | | | 60.8* | |
| Powder 20 (phr) | | | | 72.2* |
| Torilis 6200 plasticizer (phr) | 10 | 10 | 10 | 10 |
| Peroxide DC40 crosslinking | 7 | 7 | 7 | 7 |
| agent (phr) | | | | |
| Rhenogran TAC 50% crosslinking | 2 | 2 | 2 | 2 |
| coagent (phr) | | | | |

The obtained elastomer compositions had the mechanical properties compiled in Table 16 below.

TABLE 16
Mechanical properties of the elastomer compositions (series C).

| Sample | Hardness (Shore A) | M50 (MPa) | Elongation at break (%) |
|---|---|---|---|
| C - CE1 | 79.1 | 3.7 | 142 |
| C - E18 | 84.3 | 4.7 | 208 |
| C - E19 | 83.1 | 4.4 | 149 |
| C - E20 | 82.2 | 3.7 | 185 |

As can be seen from Table 16, the shore A hardness of the inventive cured elastomer products (C-E18, C-E19, and C-E20) is improved. In addition, the inventive cured elastomer products showed good M50 modulus and the elongation at break or even a further improvement of these mechanical properties.

### 3.4. Examples Series D: Tire Tread Sulfur-Cured SBR Formulations

Step 1: Internal Mixing

As a first step, batches of SBR rubber and filler were mixed in a 2 L Banbury internal mixer according to the mixing procedure shown in Table 17 below. The temperature was set at 40° C. at the beginning of each mixing, and the temperature raised up to 150° C. during the process the temperature, depending on the filler being incorporated.

TABLE 17
Internal mixing procedure.

| Time (min:s) | Operation | Speed (rpm) |
|---|---|---|
| t = 00:00 | Introduction of SBR rubber | 50 |
| t = 00:30 | Addition of the filler + ⅓ powder CE6 | 50 |
| t = 01:45 | Addition of ⅔ of powder CE6 + oil | 50 |
| | (Torilis 6200 plastcizer) | |
| t = 02:45 | Addition of the curing system | 50 |
| | (sulfur and accelerators) | |
| t = 04:15 | Ramp cleaning | adjusted |
| t = 06:30 | Dumping of the compound | adjusted |

Step 2: External Mixing

For the second step, mixing with the curing system was performed on an external mixer Agila (300×400). All the elastomer precursors were mixed with the same times, cylinder speeds, and cylinder spacing. The cooling system was set to 40° C. and the metal guides were set as to allow the elastomer precursor to occupy 70% of the cylinder surface. The detail proceedings for this process are described in Table 18 below.

TABLE 18
External mixing procedure.

| | | Cylinder |
|---|---|---|
| Time (min:s) | Operation | Spacing (mm) |
| t = 00:00 | Introduction of the mix from Step 1 | 1 |
| t = 01:30 | Insertion of the curing system | 1 |
| | (sulfur and accelerators) | |
| t = 06:00 | 3 thin passes | 0.5 |

| | |
|---|---|
| Calendering sheet, thickness 2 mm | 2 |

Step 3—Compression Molding

Sheets of the elastomer composition were produced by compression molding at 160° C. or 180° C. and 100 kgf/cm pressure. This way, small 300×300×2 mm plates were made. The curing time, which determines the molding time, was determined through a rheological MDR test.

The following elastomer compositions of Table 19 were obtained following the method described above. All elastomer compositions had an isovolumic amount of fillers. The amount of filler was adjusted to match the volume occupied by 40 phr carbon black (powder CE6), depending on the density of the filler (indicated in Table 19 with an asterisk).

TABLE 19
SBR elastomer compositions (phr: parts per hundred).

| Example | D-E21 | D-E22 | D-E23 | D-CE6 | D-CE7 |
|---|---|---|---|---|---|
| SRB - Buna VSL-2538-2 | 137.5 | 137.5 | 137.5 | 137.5 | 137.5 |
| (phr) | | | | | |
| Powder 21 | 58.4* | | | | |
| Powder 22 | | 44.9* | | | |
| Powder 23 | | | 47.8* | | |
| Powder CE6 (Carbon | 40 | 40 | 40 | 80 | 40 |
| black N220 - Vulcan 6) | | | | | |
| Powder CE7 | | | | | 61.1* |
| Vivatec 500/plasticizer | 16 | 16 | 16 | 16 | 16 |
| (phr) | | | | | |
| Protector - 6PPD (phr) | 2 | 2 | 2 | 2 | 2 |
| Protector - Antilux 500 | 2 | 2 | 2 | 2 | 2 |
| (phr) | | | | | |
| ZnO - Silox actif (phr) | 3 | 3 | 3 | 3 | 3 |
| Stearic acid - TP2 (phr) | 1.5 | 1.5 | 1.5 | 1.5 | 1.5 |
| Sulfur (phr) | 2 | 2 | 2 | 2 | 2 |
| CBS (phr) | 1 | 1 | 1 | 1 | 1 |
| MTBS (phr) | 0.5 | 0.5 | 0.5 | 0.5 | 0.5 |

The obtained elastomer compositions had the following mechanical properties compiled in Table 20 below.

TABLE 20
Effect on mechanical properties (series D).

| | M100 Modulus | Shore A | Compression | Tear resistance/ |
|---|---|---|---|---|
| Sample | (MPa) | Hardness | set (%) | DELFT (N) |
| D-E21 | 3.3 | 55.7 | 14 | 28 |
| D-E22 | 1.8 | 53.8 | 11 | 22 |
| D-E23 | 1.8 | 49.8 | 9 | 28 |
| D-CE6 | 1.4 | — | 23 | — |
| D-CE7 | 0.8 | 39.2 | 24 | 17 |

1. A curable elastomer composition comprising
a crosslinkable polymer, and
a filler selected from surface-reacted calcium carbonate, precipitated hydromagnesite, or a mixture thereof,
wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

2. The curable elastomer composition of claim 1, wherein the crosslinkable polymer is selected from natural or synthetic rubber.

3. The curable elastomer composition of claim 1, wherein the filler is present in an amount from 1 to 80 wt.-%, based on the total weight of the curable elastomer composition, or the filler is present in an amount from 5 to 175 parts per hundred (phr), based on the total weight of the crosslinkable polymer.

4. The curable elastomer composition of claim 1,
wherein the filler has a volume median particle size d₅₀ from 0.1 to 75 μm, and/or
a volume top cut particle size d₉₈ from 0.2 to 150 μm, and/or
a specific surface area of from 15 m²/g to 200 m²/g, measured using nitrogen and the BET method.

5. The curable elastomer composition of claim 1,
wherein the natural ground calcium carbonate is selected from the group consisting of marble, chalk, limestone, and mixtures thereof, or
the precipitated calcium carbonate is selected from the group consisting of precipitated calcium carbonates having an aragonitic, vateritic or calcitic crystal form, and mixtures thereof, and/or
the at least one H₃O⁺ ion donor is selected from the group consisting of hydrochloric acid, sulphuric acid, sulphurous acid, phosphoric acid, citric acid, oxalic acid, an acidic salt, acetic acid, formic acid, and mixtures thereof, preferably the at least one H₃O⁺ ion donor is selected from the group consisting of hydrochloric acid, sulphuric acid, sulphurous acid, phosphoric acid, oxalic acid, H₂PO₄⁻, being at least partially neutralised by a cation selected from Li⁺, Na⁺ and/or K⁺, HPO₄²⁻, being at least partially neutralised by a cation selected from Li⁺, Na⁺, K⁺, Mg²⁺, and/or Ca²⁺, and mixtures thereof.

6. The curable elastomer composition of claim 1, wherein the precipitated hydromagnesite is surface-treated precipitated hydromagnesite, or a mixture of precipitated hydromagnesite and surface-treated precipitated hydromagnesite.

7. The curable elastomer composition of claim 1,
wherein the filler comprises at least one surface-treatment layer on at least a part of the surface of the filler,
wherein the at least one surface-treatment layer is formed by contacting the filler with at least one surface-treatment composition in an amount from 0.07 to 9 mg/m² of the filler surface, and
wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated or unsaturated fatty acids, salts of saturated or unsaturated fatty acids, saturated or unsaturated esters of phosphoric acid, salts of saturated or unsaturated phosphoric acid esters, abietic acid, salts of abietic acid, polydialkylsiloxanes, trialkoxysilanes, and mixtures thereof and reaction products thereof,
wherein the at least one surface-treatment agent is selected from the group consisting of
a) sodium, potassium, calcium, magnesium, lithium, strontium, primary amine, secondary amine, tertiary amine and/or ammonium salts, whereby the amine form; and/or
b) a maleic anhydride grafted polybutadiene homopolymer or a maleic anhydride grafted polybutadiene-styrene copolymer and/or an acid and/or salt thereof, the maleic anhydride grafted polybutadiene homopolymer having
i) a number average molecular weight Mₙ measured by gel permeation chromatography from 1,000 to 20,000 g/mol measured according to EN ISO 16014-1:2019, and/or
ii) a number of anhydride groups per chain in the range from 2 to 12, and/or
iii) an anhydride equivalent weight in the range from 400 to 2 200, and/or
iv) an acid number in the range from 10 to 300 meq KOH/g of maleic anhydride grafted polybutadiene homopolymer, measured according to ASTM D974-14, and/or
v) a molar amount of 1,2-vinyl groups in the range from 5 to 80 mol-%, based on the total amount of unsaturated carbon moieties in the maleic anhydride grafted polybutadiene homopolymer,
and/or an acid and/or salt thereof, and/or
c) a trialkoxysilane, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof, and/or
f) at least one mono-substituted succinic anhydride consisting of succinic anhydride mono-substituted with a group selected from a linear, branched, aliphatic and cyclic group having a total amount of carbon atoms from at least C₂ to C₃₀ in the substituent and/or salts thereof, and/or
g) at least one polydialkylsiloxane, and/or
h) mixtures of the materials according to a) to g).

8. The curable elastomer composition of claim 1, wherein the curable elastomer composition comprises a crosslinking agent, and mixtures thereof.

9. The curable elastomer composition of claim 1, wherein the curable elastomer composition further comprises colouring pigment, dyes, wax, lubricant, oxidative- and/or UV-stabilizer, antioxidant, additional filler, processing aid, plasticizer, additional polymer, and mixtures thereof, preferably the additional filler is selected from the group comprising carbon black, silica, ground natural calcium carbonate, precipitated calcium carbonate, nanofiller, graphite, clay, talc, kaolin clay, calcined kaolin, calcined clay, diatomaceous earth, barium sulfate, titanium dioxide, wollastonite, and mixtures thereof.

10. A cured elastomer product formed from the curable elastomer composition according to claim 1.

11. An article comprising the cured elastomer product according to claim 10, wherein the article is selected from the group comprising tubeless articles, membranes, sealings, gloves, pipes, cable, electrical connectors, oil hoses, shoe soles, o-ring seals, shaft seals, gaskets, tubing, valve stem seals, fuel hose, tank seals, diaphragms, flexi liners for pumps, mechanical seals, pipe coupling, valve lines, military flare blinders, electrical connectors, fuel joints, roll covers, firewall seals, clips for jet engines, conveyor belts, and tires.

12. A method of producing a cured elastomer product, comprising the steps of
i) providing a crosslinkable polymer,
ii) providing a filler selected from surface-reacted calcium carbonate, precipitated hydromagnesite, or a mixture thereof,
wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source,
iii) combining the crosslinkable polymer of step i) and the filler of step ii) in one or more steps to form a curable elastomer composition, and
iv) curing the curable elastomer composition of step iii).

13. The method of claim 12, wherein the curing step iv) is carried out by adding a crosslinking agent, heat treatment, ultraviolet light radiation, electron-beam radiation and/or nuclear radiation.

14. A method comprising providing a filler for reinforcing a cured elastomer product, wherein the filler is selected from surface-reacted calcium carbonate, precipitated hydromagnesite, or a mixture thereof, and
wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

15. The method of claim 14,
wherein the tear resistance and/or the elongation at break and/or the tensile strength and/or the tensile modulus of the cured elastomer product is increased compared to a cured elastomer without filler by at least 5%, and/or
wherein the tear resistance and/or the elongation at break and/or the tensile strength and/or the tensile modulus of the cured elastomer product is increased compared to a cured elastomer product containing an isovolumic amount of carbon black N550 as filler by at least 5%, wherein the carbon black has a statistical thickness surface area (STSA) of 39±5 m²/g, measured according to ASTM D 6556-19, the tear resistance is measured according to NF ISO 34-2, and the elongation at break, the tensile strength and the tensile modulus are measured according NF ISO 37.

16. A process for the surface treatment of precipitated hydromagnesite, the process comprising the steps of:
I) providing precipitated hydromagnesite,
II) providing at least one surface-treatment composition in an amount ranging from 0.07 to 9 mg/m² of the precipitated hydromagnesite surface,
wherein the at least one surface-treatment composition comprises at least one surface-treatment agent selected from the group consisting of mono- or di-substituted succinic anhydride containing compounds, mono- or di-substituted succinic acid containing compounds, mono- or di-substituted succinic acid salts containing compounds, saturated or unsaturated fatty acids, salts of saturated or unsaturated fatty acids, saturated or unsaturated esters of phosphoric acid, salts of saturated or unsaturated phosphoric acid esters, abietic acid, salts of abietic acid, polydialkylsiloxanes, trialkoxysilanes, and mixtures thereof and reaction products thereof, and
III) contacting the precipitated hydromagnesite and the at least one surface-treatment composition in one or more steps at a temperature in the range from 20 to 180°, the at least one surface-treatment agent is selected from the group consisting of
a) sodium, potassium, calcium, magnesium, lithium, strontium, primary amine, secondary amine, tertiary amine and/or ammonium salts, whereby the amine salts are linear or cyclic, of mono- or di-substituted succinic acids, whereby one or both acid groups can be in the salt form, and/or
b) a maleic anhydride grafted polybutadiene homopolymer or a maleic anhydride grafted polybutadiene-styrene copolymer and/or an acid and/or salt thereof, the maleic anhydride grafted polybutadiene homopolymer having
i) a number average molecular weight Mₙ measured by gel permeation chromatography from 1,000 to 20,000 g/mol, measured according to EN ISO 16014-1:2019, and/or
ii) a number of anhydride groups per chain in the range from 2 to 12, and/or
iii) an anhydride equivalent weight in the range from 400 to 2,200, and/or
iv) an acid number in the range from 10 to 300 meq KOH/g of maleic anhydride grafted polybutadiene homopolymer, measured according to ASTM D974-14, and/or
v) a molar amount of 1,2-vinyl groups in the range from 5 to 80 mol-%, based on the total amount of unsaturated carbon moieties in the maleic anhydride grafted polybutadiene homopolymer,
and/or an acid and/or salt thereof, and/or
c) a trialkoxysilane, and/or
d) a phosphoric acid ester blend of one or more phosphoric acid mono-ester and/or salts thereof and/or one or more phosphoric acid di-ester and/or salts thereof, and/or
e) at least one saturated aliphatic linear or branched carboxylic acid and/or salts thereof and/or
f) at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof, and/or
g) at least one polydialkylsiloxane, and/or
h) mixtures of the materials according to a) to g).

17. The process of claim 16, wherein in step I) the precipitated hydromagnesite is provided in form of an aqueous suspension having a solids content in the range from 5 to 80 wt.-%, based on the total weight of the aqueous suspension, step III) is carried out by adding the at least one surface-treatment composition to the aqueous suspension and mixing the aqueous suspension at a temperature in the range from 20 to 120° C., and the process further comprises the step of:
IV) drying the aqueous suspension during or after step III) at a temperature in the range from 40 to 160° C. at ambient or reduced pressure until the moisture content of the obtained surface-treated precipitated hydromagnesite is in the range from 0.001 to 20 wt.-%, based on the total weight of the surface-treated precipitated hydromagnesite.

18. A surface-treated precipitated hydromagnesite obtained by a process according to claim 16.
